(19) United States
(12) Patent Application Publication
(10) Pub. No.: US 2025/0206469 A1
(43) Pub. Date: Jun. 26, 2025

(54) SPACECRAFT MODULE CHASSIS SYSTEM

(71) Applicant: SPACE.ORG.], Inc., FELTON, CA (US)

(72) Inventors: JOHN FRANCIS McENTEE, BOULDER CREK, CA (US); THOMAS LEAVITT, APTOS, CA (US)

(73) Assignee: SPACE.ORG, FELTON, CA (US)

(21) Appl. No.: 18/628,443

(22) Filed: Apr. 5, 2024

Related U.S. Application Data
(63) Continuation-in-part of application No. 63/614,786, filed on Dec. 26, 2023, now abandoned.

(51) Int. Cl. B64G 1/22; B64G 1/64

(52) U.S. Cl. CPC B64G 1/223; B64G 1/641

(57) ABSTRACT

A system of versatile foundational spacegoing module infrastructure which is a framework of modular hardware and software elements which can be used to rapidly design and produce spacecraft. Preferred embodiments may comprise or include spacecraft modular building elements uniquely suitable for facilitating rapid assembly of numerous custom spacecraft designs from standard modular parts. A craft produced using these elements consists of one of more deltahedral structural frame modules and one or more function modules which provide instrument or subsystem elements. The frame modules provide the spacecraft mechanical structure, power and network distribution. The function modules provide the instruments and subsystems. Combinations of these standard elements can produce an unlimited variety of spacecraft embodiments, as needed for each mission. Supporting technologies may include an androgynous mount interface and a mechanical fastening apparatus for rigid mounting.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### STATEMENT REGARDING PRIOR DISCLOSURES BY THE INVENTOR OR A JOINT INVENTOR

Not Applicable.

### BACKGROUND OF THE INVENTION

### Field of the Invention

The present invention is related generally to spacegoing module design, and more particularly to a system and method for designing, planning, programming, building, and launching modular spacecraft.

### Background Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The production of satellites and other automated spacecraft has always been a tedious, slow and expensive process. Each craft is specified for an individual mission, designed from the ground up, and hand built, taking between six months and three years to complete, depending on the complexity. The cost of launching spacecraft has dropped significantly in the last ten years, but the cost of producing those spacecraft remains very high. Beyond the physical aspects of design and construction, spacecraft projects require the interaction of many engineers, scientists, contractors, sub-contractors, and vendors, all requiring careful coordination of efforts and agreement to specifications. The process is iterative, so the final project cost and actual completion time often remains uncertain until late in the project timeline. This makes planning and budgeting difficult to control and manage.

Standardized connectivity as applied in other fields is an everyday convenience with clear benefits. Electrical outlets in one's home are standardized ports for easily connecting a compatible plug to an electrical network, without having to understand exactly how the wiring works; one need not be an expert electrician just to plug in and use an electric device in one's home. The USB standard provides a similar benefit in the field of computer hardware; designers can make keyboards, external memory drives, music players, or even a heating coaster for a warm drink, and know that utilizing a USB connector for data and/or power will make these devices broadly compatible with most personal computers.

Even though some basic infrastructure aspects remain generally the same from spacecraft to spacecraft, such as the necessity of wiring basic electrical and data connections, these systems also are designed bespoke from the ground up along with the rest of the craft, and a lot more coordination is required even on these basic elements. Further, the difficulty compounds with any subsequent adding-on or retrofitting of a craft, as any new component must then also be designed custom in order to compatibly interface with the specific, bespoke wiring system of the original module.

There is, therefore, a long-felt need for improvement in space module design to improve efficiency and reduce difficulty by providing a system of versatile foundational module infrastructure.

### BRIEF SUMMARY OF THE INVENTION

Towards these and other objects of the method of the present invention (hereinafter, “the invented method”) that are made obvious to one of ordinary skill in the art in light of the present disclosure, what is provided is a system of versatile foundational spacegoing module infrastructure (hereinafter, “the invented system”) which is a framework of modular hardware and software elements which can be used to rapidly design and produce spacecraft. In preferred embodiments, the invented system may comprise or include spacecraft modular building elements uniquely suitable for facilitating rapid assembly of numerous custom spacecraft designs from standard modular parts. A craft produced using these elements consists of one of more deltahedral structural frame modules and one or more function modules which provide instrument or subsystem elements. The frame modules provide the spacecraft mechanical structure, power and network distribution. The function modules provide the instruments and subsystems. Combinations of these standard elements can produce an unlimited variety of spacecraft embodiments, as needed for each mission. Supporting technologies may include an androgynous mount interface and a mechanical fastening apparatus for rigid mounting. These frame modules may also be discussed herein utilizing the terms “chassis frame” or “chassis assembly”.

In preferred embodiments, the invented system may further comprise or include a unique distributed network device bus which coordinates all functions of module elements autonomously according to mission programming, and may also incorporate a unique automated on-line business method facilitating an open source market ecosystem which provides end to end spacecraft project management from ideation, through design, mission programming, purchase, production, launch and ground services. In preferred embodiments, the invented system may further include the elements of tolerance-compliant attachment for ridged mounting comprising three mounting points guided along each of three radial paths at 120 degrees and those being incorporated in mount connectors; and an androgynous mount connector design wherein every projection above a neutral plane on one side of the central plane is mirrored by a mating depression below the neutral plane on the opposite side and every element on one side of a central plane has a mating counterpart on the other side of the central plane.

The central modular elements in the framework are proprietary frame modules which are used to create mechanical support for the spacecraft, rigidly supporting the spacecraft's instruments and subsystems, while providing power and data interconnectivity for those attached instruments and subsystems. The frame modules are generally structured in the shapes of polyhedra, such as but not limited to deltahedra such as tetrahedra, octahedra, and icosahedra.

In preferred operation, the invented system may function as a basic, standard skeletal foundation for supporting an otherwise specialized spacegoing module, providing basic power and data connectivity throughout the module which is accessible via standard internal ports, a standard external port design for facilitating power and data connectivity with other modules, and an outer structure geometrically suited to coupling together with compatible modules. One or more specialized useful devices for a spacegoing craft, such as but not limited to telescopes, cameras, power generators, batteries, orientation, thrust generators, attitude control, data storage, or processors, may be installed and fitted into or onto the chassis of the system. Further, a basic infrastructural foundation provided by preferred embodiments of the invented system may facilitate design of compatible devices without craft-specific customization of every aspect; independent modular design of various spacecraft elements to be plugged into a modular craft following a consistent interface standard becomes more feasible.

Some preferred materials for constructing the tube body of the struts as presented herein may include but are not limited to: metals such as aluminum, steel alloy, stainless steel, titanium, or 3D-printed metals; ceramics; and composites such as carbon epoxy, glass epoxy, and other fiber-polymer compositions, fiber-embedded metal composites, or carbon-carbon. Some preferred materials for constructing the power and signal path components of the struts as presented herein may include but are not limited to: metals such as aluminum, copper, silver, and gold; carbon materials including graphene, or fiber optics materials such as acrylic, polystyrene, quartz, fluorozirconate, fluoroaluminate, and chalcogenide glasses, or crystalline materials like sapphire. Some preferred materials for insulation such as insulation of the struts may include but are not limited to: glass, ceramic, woven fiber of glass or ceramic, flexible polymer film such as Polyimide Film, or conductor insulation jackets from any mission-appropriate polymer such as PVC (Polyvinyl Chloride), PE (Polyethylene), ECTFE, PVDF, or Nylon. It is understood that the listing above is not exhaustive or limiting, that other materials may be discovered to be suitable or preferred, and that any material considered to be suitable for these applications by one skilled in the art might be utilized.

Some preferred materials for constructing the node body of the nodes as presented herein may include but are not limited to: metals such as aluminum, steel alloy, stainless steel, titanium, and 3D-printed Metals; ceramics; composites such as Carbon Epoxy, Glass Epoxy, other fiber-polymer compositions, Fiber-Embedded Metal composites, or carbon-carbon. Some preferred materials as radiation shielding for protecting the embedded CPU-controller components of the nodes as presented herein may include but are not limited to: aluminum casing with additional shielding materials such as but not limited to polyethylene, polybenzoxazine, or materials containing Hydrogen such as hydrogen absorbed Boron Nitride. Some preferred materials for constructing the mount interface connector body of the nodes as presented herein may include but are not limited to: any of the common materials known in the art including Nylon, PBT Polyester, PTFE, PPS, PEI, LCP, and ceramics such as Alumina, Silica, etc. Some preferred materials for constructing the electronic control circuit of the nodes as presented herein may include but are not limited to: Epoxy-based laminate materials such as FR4, FR5, Polyimide. Some preferred materials for constructing the flex mount mechanical attachment fixture of the nodes as presented herein may include but are not limited to: Spring Steel such as 1095, 302 or 304 Stainless Steel, also composite materials such as graphite epoxy (bonded instead of welded), and ceramic spring materials such as silicon nitride. It is understood that the listing above is not exhaustive or limiting, that other materials may be discovered to be suitable or preferred, and that any material considered to be suitable for these applications by one skilled in the art might be utilized.

Some preferred materials for constructing the delta ring as presented herein may include but are not limited to: Metals such as Aluminum, Steel Alloy, Stainless Steel, Titanium, 3D-printed Metals; and Composites such as Carbon Epoxy, Glass Epoxy, other fiber-polymer compositions, Fiber-Embedded Metal composites, or carbon-carbon. It is understood that the listing above is not exhaustive or limiting, that other materials may be discovered to be suitable or preferred, and that any material considered to be suitable for these applications by one skilled in the art might be utilized.

Some preferred dimensions and scaling of the tube body of the struts as presented herein might include, but are not limited to, the following. A preferred length of the strut might be 15 inches, and it is noted that even far shorter embodiments such as a 1 inch strut may be suitable for use in certain applications. A preferred diameter of the tube body might be 0.75 inch, and it is further noted that this might scale smaller such as but not limited to a diameter of 0.06 inches, or scale larger such as but not limited to a diameter of 6 inches or more. A preferred thickness of the tube wall might be 0.030 inches, and it is noted that, depending on factors such as but not limited to the material and the tube diameter, might be thinner, such as but not limited to 0.005 inches, or thicker, such as but not limited to 2.0 inches or more.

Some preferred dimensions and scaling of the nodes as presented herein might include, but are not limited to, the following. The node dimensions as viewed from the top might preferably be 2.25 inches square, and it is further noted that this might scale smaller such as but not limited to 0.25 inches square, or scale larger such as but not limited to 18 inches square or more. The height of this component might preferably be 0.75 inches, and it is further noted that this might scale smaller such as but not limited to 0.06 inches, or scale larger such as but not limited to 6 inches or more.

Some preferred dimensions and scaling of the delta ring as presented herein might include, but are not limited to, the following. The delta ring is preferably an equilateral triangle with sides all measuring 15 inches, and it is further noted that this might scale smaller such as but not limited to 1 inch on a side, or scale larger such as but not limited to 25 feet on a side or more. It is further noted that the shape of the delta ring is not necessarily limited to that of an equilateral triangle, and that a non-equilateral shape would include sides having different lengths. The depth of the delta ring might preferably measure 0.75 inches, and it is further noted that this might scale smaller such as but not limited to 0.3 inch, or scale larger such as but not limited to 6 inches or more.

It is noted and understood overall that the above statements regarding materials, scale, and dimensions are provided as exemplary and non-limiting, to the end of advising how best to practice certain preferred or alternative embodiments of the invented method according to the inventor's current understanding. The materials, dimensions, and scale should not be construed as limited by any statement made herein, and are limited exclusively by the text of the claims.

Regarding aspects pertaining to power flow and electrical connectivity, one skilled in the art such as an electrician may recognize that, under the overall heading of “providing power connectivity”, fundamental aspects of electrical wiring such as mitigating between differing voltage levels, distinguishing between positive and negative terminals, and connecting to power sources and power consumers each accordingly may be relevant to practical application of the concepts discussed herein. This level of specific detail may not always be mentioned in the context of the broader concept of providing electrical connectivity, and can be understood to be practiced as needed.

It is understood that the terms “male”, “female”, and “androgynous” are utilized in this text in the engineering capacity of distinguishing types of connectors: respectively, a side of a connector which protrudes (and connects by fitting into indentations), a side of a connector which indents (and connects by fitting around protrusions), and a connector which does neither and instead connects to a same connector.

In the disclosure, several varieties of chassis frames shaped like various polyhedrons are presented, and a naming convention is utilized for describing these polyhedral frames wherein the numerical prefix of the polyhedron (e.g. “tetra-” in “tetrahedron” or “octa-” in “octahedron”) is paired with the suffix of “-frame” as a name for a variety of chassis frame having this polyhedral shape. For example, a tetraframe is a polyhedral chassis frame in the shape of a tetrahedron (see FIG. 9A), and an octaframe is a polyhedral chassis frame in the shape of an octahedron (see FIG. 1). Other variations presented visually herein include a cubeframe (a polyhedral chassis frame in the shape of a cube, see FIG. 9C) and an icosaframe (a polyhedral chassis frame in the shape of an icosahedron, see FIG. 9B). It is understood that any unfamiliar terms encountered in the disclosure which comprise the combination of a numerical prefix with the suffix “-frame” are following this naming convention and should be interpreted accordingly.

Preferred embodiments of the invented device may comprise or include a spacecraft chassis comprising a plurality of strut assemblies and a plurality of node assemblies, each node assembly coupled with at least three strut assemblies, whereby a plurality of poly-mount interfaces is formed, each poly-mount interface defined by at least three node assemblies and at least three strut assemblies, and the chassis assembly forms a power and signal network. Some embodiments of the spacecraft chassis may be molded, extruded, or otherwise manufactured as a single composite piece, rather than assembled.

At least one strut assembly may comprise a structural tube forming a first opposing end and a second opposing end and containing at least one power pathway and at least one signal pathway. At least one strut assembly may be coupled with a first node assembly at the first opposing end and a second node assembly at the second opposing end. At least one power pathway may electrically couple the first node assembly and the second node assembly. The first node assembly may comprise a first power pathway and a first external power contact, wherein the first power pathway provides an electrical power pathway from the at least one power pathway to the first external electrical contact, whereby a functional node coupled with the first node assembly receives electrical power via the first external power contact. The first node assembly may be electrically coupled to provide electrical power to a first functional module. The at least one signal pathway may electrically couple the first node assembly and the second node assembly. The first node assembly may comprise a first signal pathway and a first external signal contact, wherein the first signal pathway provides an electrical signal pathway from the at least one signal pathway to the first external signal contact, whereby a functional node coupled with the first node assembly receives electrical signal via the first external signal contact. The first node assembly may be electrically coupled to provide electrical signal to a first functional module.

The chassis may further comprise a network power pathway that extends through a plurality of strut assemblies and a plurality of node assemblies, whereby power is provided to at least two node assemblies. A first plurality of strut assemblies may be coupled by a first plurality of node assemblies to form a polygon with each vertex comprising a node assembly and each side comprising a strut assembly. The polygon may be a regular polygon. The polygon may present a first mounting interface for compatibly coupling together with a second mounting interface. The first mounting interface and the second mounting interface may couple together both mechanically and electrically. The plurality of strut assemblies may be coupled by the plurality of node assemblies to form a polyhedron wherein each vertex comprises a node assembly, each edge comprises a strut assembly, and each face is a polygon with each vertex comprising a node assembly and each side comprising a strut assembly. The polyhedron may be a regular polyhedron. The chassis may further comprise a plurality of interfaces each configured to accept a same functional module. At least one node assembly may further comprise an embedded microprocessor coupled with a control system.

Preferred embodiments of the invented device may comprise or include a spacecraft chassis interface component for inclusion on the exterior of a first device, to be disposed between the first device and a second device having a compatible interface, the interface component comprising a base frame having a device side and an interface side and including one or more mechanical mounting features; one or more internal electrical power channel connection points positioned on the device side of the base frame for electric coupling to any elements of the device which require electrical power; one or more internal power supply connection points positioned on the device side of the base frame for electric coupling to any elements of the device which provide electrical power; one or more external power supply connection points positioned on the interface side of the base frame for electrically coupling to a corresponding one or more external electrical power channel connection points of the interface of the second device, the one or more external power supply connection points electrically coupled to the one or more internal power supply connection points; one or more external electrical power channel connection points positioned on the interface side of the base frame for electrically coupling to one or more compatible external power supply connection points of the interface of the second device, the one or more external electrical power channel connection points electrically coupled to the one or more internal electrical power channel connection points; one or more internal data transmission connection points for electric coupling to any elements of the device which use a data connection; one or more external data transmission connection points for electric coupling to one or more data transmission connection points of the interface of the second device, the one or more external data transmission connection points electrically coupled to the one or more internal data transmission connection points, and/or a device incorporating some or all of these aspects.

To provide a whole-craft specification, a unique and automated business method utilizes a novel parameter called the Meta-Spec. On the simplest level, the Meta-Spec can be described as a specification of specifications. In its utilization, the Meta-Spec fully represents the spacecraft in all aspects of interest and is generated, step by step, on a software interface platform as the spacecraft is being created and tested. The Meta-Spec is much more than just a “bill of materials”, and is an automatically-generated top-level specification of a designed modular spacecraft. On a most basic level, the Meta-Spec is an archive of detailed specifications for all modules included in the spacecraft build, but the Meta-Spec goes far beyond that. The Meta-Spec is also a catalog of detailed metadata critical to the use and function of the spacecraft. When a user on a spacecraft-designing platform such as the spacecraft-designing platform interface presented in FIGS. 29 through 34 herein virtually assembles and tests a new spacecraft, the information system's metadata engine derives metadata of targeted types from the resulting spacecraft configuration. This can include: precise dimensional data and package contour of the current spacecraft configuration, mounting options and launch load limits, mass and mass distribution of the current spacecraft configuration, strength of structure from any given mount position, energy resource management variables such as: energy expended in each type of spacecraft maneuver, energy available to the system, etc., communication structure metadata (spacecraft command language), and legal metadata such as ownership status.

As a non-limiting example, one might consider an example embodiment where a telescope module is commanded to capture a picture taken in a specified direction. The telescope module's controller, upon receiving a “capture image” command, may issue a craft re-orientation command to an orientation module, and wait for a verification of the new fixed position before capturing and sending the image, by way of the network, to a storage drive inside a communication module. Starting at the point where the original “capture image” command was received by the telescope module, a thread of linked sub-commands can be followed by the metadata engine to correlate and catalogue the total energy expenditure of each command. The electronics draw on electrical power but there may be other energy factors to be accounted for. For example, the orientation module may have expended electrical energy powering its reaction wheel orientation devices or perhaps the re-orientation is accomplished expending propellent or fuel. Regardless of the configuration, the system's metadata engine can follow the command thread to derive, correlate, and catalog energy usage values for every command.

A Meta-Spec and a Mission-Plan of a designed spacecraft are each conceptualized as items that can be sold, purchased, or otherwise traded, and which data structures include metadata for keeping track of their own ownership. It is further understood that a physical spacecraft, itself, as per a design formulated in accordance with the invented method, would have at least two levels of ownership: virtual and physical. For example, a user's own efforts to configure and program a spacecraft gives the user the right to sell that configuration to another member of the platform, but the spacecraft itself does not physically exist until the “build” is purchased from the provider of the invented service. A Mission-Plan may be owned or traded, but the project's mission itself could not be initiated without the ownership of the physical spacecraft and the services contracted in the Mission-Plan.

As another example, one might consider an individual designing a modular spacecraft utilizing the spacecraft design interface of FIGS. 28 through 35, which modular spacecraft will be required to perform several different functions provided by various modules as designed and supplied by various different vendors and/or manufacturers. Since each module includes a detailed, structured specification which reports that mechanism's energy budget, the designer of the composite modular spacecraft will be able to determine which other modules should be included also to support operations of the craft, such as additional modules providing solar panels or other power generation. Further, interactions between modules and the energy cost of those interactions can be simulated and modeled as the craft is designed, providing guidance throughout for the designer as to whether the craft as currently designed can power itself adequately. Similar stats and modeling might be provided for other aspects, such as the overall mass of the craft in view of available propulsion, and placement of the craft's center of gravity.

The Meta-Spec represents the spacecraft as a whole. The individual modules may have detailed specifications (specs), but not necessarily include a Meta-Spec. As stated elsewhere, the Meta-Spec is automatically generated by metadata engines in the process of configuring the modules into a spacecraft. Module specifications are embedded by the module manufacturer, accurately representing the physical and operational parameters of interest. In preferred embodiments, a spacecraft may store its own Meta-Spec in memory, to provide as a reference resource for function modules which may be affected by the properties of the craft, such as for example a propulsion module requiring the information of how heavy the craft is and where the center of gravity is. It is noted that, since a Meta-Spec is automatically generated based on the aggregated specs of constituent modules, the Meta-Spec can be automatically updated even as new modules are installed or coupled onto the original craft over time. Embedding of the Meta-Spec in a special module (AI Module) that uses artificial intelligence to generate sophisticated planning, piloting and to autonomously direct exploration missions is an anticipated potential application.

Some anticipated benefits include seamless integration of components from multiple vendors without prior coordination between these vendors or custom hardware engineering. Providing of a convertibility standard such as the delta ring and compatible chassis geometry as discussed herein, one which provides standardization of power, data, and physical connection between components and modules, creates the opportunity to provide a module marketplace for licensing and integrating modules designed by multiple different vendors into designs of modular spacecraft.

Certain embodiments of the invented method presented herein demonstrate how the Meta-Spec is important in creating a project. The Mission-Plan includes the spacecraft used, the mission planning, logistics planning and other services such as launch, deployment, ground communications, etc. It starts with the selection of a spacecraft for the project. The spacecraft selection associates the spacecraft Meta-Spec with each of the tools used in the project. Within each tool, the Meta-Spec plays an important role in defining, acquiring and financing all services. While the Project Management page coordinates services and discussions, it also provides access to the Spacecraft Lab App and the Mission-Plan. Both of these apps also use the Meta-Spec's information to perform their tasks. For example, the Mission Planning App may use an array of information from the Meta-Spec including total mass, center of gravity, moment of inertia in three axes, spacecraft power usage, power generation and storage, thrust, orientation capability, instrument positions, etc.

The process of creating the Meta-Spec for a spacecraft can be dependent on several factors, including but not limited to the precise specifications for all selected modules (in all factors of interest), the precise relative physical positions and orientation of each module within the defined spacecraft, and a means of associating them in the process of creating the modular spacecraft.

Since spacecraft created with this platform are built on standard chassis assemblies of known dimension and each module's position and orientation in the frame structure of the chassis is also known, the chassis frame can act as 3-dimensional grid, precisely describing the relative position and orientation of each module in the spacecraft. Therefore, when defining the spacecraft configuration, a means is provided to know on which of the frame's poly-mount interfaces and in which orientation the module was joined. One way to do this is to provide a table, preferably or optionally auto-generated by the design software, showing all possible positions on the frame and requiring the spacecraft creator to populate the table with codes for selected modules.

Further aspects of the invented system and method may be related generally to a system and method for designing, planning, programming, building, launching and utilizing modular spacecraft. A Spacecraft Structured Data Asset (SSDA) is a token representing engineering added value and such value can be bought, licensed or sold as a commodity. SSDAs may be autonomously created within apps as algorithms respond to a user's configuration, programming and mission planning actions. The ability to buy and sell engineering value as SSDAs facilitates an equitable compensation strategy for engineering performed, without the usual negotiations and contracts. These assets can be bought, sold, licensed or otherwise traded in an open-source market ecosystem. The business method may include two: The Meta-Spec and the Mission-Plan. The Meta-Spec defines a spacecraft and the Mission-Plan defines how the spacecraft is deployed and operated.

The Meta-Spec may include or comprise the following aspects: A tradable asset that fully defines a spacecraft in all parameters of interest; This asset created and initially owned by the individual or organization that configures and programs said spacecraft; Combined with a means of reporting and updating Meta-Spec ownership (Meta-Spec data field for ownership or other identifier used to track ownership); And further combined with a means of automatically generating said Meta-Spec through the configuration of the spacecraft; User configured spacecraft created by specification of chassis frames and function modules and how they are joined at their poly-mount interfaces; And such combination of elements initiating meta-data engines to extract module specification data from said combination in all areas of interest; And processing such data to generate whole spacecraft operation data, command vocabulary, overall dimensions, shape, mounting points, power usage data, mass, center of gravity, moment of inertia, required expendable materials etc., while embedding and updating this whole-spacecraft meta-data within the Meta-Spec; And may include whole-spacecraft programming possibly defining new command vocabulary; And may also employ an embodiment of a user-configured spacecraft utilizing a simulated 3D app application; Such asset can be sold, purchased, licensed, or otherwise traded as allowed by Meta-Spec ownership; Includes data in all spacecraft functions of interest for use in subsequent dependent operations; And may be embedded in spacecraft control system (node controllers); And, finally, directing the physical manufacture of such defined spacecraft once purchased.

A Mission-Plan contains the information needed to carry out a mission, contains all operations required for spacecraft navigation as well as planned mission operations, and may include at least the following elements: A tradable asset that fully defines a spacecraft's deployment including trajectory plans and detailed mission operations; Such asset created and initially owned by an individual or organization, utilizing an owned Meta-Spec, and programing mission trajectory and mission operations; Combined with a means of reporting and updating Mission-Plan ownership (Mission-Plan data field for ownership or other identifier used to track ownership); And further combined with a means of automatically generating said Mission-Plan incorporating; A user directed mission-planning-tool application which utilizes planetary simulator data, orbital mechanics, etc. in conjunction with the spacecraft's Meta-Spec data and used in the calculation of a mission's planned trajectories, automatically programming the sequence and timing of the spacecraft's functions for required attitude control, thrust and other flight path and control maneuvers during the mission; Together with programmed mission operations such as initiating measurements, image capture, communications or other operations of interest, such programming possibly extending the command vocabulary; A Mission-Plan can be purchased, licensed, sold or otherwise traded as allowed by platform's Mission-Plan ownership; And may be embedded in spacecraft control system (node controllers); And, further, includes data in all spacecraft functions of interest for use in subsequent dependent operations such as launch requirements, calculated energy requirements, charging required, fuel, propellent, or other consumables.

In a similar manner, additional SSDAs can be created by other apps using metadata engines to configure other engineering assets. For example, SSDAs may be created for Launch and Deployment, Ground Services, and Logistics, each owned and traded in the same manner described for the Meta-Spec and Mission-Plan.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWING(S)

The detailed description of some embodiments of the invention is made below with reference to the accompanying figures, wherein like numerals represent corresponding parts of the figures.

FIG. 1 is a 3D model of an octaframe chassis assembly comprising a plurality of strut assemblies and a plurality of node assemblies forming a plurality of poly-mount interfaces;

FIG. 2 is a 3D model of a node assembly of the chassis of FIG. 1, presented in isolation;

FIG. 3A is a block diagram presenting an electronic communications network of the first chassis system of FIG. 1;

FIG. 3B is a diagram representing connections of the network of FIG. 3A;

FIG. 3C is a diagram providing a more complex exemplary representation of connections of the network of FIG. 3A;

FIG. 4A is a block diagram presenting hardware and software elements of the controller of the node assembly of FIG. 2;

FIG. 4B is a first block diagram presenting further detail of the block diagram of FIG. 4A;

FIG. 4C is a second block diagram presenting further detail of the block diagram of FIG. 4A;

FIG. 4D is a third block diagram presenting further detail of the block diagram of FIG. 4A;

FIG. 4E is a fourth block diagram presenting further detail of the block diagram of FIG. 4A;

FIG. 5 is a 3D model of a strut assembly of FIG. 1, presented in isolation;

FIG. 6A is a 3D model presenting a close-up view of one of the struts being coupled with one of the nodes of the chassis assembly of FIG. 1;

FIG. 6B is a 3D model presenting three corners of one of the plurality of poly-mount interfaces of the chassis assembly FIG. 1;

FIG. 7 is a 3D model of the first chassis assembly further coupled with an interface frame component;

FIG. 8 is a close view of one corner of the interface frame component of FIG. 7;

FIG. 9A is a first alternative chassis shape to the octaframe chassis shape of FIG. 1, specifically a tetraframe chassis assembly;

FIG. 9B is a second alternative chassis shape to the octaframe chassis shape of FIG. 1, specifically an icosaframe chassis assembly;

FIG. 9C is a third alternative chassis shape to the octaframe chassis shape of FIG. 1, specifically a cube chassis assembly;

FIG. 10A is a first combination chassis arrangement comprised of multiple instances of the octaframe chassis assembly of FIG. 1;

FIG. 10B is a second combination chassis arrangement comprised of multiple instances of the octaframe chassis assembly of FIG. 1 and the tetraframe assembly of FIG. 9A;

FIG. 10C is a third combination chassis arrangement comprised of multiple instances of the octaframe chassis assembly of FIG. 1;

FIG. 10D is a fourth combination chassis arrangement comprised of multiple instances of the octaframe chassis assembly of FIG. 1;

FIG. 11A is a first example of a function module which might be coupled onto the chassis of FIG. 1 or similar, specifically a visible imaging camera & infrared spectrometer function module;

FIG. 11B is a second example of a function module which might be coupled onto the chassis of FIG. 1 or similar, specifically a communications function module;

FIG. 11C is a third example of a function module which might be coupled onto the chassis of FIG. 1 or similar, specifically a telescope function module;

FIG. 11D is a fourth example of a function module which might be coupled onto the chassis of FIG. 1 or similar, specifically a PV array function module;

FIG. 12A presents an exploded view of the telescope function module of FIG. 11C;

FIG. 12B presents further detail pertaining to developer kit functionality of the delta ring of FIG. 7;

FIG. 12C presents a view of the communications function module of FIG. 11B with the back casing detached, showing how the interface frame component of FIG. 7 may be incorporated into this design;

FIG. 13 presents a 3D model of an exemplary modular spacecraft incorporating elements discussed in previous Figures, such as a composite chassis assembly as presented in FIGS. 10A through 10D and inclusion of each of the function modules of FIGS. 11A through 11D;

FIG. 14A is a first line diagram explicating further detail regarding the corner geometry of the frame modules of FIG. 1;

FIG. 14B is a second line diagram further explicating the geometric principles of FIG. 14A and depicting a three-strut node embodiment;

FIG. 14C is a third line diagram further explicating the geometric principles of FIG. 14A and depicting an embodiment forming a square-shaped frame module;

FIG. 14D is a fourth line diagram further explicating the geometric principles of FIG. 14A and depicting an embodiment forming a pentagon-shaped frame module;

FIG. 14E is a fifth line diagram further explicating the geometric principles of FIG. 14A and depicting an embodiment forming a hexagon-shaped frame module;

FIG. 15A is a line diagram of a design for the mount connector of FIG. 2 formulated in view of the geometry of FIGS. 14A through 14E;

FIG. 15B is a line diagram depicting how two mount connectors of FIG. 15A may be fitted together;

FIG. 16A is a 3D model presenting a first androgynous mount connector design as explicated in FIGS. 14A through 15B;

FIG. 16B is a 3D model of the mount connector design of FIG. 16A presenting further information;

FIG. 16C is a 3D model of the mount connector design of FIG. 16A presenting further information;

FIG. 16D is a 3D model presenting two instances of the mount connector design of FIG. 16A being compatibly fitted together;

FIG. 16E is a first diagram regarding the internal contact point circuitry described by FIGS. 16B through 16D;

FIG. 16F is a second diagram regarding the internal contact point circuitry described by FIGS. 16B through 16D;

FIG. 16G is a third diagram regarding the internal contact point circuitry described by FIGS. 16B through 16D;

FIG. 16H is a fourth diagram regarding the internal contact point circuitry described by FIGS. 16B through 16D;

FIG. 17A is a 3D model presenting a second androgynous mount connector design as explicated in FIGS. 14A through 16D;

FIG. 17B is a 3D model presenting two instances of the mount connector design of FIG. 17A being compatibly fitted together;

FIG. 18A is a 3D model presenting a third androgynous mount connector design as explicated in FIGS. 14A through 17B;

FIG. 18B is a 3D model presenting two instances of the mount connector design of FIG. 18A being compatibly fitted together;

FIG. 19A is a 3D model presenting a fourth androgynous mount connector design as explicated in FIGS. 14A through 18B;

FIG. 19B is a 3D model presenting two instances of the mount connector design of FIG. 19A being compatibly fitted together;

FIG. 20A is a 3D model presenting a fifth androgynous mount connector design as explicated in FIGS. 14A through 19B;

FIG. 20B is a 3D model presenting two instances of the mount connector design of FIG. 20A being compatibly fitted together;

FIG. 21 is a diagram presenting geometry relevant to a compliant restraining apparatus for coupling with the delta ring of FIG. 7 or other elements;

FIG. 22A is a simplified model presenting aspects of coupling together two triangular frames in accordance with the geometric principles of FIG. 21;

FIG. 22B is a second view of the model of FIG. 22A presenting the frames in a coupled position;

FIG. 22C is a detail of the assembled model of FIG. 22B, showing the fit of the pin within the slot;

FIG. 22D is the view of FIG. 22C, further including a retaining fastener;

FIG. 23A is a 3D model of a parallel fixture device which might provide an alternative to the mechanical fastening concepts of FIGS. 21 through 22D;

FIG. 23B is a second image of the model of FIG. 23A, annotated with arrows to show the freedom of movement of an attached fastener;

FIG. 24 is a 3D model of the node assembly of FIG. 2 coupled with a plurality of struts, annotated with arrows regarding available motion of the fastener of FIGS. 23A & 23B;

FIG. 25A is a 3D model of the node assembly of FIG. 24, showing coupling of the flex mount of FIG. 23A to the node assembly;

FIG. 25B is a 3D model of the node assembly of FIG. 24, showing the coupling of a coupling guide element to the node assembly;

FIG. 26A is a 3D model presenting two of the node assemblies of FIG. 25A coupled together;

FIG. 26B is a diagram presenting internal coupling fixtures of the two coupled-together node assemblies of FIG. 26A;

FIG. 27A is a 3D model presenting an exploded view of the mounting assembly of FIG. 2 with the mechanical coupling assembly of FIGS. 21 through 26B and the androgynous connector design of FIGS. 14A through 20B incorporated;

FIG. 27B is a 3D model presenting an assembled view of the mounting assembly of FIG. 2 with the mechanical coupling assembly of FIGS. 21 through 26B and the androgynous connector design of FIGS. 14A through 20B incorporated;

FIG. 27C is a 3D model presenting the mounting assembly of FIG. 27B coupling onto the node assembly of FIG. 2;

FIG. 28A is a block diagram representing the invented Meta-Spec data structure as discussed further in FIGS. 30 through 35;

FIG. 28B is a block diagram representing the invented Mission-Plan data structure as discussed further in FIGS. 30 through 35;

FIG. 29 is a diagram of an electronic communications network for providing services related to designing and managing modular spacecraft designed in accordance with the invented method, such as the example modules of FIGS. 11A through 11D;

FIG. 30 is an example home screen for an interface for designing modular spacecraft utilizing the network environment of FIG. 29;

FIG. 31 is a process chart representing a business flow associated with the home screen of FIG. 30;

FIG. 32 is an example project management page for an interface for designing modular spacecraft utilizing the network environment of FIG. 29;

FIG. 33 is a process chart representing a method flow associated with the project management screen of FIG. 32;

FIG. 34 is an example spacecraft lab page for an interface for designing modular spacecraft utilizing the network environment of FIG. 29;

FIG. 35 is a process chart representing a method flow associated with the spacecraft lab screen of FIG. 34;

FIG. 36 is a process chart presenting a method for designing modular spacecraft utilizing the interface of FIGS. 34 and 35;

FIG. 37A is a first line diagram presenting an alternative embodiment of the chassis of FIG. 1 which is manufactured as a single piece of material;

FIG. 37B is a second line diagram presenting details of the single-piece chassis of FIG. 37A;

FIG. 37C is a third line diagram presenting details of the single-piece chassis of FIG. 37A; and

FIG. 37D is a fourth line diagram presenting details of the single-piece chassis of FIG. 37A.

### DETAILED DESCRIPTION OF THE INVENTION

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the range's limits, an excluding of either or both of those included limits is also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.)

Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Throughout this specification, like reference numbers signify the same elements throughout the description of the figures.

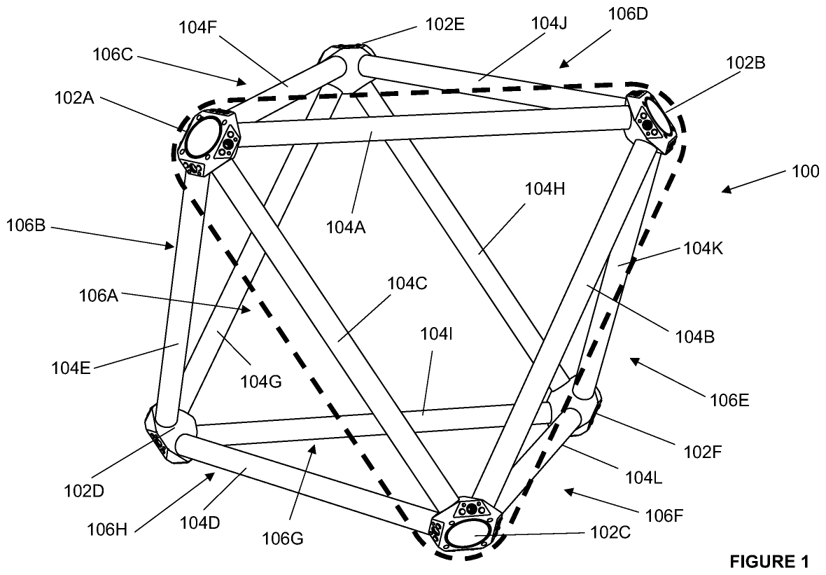

Referring now generally to the Figures, and particularly to FIG. 1, FIG. 1 is a 3D model of an octaframe chassis assembly 100 comprising a plurality of node assemblies 102 (“the nodes 102”) and a plurality of strut assemblies 104 (“the struts 104”). The octaframe chassis assembly 100 is in the shape of an octahedron, which is an eight-sided regular polyhedron, with each side an equilateral triangle; while this is one preferred shape, other preferred possible shapes will be presented in later Figures, and the shape of the chassis of various alternative embodiments of the invented system is not limited to this specific geometry. Individual instances of the nodes 102 are labeled in this Figure, specifically a first node 102A, a second node 102B, a third node 102C, a fourth node 102D, a fifth node 102E, and a sixth node 102F. Individual instances of the struts 104 are labeled in this Figure, specifically a first strut 104A, a second strut 104B, a third strut 104C, a fourth strut 104D, a fifth strut 104E, a sixth strut 104F, a seventh strut 104G, an eighth strut 104H, a ninth strut 104I, a tenth strut 104J, an eleventh strut 104K, and a twelfth strut 104L.

The coupling of the nodes 102 and the struts 104 forms a plurality of poly-mount interfaces 106, faces of the shape of the chassis to which other chassis or modules might be attached; it is noted that each of the poly-mount interfaces 106 of the octaframe chassis assembly 100 presented in FIG. 1 are triangular, but this aspect may vary depending on the geometric shape of the chassis. Specifically, a first poly-mount interface 106A is formed by the first node 102A, the second node 102B, the third node 102C, the first strut 104A, the second strut 104B, and the third strut 104C; a second poly-mount interface 106B is formed by the first node 102A, the third node 102C, the fourth node 102D, the third strut 104C, the fourth strut 104D, and the fifth strut 104E; a third poly-mount interface 106C is formed by the first node 102A, the fourth node 102D, the fifth node 102E, the fifth strut 104E, the sixth strut 104F, and the seventh strut 104G; a fourth poly-mount interface 106D is formed by the first node 102A, the second node 102B, the fifth node 102E, the first strut 104A, the sixth strut 104F, and the tenth strut 104J; a fifth poly-mount interface 106E is formed by the second node 102B, the fifth node 102E, the sixth node 102F, the eighth strut 104H, the tenth strut 104J, and the eleventh strut 104K; a sixth poly-mount interface 106F is formed by the second node 102B, the third node 102C, the sixth node 102F, the second strut 104B, the eleventh strut 104K, and the twelfth strut 104L; a seventh poly-mount interface 106G is formed by the fourth node 102D, the fifth node 102E, the sixth node 102F, the seventh strut 104G, the eighth strut 104H, and the ninth strut 104I; and an eighth poly-mount interface 106H is formed by the third node 102C, the fourth node 102D, the sixth node 102F, the fourth strut 104D, the ninth strut 104I, and the twelfth strut 104L. The dotted triangle outline marked in the Figure shows the first poly-mount interface 106A.

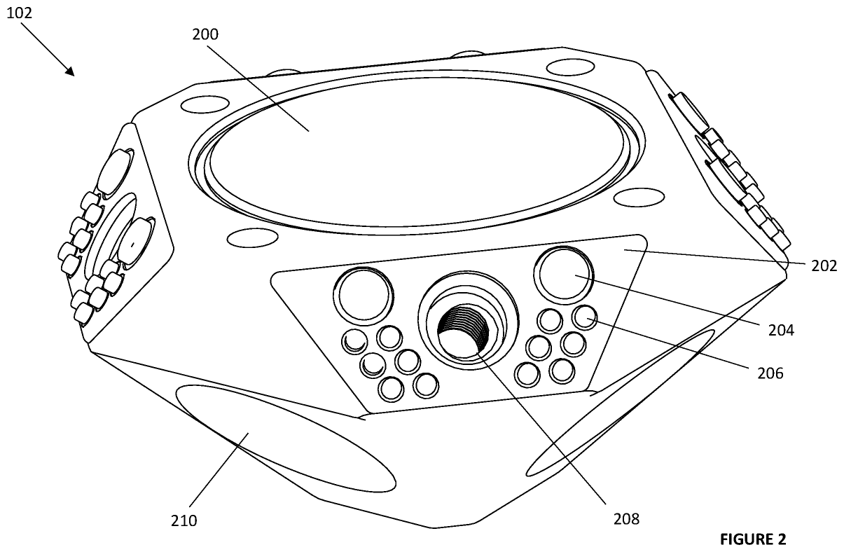

Referring now generally to the Figures, and particularly to FIG. 2, FIG. 2 is a 3D model of one of the nodes 102, such as the first node 102A, of the octaframe chassis assembly 100, presented individually. Each of the nodes 102 may further include an embedded microprocessor & control system 200 (“the node controller 200”), may further include one or more mount connectors 202 which may further include one or more power connectors 204, one or more data connectors 206, and/or one or more module mechanical fastening features 208; and may include three or more strut connection points 210 for coupling the struts 104 to this one of the nodes 102 as presented in FIG. 1. An assembly of multiple of the nodes 102 may include a plurality of instances of the node controller 200, therefore terminology of “the node controllers 200” will also be utilized herein.

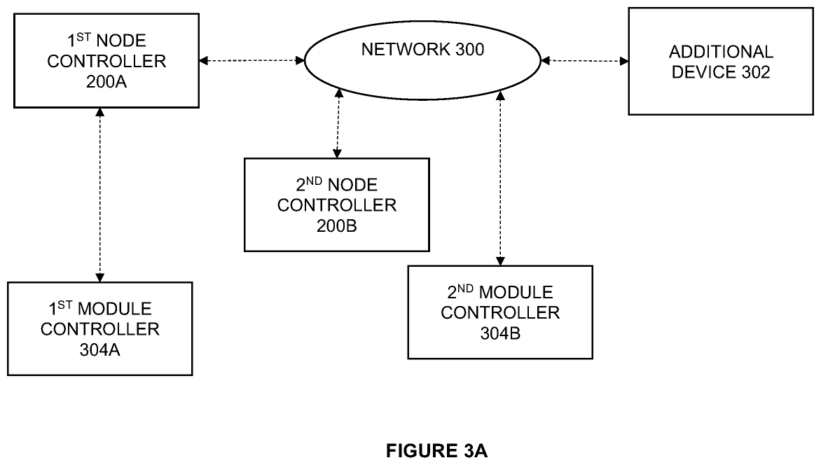

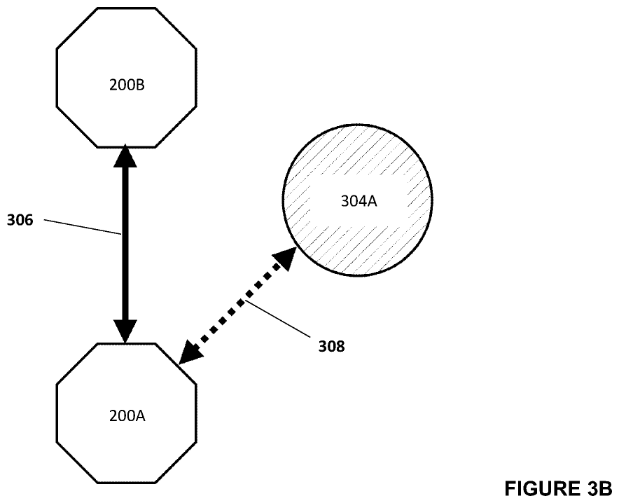

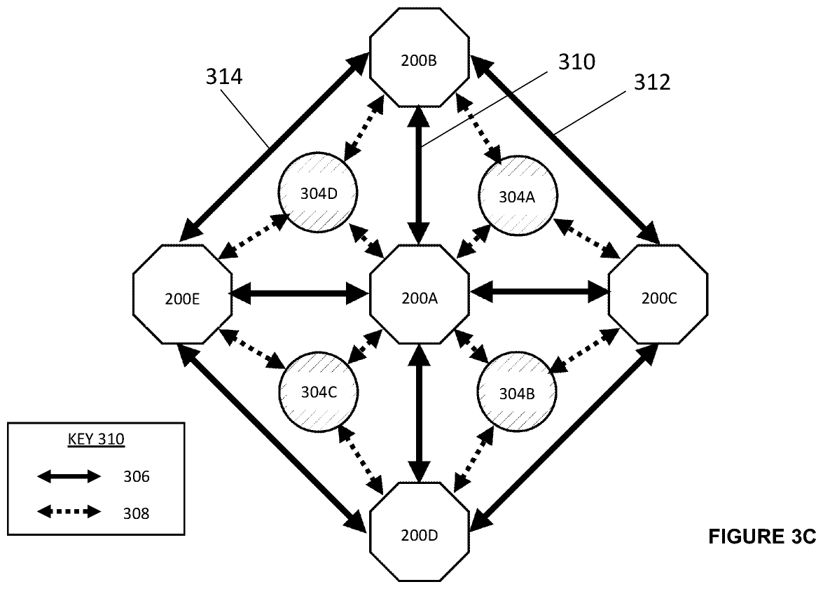

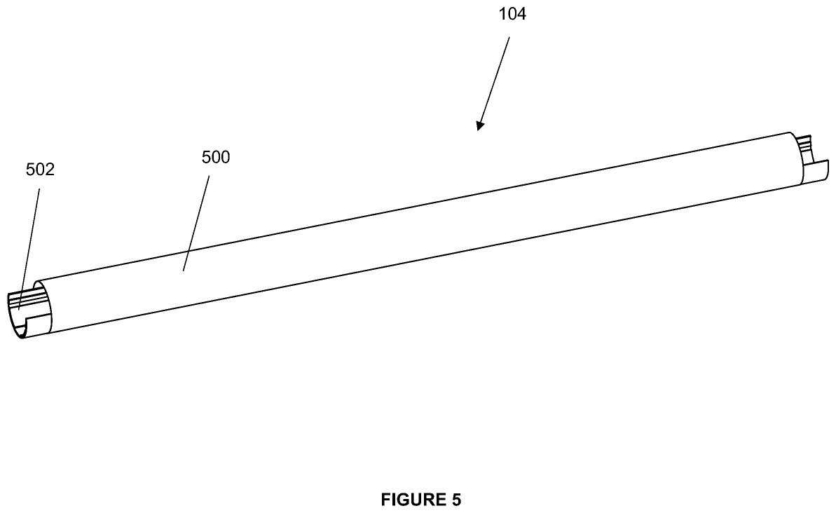

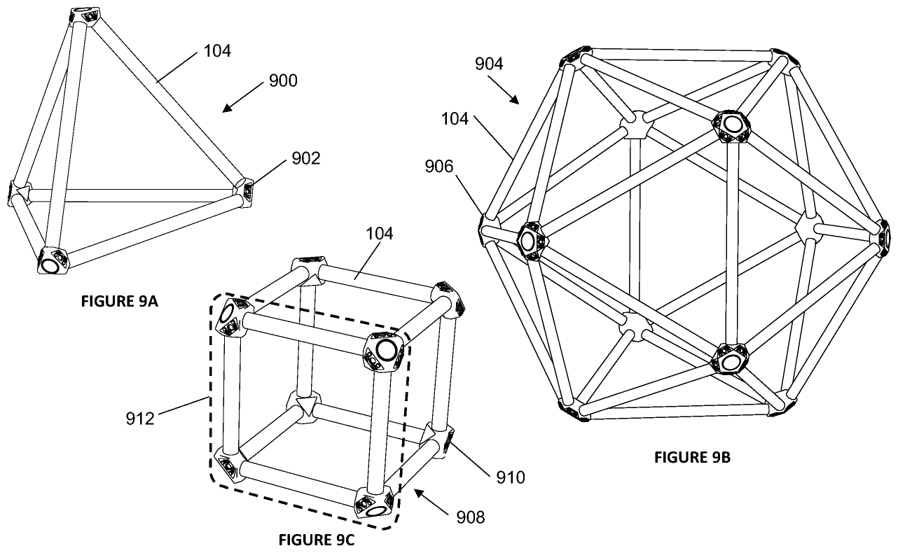

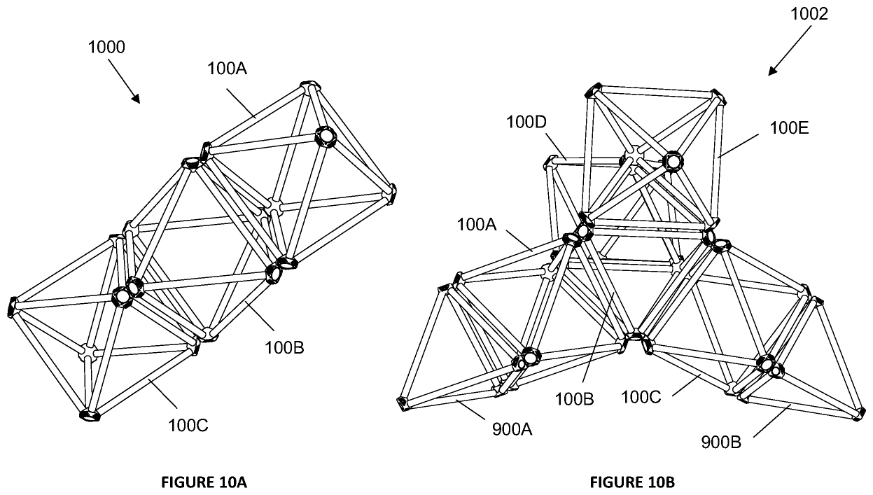

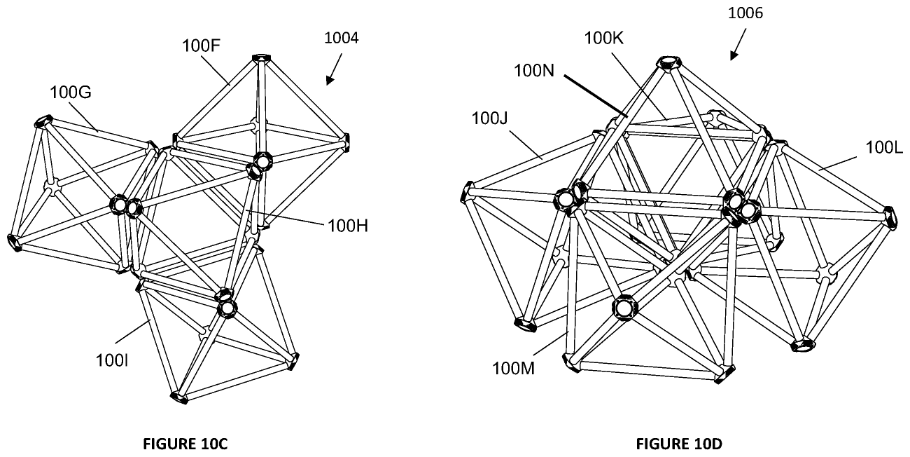

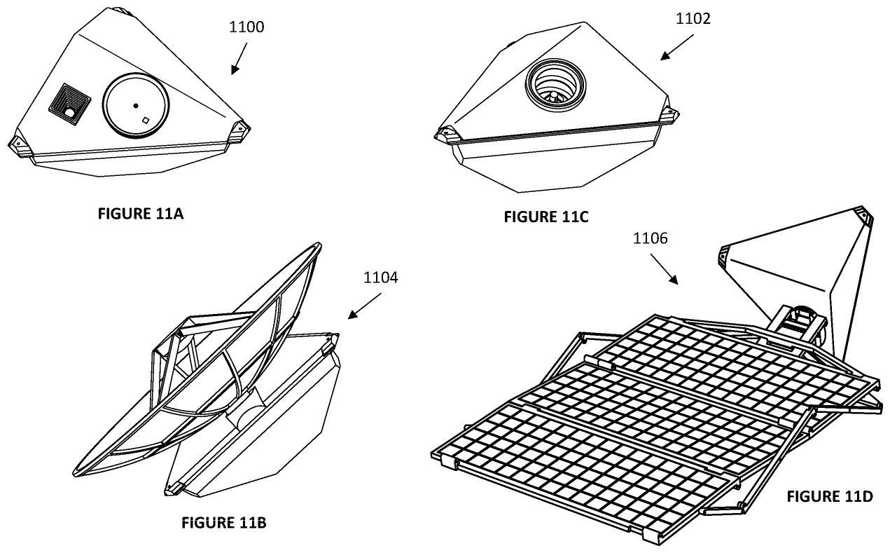

Referring now generally to the Figures, and particularly to FIG. 3A, FIG. 3A is a block diagram presenting an electronic communications network 300 (“the network 300”) of the first chassis system 100, in which a first node controller 200A, a second node controller 200B, an additional device 302, a first module controller 304A, and a second module controller 304B are networked together. The first node controller 200A and the second node controller 200B may be instances of the node controller 200 belonging to different ones of the nodes 102, such as the first node 102A and the second node 102B of FIG. 1. In preferred embodiments, the nodes 102 of the first chassis system 100 are networked together via a data transmission medium (such as wiring or fiber optic cable) in the struts 104 (see FIG. 5). Further, a compatible function module installed in the first chassis system 100, such as but not limited to the function module examples of FIGS. 11A through 11D, may have its own controller which is also connected to the network 300, either through one of the node controllers 200 or directly, as represented here by the first module controller 304A and the second module controller 304B. A module controller 304, such as the first module controller 304A or the second module controller 304B, may be connected to the network 300 either indirectly through a connection to one or more of the node controllers 200 (as represented by the first module controller 304A in this diagram), or directly (as represented by the second module controller 304B in this diagram). It is understood that this diagram is not comprehensive or exhaustive, and presents a representative few of the node controllers 200 and a representative few instances of a module controller 304, the first module controller 304A and the second module controller 304B, rather than attempting to represent every single one of either that might be included, particularly since the network 300 can vary in size, complexity, and number of connections depending on how many of the nodes 102 and modules such as but not limited to the function module examples of FIGS. 11A through 11D may be present, connected to a same single chassis or to one of an interconnected structure of chassis such as but not limited to the assemblies of FIGS. 10A through 10D.

In addition to the nodes 102 being interconnected, this same network might be connected to by an additional device, such as but not limited to (a.) another craft such as a nearby satellite or spaceship, or (b.) a diagnostic tool capable of interfacing with the network 300 of the first chassis system 100; all of these possibilities and any other possible device besides a node or module that might connect to the network 300 are collectively represented here with inclusion of the additional device 302.

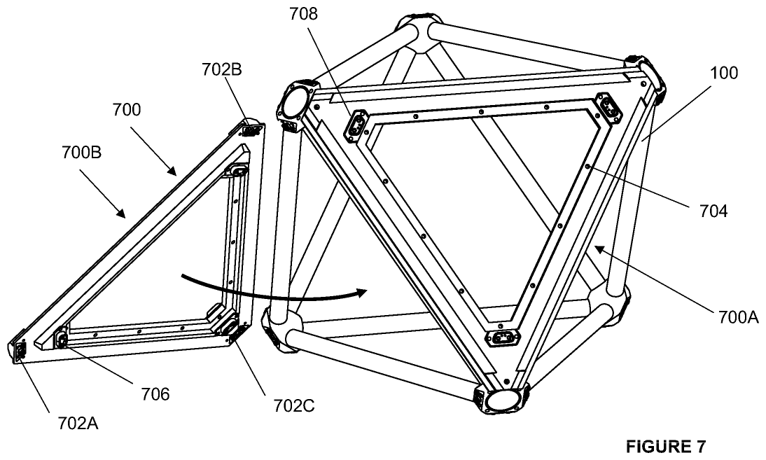

Referring now generally to the Figures, and particularly to FIG. 3B, FIG. 3B is a diagram representing connections of the network 300, specifically a node-to-node interconnection 306 between the first controller 200A and the second controller 200B, and a node-to-module interconnection 308 between the first controller 200A and the first module controller 304A, a controller of a function module such as but not limited to one of the function module examples of FIGS. 11A-D. A plurality of node-to-node interconnections 306 throughout a chassis, such as but not limited to the octaframe chassis assembly 100 of FIG. 1, carry power and data throughout a spacecraft's networks. A plurality of node-to-function-module interconnections 308 give the attached module access to the fault-tolerant power and communications network provided by a chassis, such as but not limited to the octaframe chassis assembly 100 of FIG. 1. Regarding the node-to-node interconnection 306, this may be embodied as the wiring encased in one of the struts 104, and may comprise or include some or all of the following: at least one Power connection, at least one Device Bus connection, may include Network interconnections, may include additional High-Speed Serial interconnections, may include other connections for Node-To-Node Power, and Control System management. Regarding the node-to-function-module interconnection 308, this may be embodied as the wiring of the delta ring 700 of FIG. 7, and may comprise or include some or all of the following: at least one Power, at least one High-Speed Serial (device command) connection, possible additional High-Speed Serial lines, and possible Device Buses. Each of the node controllers 200 controls whether the signals and power received from adjacent nodes 102 are allowed to be passed on to other adjacent nodes 102. In the same way, module-node connections 308 can be monitored and selectively broken as required for fault protection. With each node 102 operating in a module frame network, this strategy can mitigate a wide array of failures.

Referring now generally to the Figures, and particularly to FIG. 3C, FIG. 3C is a diagram providing a more complex exemplary representation of connections between a plurality of node controllers 200 and a plurality of module controllers 304. Specifically, the first node controller 200A, the second node controller 200B, a third node controller 200C, a fourth node controller 200D, and a fifth node controller 200E are represented here, interconnected by a plurality of node-to-node interconnections 306 represented by solid lines per a key 310. Additionally, the plurality of module controllers 304 are specifically the first module controller 304A, a second module controller 304B, a third module controller 304C, and a fourth module controller 304D. Each of these is connected to its respective adjacent node controllers 200 by node-module connections 308, as represented by dotted lines per the key 310. As one example, the first module controller 304A is connected by a plurality of node-module connections 308 to each of the first node controller 200A, the second node controller 200B, and the third node controller 300C.

It is noted that the controllers 200 of the nodes 102 surrounding the first node 102A (and therefore the first node controller 200A) is presented here as an example, and this interconnected structure of communications may be present around any one of the nodes 102 including all. Continuing with the example of the octaframe chassis assembly 100 of FIG. 1, the first node 102A would directly communicate with the four adjacent ones of the nodes 102, specifically the second node 102B, the third node 102C, the fourth node 102D, and the fifth node 102E, as presented here. Since the nodes 102 form an interconnected web, the same one of the node controllers 200 or the module controllers 304 may receive the same signals or data transmission via multiple connections; this redundancy may provide increased fault protection by using N-Redundant devices or algorithms to filter data by comparing the redundant signals from different connections, provide the ability to selectively isolate any part of the network that may not be working correctly without cutting off other portions of the network, and also provide backup connections in the event that the spacecraft gets damaged.

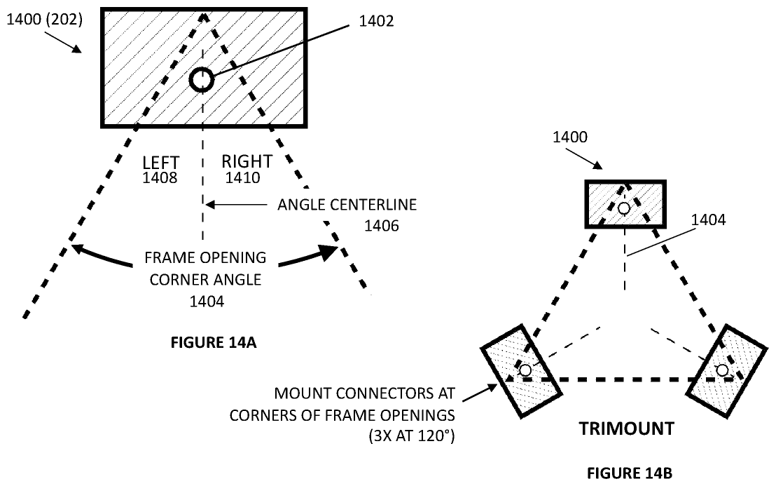

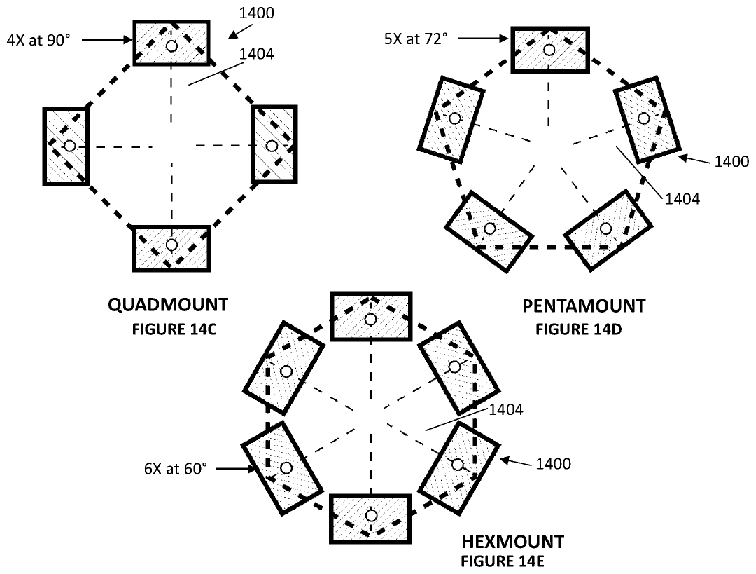

In preferred embodiments, every node 102 has a node controller 200. In an assembly such as but not limited to the octaframe chassis assembly 100, each node 102 is connected to adjacent nodes 102 by way of struts 104. In preferred embodiments, the nodes 102 may be identical but independently operating. Each of the nodes 102 has the ability to communicate directly with the node controllers 200 of adjacent nodes 102. Each node 102 may also communicate, separately, with the module controllers 304 of adjacently-positioned function modules such as, but not limited to, the function module examples of FIG. 11A through 11D, by way of the poly-mount connectors of the node 102 as illustrated in FIGS. 14A through 21.

Here follow some examples of robust fault protection offered by this method. It is understood that these are non-limiting example cases demonstrating the benefit of this design feature.

In a first example case, one of the struts 104 carrying a first example node-to-node interconnection 312 has received mechanical damage, making the first example node-to-node interconnection 312 intermittent. The first node controller 200A detects the failure and disconnects the signal. The second node controller 200B has also detected the failure and disconnects the first example node-to-node interconnection 312 as well. Now the example node-to-node interconnection 312 has been completely isolated from the rest of the network 300. The other redundant node-to-node interconnections 306 are still connected, and minimal loss in function is experienced.

In a second example case similar to the first example case, the damaged strut 104 of the first example may still include non-intermittent signals (i.e. wires which weren't damaged), but the detected damage to at least part of the rest of that strut 104 may prompt the adjacent nodes 102 to consider even the leftover intact connections adjacent to the damage to be suspect. Since other undamaged connections provide redundancy, any connection that even might be suspect can be isolated until repaired or verified, with minimal loss of functionality.

In a third example case, the second node controller 200B fails, producing errant signals to the four other node controllers 200 which are networked to the second node controller 200B (it is noted that only three of those four are included in this diagram: the first node controller 200A, the third node controller 200C and the fifth node controller 200E). The first node controller 200A may detect the failure by comparing incoming redundant signals; since the second node controller 200B is malfunctioning and the third node controller 200C, fourth node controller 200D, and fifth node controller 200E are not, the second node controller 200B may produce a distorted signal output in comparison to non-malfunctioning node controllers 200. The node-to-node interconnections 306 leading to the second node controller 200B are shut down—specifically, the first example node-to-node interconnection 312, a second example node-to-node interconnection 314, and a third example node-to-node interconnection 316, and a fourth node-to-node interconnection which is not shown in the diagram which would correspond to the tenth strut 104K leading to the sixth node 102F of the octaframe chassis assembly of FIG. 1. The function modules may also be advised by the network 300 to shut down the node-module connections 308 leading to the second node controller 200B. Even with the malfunctioning node controller 200B isolated, the octaframe chassis assembly 100 would still have 5 out of 6 functional nodes 102, minimizing loss in function.

In a fourth example case, a physical connector contact between the first node 102A and the module controlled by the first module controller 304A fails and becomes an open circuit, intermittent or noisy. The first node controller 200A can isolate this connection and keep the “noise” out of the rest of the network 300. The first module controller 304A is still communicating by way of the node-module interconnections 306 to the second node controller 200B and the third node controller 200C, so there is minimal loss in function.

In a fifth example case, radiation is triggering random bit-flips on all of the node-to-node interconnections 306 connected to the first node controller 200A. The first node controller 200A can significantly repair those data streams by use of its 4-Redundant majority logic gates, voting on each bit.

In a sixth example case, a module controller such as but not limited to the first module controller 304A has failed and is sending corrupted command data to the network 300.

After analysis at the node controller 200, level or from a ground control intervention, the 3 nodes 102 attached to that module can be instructed to isolate the failing hardware. It is noted that the modular design concept overall may make it easy to have an identical module included in the same spacecraft as a backup, which can take over the tasks of the malfunctioning one. Further, if the data connections to the malfunctioning module are still working, then the module can be designated as offline and isolated from the network 300, but still enable connective access for use in troubleshooting or debugging the malfunction, such as by a ground control operator or an astronaut.

In a seventh example case, a detected problem or a change in a mission requires the spacecraft to be reprogrammed, such as by ground control operators, to change the operational algorithms or spacecraft function. The network 300 can facilitate this without interruption of function, by designating a plurality of node controllers 200 offline for reprogramming while continuing to operate the craft with the rest of the node controllers 200 not designated as offline. For instance, the octaframe chassis assembly 100 of FIG. 1 includes six nodes 102, but can function with only three of the nodes 102 online. Therefore, three nodes 102 can be shut down and reprogrammed while the other three nodes 102 continue to control the spacecraft. It is noted that, even if the spacecraft shouldn't continue performing the tasks of the old mission without being reprogrammed, it may still be preferable to reprogram the nodes 102 in “shifts” such that there are always enough nodes 102 supporting basic functionality of the craft, such as avoiding collisions, maneuvering, storing incoming sensor data, and providing network infrastructure. After the programming, the nodes 102 with the former program can be isolated while the newly programmed nodes 102 can be brought online and tested. This is a valuable capability because if the new program fails for some reason, the nodes 102 with the old program can be brought back online to operate as before until the problem is fixed. If the new program is successful, the three nodes with the old program can be also reprogrammed and brought back online.

The cluster of node controllers 200 in a chassis assembly (such as 6 in the octaframe chassis assembly 100 of FIG. 1) can also work in conjunction with each other to perform higher level analysis of craft function, possibly isolating modules or various interconnects based on shared analysis or ground control. One simple example would be a situation, such as the first example case, where other still-functioning signals in a damaged strut 104 might be determined to be suspect and are therefore isolated by adjacent node controllers 200 with minimal loss of function. All these fault-protection methods add protection in addition to common non-redundant error checking commonly used in data streams such as checksums and the like.

In addition to fault tolerance, the fully networked CPUs of the node controllers 200 can be used in parallel computing and/or as a computer cluster to perform higher-level analysis at greater speeds. The cluster of node controllers 200 in a chassis assembly (such as 6 in the octaframe chassis assembly 100 of FIG. 1) can also work in conjunction with each other to perform housekeeping analysis of craft function, possibly isolating modules or various interconnects based on shared analysis or ground control.

Although shown applied to the octaframe chassis assembly 100, these architecture principles are as useful for any chassis shape, such as icosaframes, tetraframes, or cubes, with the number and configuration of connections adjusted accordingly. In the case of icosaframe, each of the nodes 102 may communicate redundantly with five adjacent nodes and up to five connected modules. The tetraframe may communicate redundantly with three adjacent nodes and up to three modules.

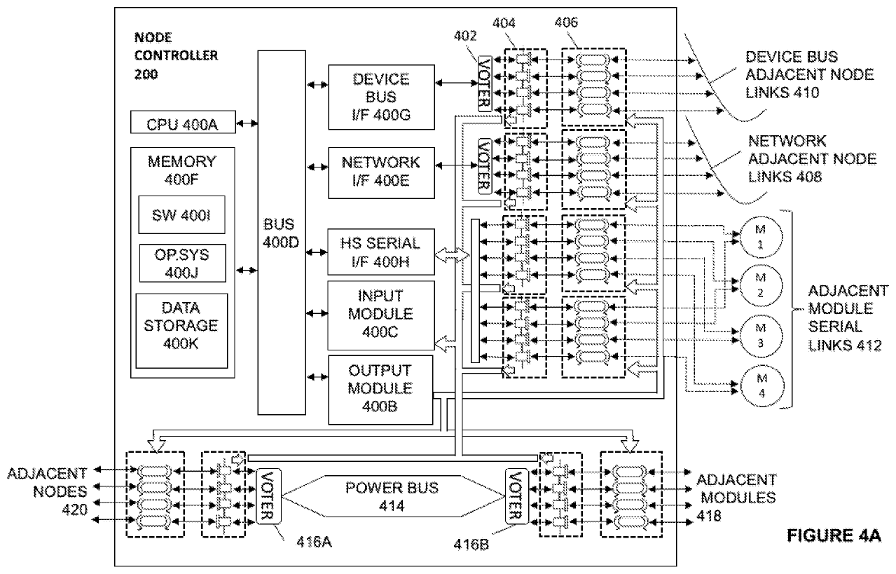

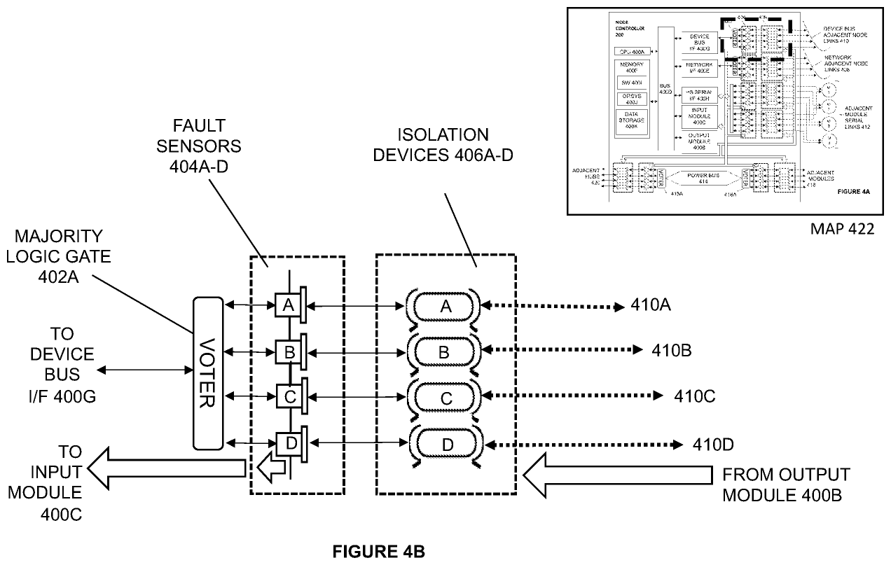

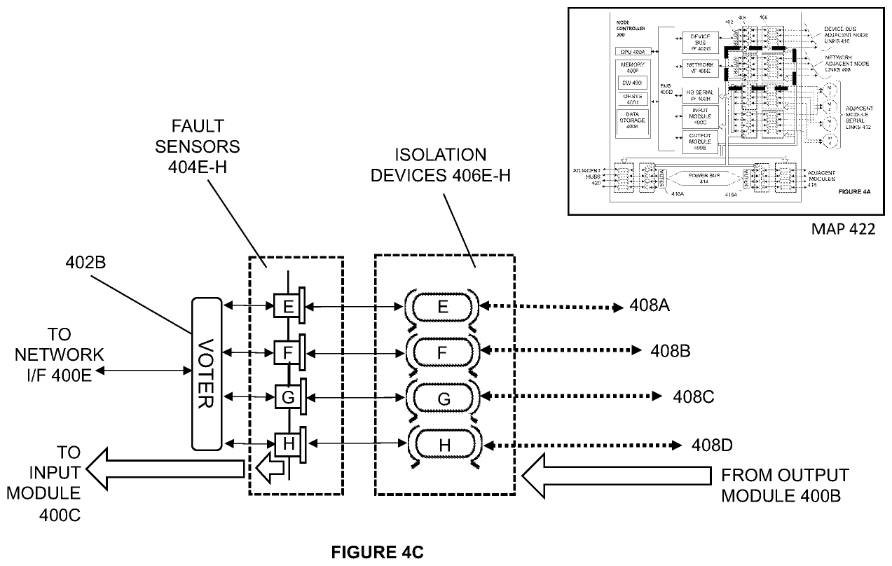

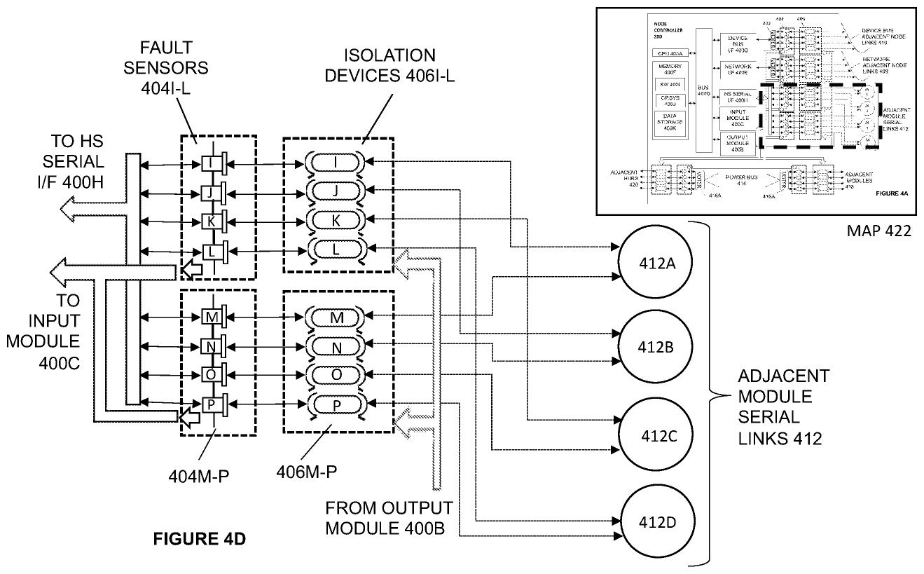

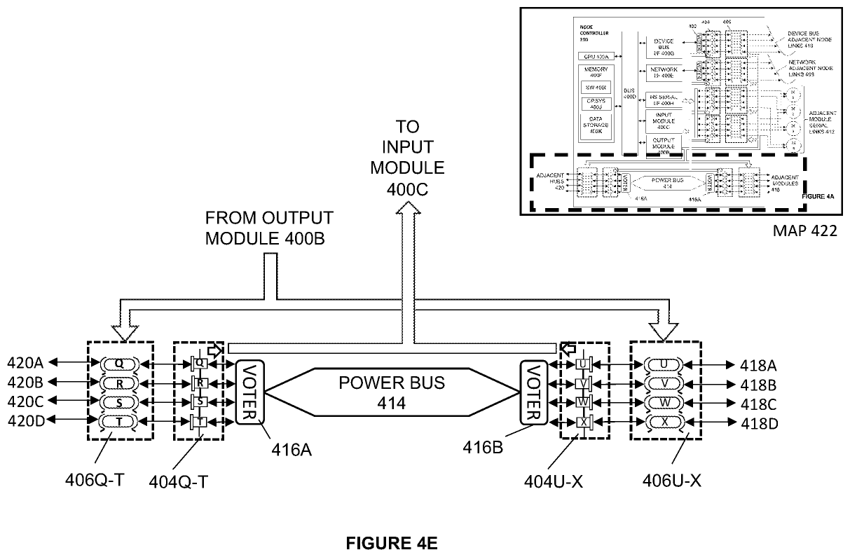

Referring now generally to the Figures, and particularly to FIG. 4A, FIG. 4A is a block diagram of a representative one of the node controllers 200 of the octaframe chassis assembly 100 as connected to the network 300, and displaying together both hardware and software aspects thereof, wherein the node controller 200 comprises: a central processing unit or “CPU” 400A; an output module 400B; an input module 400C; a software bus 400D; a network interface 400E; a memory 400F; a device bus interface 400G; and a high-speed serial interface 400H.

Some preferred hardware and software elements for providing the redundancy, selectivity in connection, error-checking, and error-handling described herein generally and particularly regarding FIG. 3C, are also presented in this diagram, specifically a plurality of majority logic gates 402, a plurality of fault sensors 404, and a plurality of isolation devices 406 as presented in further detail in FIGS. 4B through 4E.

The output module 400B might be any module or modules suited to communicating data output, such as but not limited to displaying a user interface; one non-limiting example of a component of the output module 400B might be the necessary hardware and driver support for a visual display element such as a monitor. The output module 400B may further be communicatively coupled to certain of the isolation devices 406.

The input module 400C might be any module or modules suited to receiving data input, such as but not limited to receiving commands from a user or collecting of sensor data; one non-limiting example of an input module component might be the necessary hardware and driver support for use of a keyboard, keypad, or touch-screen. It is noted that the node controller 200 might also alternatively communicate data entirely via the network connections (without, for instance, providing individual support at every single one of the nodes 102 for including a keyboard and/or screen), but these potential features are depicted in the interest of completeness; the redundancy of some “manual” data connections for the use of a human user may be preferable for emergency or debug purposes. The input module 400C may receive input from several external sources, as shown, including but not limited to the power and data connections between this node controller 200 and others, or between this node controller 200 and adjacent module controllers 304.

The software bus 400D facilitates communications between the above-mentioned components of the node controller 200, and is bi-directionally communicatively coupled with the CPU 400A, the output module 400B, the input module 400C, the network interface 400E, the memory 400F, the device bus interface 400G, and the high-speed serial interface 400H. The software bus 400D may be a CAN bus. The device bus interface 400G may use CAN bus, a FlexRay bus, or other device protocol as known in the art.

The network interface 400E enables communication with others of the node controllers 200 connected via the network 300 of the octaframe chassis assembly 100 and with other connected compatible devices, and supports a bi-directional communicative coupling apparatus comprising a plurality of the majority logic gates 402, a plurality of the fault sensors 404, and a plurality of the isolation devices 406 as shown, facilitating communications between the node controller 200 and the network adjacent node links 408.

The memory 400F of the node controller 200 includes a software operating system OP.SYS 400G. The software operating system OP.SYS 400G of the node controller 200 may be selected from freely available, open source and/or commercially available operating system software known in the art capable of providing networking and operating system services as known in the art. The exemplary software program SW 400H consisting of executable instructions and associated data structures is optionally adapted to enable the node controller 200 to perform, execute and instantiate all elements, aspects and steps as required of the node controller 200 to practice various preferred embodiments of the invented method, including in interaction with other devices of the network 300 of the octaframe chassis assembly 100, such as but not limited to the first node controller 200A, the second node controller 200B, the first module controller 304A, and the additional device 302 of the network 300. The memory 400F of the node controller 200 further includes data storage 400K, such as data storage for performing local functions of the node controller 200, or extra network storage that can be made available for other node controllers 200 or module controllers 304 to use as needed.

The device bus interface 400G supports a bi-directional communicative coupling apparatus comprising a plurality of the majority logic gates 402, a plurality of the fault sensors 404, and a plurality of the isolation devices 406 as shown, facilitating communications between the node controller 200 and the device bus adjacent node links 410.

The high-speed serial interface 400H is an interface with the high-speed serial communications lines which connect the node controller 200 to adjacent module serial links 412 leading to adjacent module controllers 304 as discussed in FIGS. 3A through 3C. The high-speed serial interface 400H supports a bi-directional communicative coupling apparatus comprising a plurality of the majority logic gates 402, a plurality of the fault sensors 404, and a plurality of the isolation devices 406 as shown, for facilitating this communication.

A power bus 414 is also presented. The power bus 414 is bi-directionally electronically coupled through a bi-directional electronic coupling apparatus comprising a first power majority logic gate 416A, a second power majority logic gate 416B, a plurality of the fault sensors 404, and a plurality of the isolation devices 406, as shown, to a plurality of adjacent module links 418—that is, the power systems of function modules such as but not limited to the function module examples of FIGS. 11A through 11D—and a plurality of adjacent node links 420—that is, links to power buses 414 belonging to adjacent node controllers 200, such that power coupling between node controllers 102 or between nodes and module controllers 304 can be checked for consistency and/or selectively disabled, as discussed with regard to FIG. 3C.

It is further understood that, if only used for power, a power bus such as the power bus 414 might not benefit from “Majority Logic Gates” but these may be important if the power bus 414 is used with “Power-Line Communication” technology to transmit and receive data over the same conductors used to supply power. Current state of the art technologies are available to accomplish this for both AC and DC buses. If the power bus 414 is used with Power-Line Communication technology, the first power majority logic gate 416A and the second power majority logic gate 416B would be very useful. Using Power-Line Communications over the power bus 414 can have advantages in some embodiments. For example, every powered component of interest in the craft could contain Power-Line Communication technology and could therefore have access to this communication bus just by being powered. This universal connectivity with any powered component (even electrical components without access to other networks) can have useful applications. One example embodiment would be the transfer of power-management coordination data between power storage, power generation, and various critical points of usage. Critical warnings and commands could be broadcast to all power-connected components such as instruction to switch to low-power mode when resources are limited.

Each of the nodes 102 can be designed to provide a high degree of internal fault tolerance, as presented in this diagram. Fault sensing (over-voltage, weak signal or noise) can be monitored by algorithms or circuits to initiate a break in connection by way of the isolation devices. Another level of protection is provided by the fact that each connection point from any one of the nodes 102 to another adjacent one of the nodes 102 is redundant and should contain identical signals and voltages. These signals can used in an N-modular redundancy circuit or algorithms to pass on only signals that agree. A faulty circuit can be broken so it does not continue to influence the N-modular test. Like the data connections, power connections between adjacent nodes can also be monitored with fault sensors and disconnected, if necessary, with isolation devices. For certain types of faults, an analog majority device could also be used to only accept power from bus links that agree.

Like the data connections, the power bus between adjacent nodes 102 may also be monitored with fault sensors and disconnected, if necessary, with isolation devices. For certain types of faults, an analog majority device could also be used to only accept power from bus links that agree. One level of fault tolerance can involve isolating a faulty signal. On each input, fault sensor readings indicating failures (over-voltage, weak signal or noise) can initiate a break in that connection by triggering its isolation device. The trigger can be initiated by an electronic device, by the decision of an algorithm running in the CPU, or by ground control. Additionally, the redundancy can mitigate other fault types, such as stripping randomly flipped bits in a data stream by use of the majority logic gates.

Referring now generally to the Figures, and particularly to FIG. 4B, FIG. 4B presents further detail regarding a first majority logic gate 402, the plurality of fault sensors 404, and the plurality of isolation devices 406 associated with the device bus adjacent links 410 and the device bus interface 400G. A map 422 is provided in the upper right corner of the drawing, indicating what subsection of the diagram of FIG. 4A is presented here in further detail. A first device bus adjacent node link 410A is bi-directionally communicatively coupled with a first isolation device 406A, which is bi-directionally communicatively coupled with a first fault sensor 404A, which is bi-directionally communicatively coupled with the first majority logic gate 402A. A second device bus adjacent node link 410B is bi-directionally communicatively coupled with a second isolation device 406B, which is bi-directionally communicatively coupled with a first fault sensor 404B, which is bi-directionally communicatively coupled with the first majority logic gate 402A. A third device bus adjacent node link 410C is bi-directionally communicatively coupled with a third isolation device 406C, which is bi-directionally communicatively coupled with a third fault sensor 404C, which is bi-directionally communicatively coupled with the first majority logic gate 402A. A fourth device bus adjacent node link 410D is bi-directionally communicatively coupled with a fourth isolation device 406D, which is bi-directionally communicatively coupled with a fourth fault sensor 404D, which is bi-directionally communicatively coupled with the first majority logic gate 402A. Individual wiring of these channels of communication allows for any one of the isolation devices 406A-D as presented to be selectively toggled to connect or disconnect, per the example problem-solving strategies explicated in the text regarding FIG. 3C; for each of these channels to be individually monitored for faults by the fault sensors 404A-D; and for the four channel signals to be compared with each other by the first majority logic gate 402A, such that if the signal data from one channel differs widely from the signal data coming in from the other three channels, the outlier can be double-checked or disregarded, per the example problem-solving strategies of FIG. 3C.

Referring now generally to the Figures, and particularly to FIG. 4C, FIG. 4C presents further detail regarding a second majority logic gate 402, the plurality of fault sensors 404, and the plurality of isolation devices 406 associated with the network interface 400E and the network adjacent node links 408. The map 422 is again provided in the upper right corner of the drawing, indicating what subsection of the diagram of FIG. 4A is presented here in further detail. A first network adjacent node link 408A is bi-directionally communicatively coupled with a fifth isolation device 406E, which is bi-directionally communicatively coupled with a fifth fault sensor 404E, which is bi-directionally communicatively coupled with the second majority logic gate 402B. A second network adjacent node link 408B is bi-directionally communicatively coupled with a sixth isolation device 406F, which is bi-directionally communicatively coupled with a sixth fault sensor 404F, which is bi-directionally communicatively coupled with the second majority logic gate 402B. A third network adjacent node link 408C is bi-directionally communicatively coupled with a seventh isolation device 406G, which is bi-directionally communicatively coupled with a seventh fault sensor 404G, which is bi-directionally communicatively coupled with the second majority logic gate 402B. A fourth network adjacent node link 408D is bi-directionally communicatively coupled with an eighth isolation device 406H, which is bi-directionally communicatively coupled with an eighth fault sensor 404H, which is bi-directionally communicatively coupled with the second majority logic gate 402B. Individual wiring of these channels of communication allows for any one of the isolation devices 406E-H as presented to be selectively toggled to connect or disconnect, per the example problem-solving strategies explicated in the text regarding FIG. 3C; for each of these channels to be individually monitored for faults by the fault sensors 404E-H; and for the four channel signals to be compared with each other by the second majority logic gate 402B, such that if the signal data from one channel differs widely from the signal data coming in from the other three channels, the outlier can be double-checked or disregarded, per the example problem-solving strategies of FIG. 3C.

Referring now generally to the Figures, and particularly to FIG. 4D, FIG. 4D presents further detail regarding the plurality of fault sensors 404 and the plurality of isolation devices 406 associated with the high-speed serial interface 400H and the adjacent module serial links 412. The map 422 is again provided in the upper right corner of the drawing, indicating what subsection of the diagram of FIG. 4A is presented here in further detail. A first adjacent module serial link 412A is bi-directionally communicatively coupled with a ninth isolation device 406I and a thirteenth isolation device 406M, which are respectively bi-directionally communicatively coupled with a ninth fault sensor 404I and a thirteenth fault sensor 404M. A second adjacent module serial link 412B is bi-directionally communicatively coupled with a tenth isolation device 406J and a fourteenth isolation device 406N, which are respectively bi-directionally communicatively coupled with a tenth fault sensor 404J and a fourteenth fault sensor 404N. A third adjacent module serial link 412C is bi-directionally communicatively coupled with an eleventh isolation device 406K and a fifteenth isolation device 406O, which are respectively bi-directionally communicatively coupled with an eleventh fault sensor 404K and a fifteenth fault sensor 404O. A fourth adjacent module serial link 412D is bi-directionally communicatively coupled with a twelfth isolation device 406L and a sixteenth isolation device 406P, which are respectively bi-directionally communicatively coupled with a twelfth fault sensor 404L and a sixteenth fault sensor 404P. Individual wiring of these channels of communication allows for any one of the isolation devices 406I-P as presented to be selectively toggled to connect or disconnect, per the example problem-solving strategies explicated in the text regarding FIG. 3C; for each of these channels to be individually monitored for faults by the fault sensors 404I-P per the example problem-solving strategies of FIG. 3C. It is noted that, since these channels are coming from different function modules such as but not limited to the function module examples of FIGS. 11A through 11D, no checksum comparison is made for consistency between, for instance, the data channel from a telescope module and the data channel from a solar panel module.

Referring now generally to the Figures, and particularly to FIG. 4E, FIG. 4E presents further detail regarding the plurality of fault sensors 404, the plurality of isolation devices 406, the first power majority logic gate 416A, and the second power majority logic gate 416B associated with the power bus 414, the plurality of adjacent module links 418, and the plurality of adjacent node links 420. The map 422 is again provided in the upper right corner of the drawing, indicating what subsection of the diagram of FIG. 4A is presented here in further detail. A first node power link 420A is bi-directionally electronically coupled with a seventeenth isolation device 406Q, which is bi-directionally electronically coupled with a seventeenth fault sensor 404Q, which is further bi-directionally electronically coupled with the first power majority logic gate 416A. A second node power link 420B is bi-directionally electronically coupled with an eighteenth isolation device 406R, which is bi-directionally electronically coupled with an eighteenth fault sensor 404R, which is further bi-directionally electronically coupled with the first power majority logic gate 416A. A third node power link 420C is bi-directionally electronically coupled with a nineteenth isolation device 406S, which is bi-directionally electronically coupled with a nineteenth fault sensor 404S, which is further bi-directionally electronically coupled with the first power majority logic gate 416A. A fourth node power link 420D is bi-directionally electronically coupled with a twentieth isolation device 406T, which is bi-directionally electronically coupled with a twentieth fault sensor 404T, which is further bi-directionally electronically coupled with the first power majority logic gate 416A. A first module power link 418A is bi-directionally electronically coupled with a twenty-first isolation device 406U, which is bi-directionally electronically coupled with a twenty-first fault sensor 404U, which is further bi-directionally electronically coupled with the second power majority logic gate 416B. A second module power link 418B is bi-directionally electronically coupled with a twenty-second isolation device 406V, which is bi-directionally electronically coupled with a twenty-second fault sensor 404V, which is further bi-directionally electronically coupled with the second power majority logic gate 416B. A third module power link 418C is bi-directionally electronically coupled with a twenty-third isolation device 406W, which is bi-directionally electronically coupled with a twenty-third fault sensor 404W, which is further bi-directionally electronically coupled with the second power majority logic gate 416B. A fourth module power link 418D is bi-directionally electronically coupled with a twenty-fourth isolation device 406X, which is bi-directionally electronically coupled with a twenty-fourth fault sensor 404X, which is further bi-directionally electronically coupled with the second power majority logic gate 416B. Individual wiring of these channels of communication may allow for any one of the isolation devices 406Q-X as presented to be selectively toggled to connect or disconnect, per the example problem-solving strategies explicated in the text regarding FIG. 3C; for each of these channels to be individually monitored for faults by the fault sensors 404Q-X; and for the four channel signals to be compared with each other by the first power majority logic gate 416A and the second power majority logic gate 416B (respectively for each side as shown), such that if the signal data from one channel differs widely from the signal data coming in from the other three channels, the outlier might be double-checked or isolated, per the example problem-solving strategies of FIG. 3C. It is noted that detecting if a power connection is behaving anomalously (such as transmitting power surges or drawing more power than expected) and being able to selectively isolate a power channel (such as one leading to a malfunctioning module or a damaged part of the spacecraft) can be very useful in practicing the problem-solving strategies outlined in the text regarding FIG. 3C. Further, the power bus 414 may be filtered utilizing the first power majority logic gate 416A and the second power majority logic gate 416B in the case that data is transmitted within the power bus 414 using any data-over-power method known in the art.

Referring now generally to the Figures, and particularly to FIG. 5, FIG. 5 is a 3D model of one of the struts 104 of FIG. 1, such as the first strut 104A, presented individually. Each of the struts 104 may include a rigid structural tube 500 enclosing a power and signal pathway 502. The strut assembly is presented in FIG. 5 using ribbon electrical conductors bonded to the rigid structural tube 500 internal diameter, but any type of power or signal pathway, including coaxial cable, twisted pairs, optical fibers, etc., attached or unattached, might be utilized. Further, power and data could be sent between nodes in the form of microwave energy and signals. This can be done by using the center bore of the strut tube as a waveguide and providing opposing microwave transceivers, mounted within each node at its tube interfaces. Signals and power can also be transmitted down the tube using aligned “laser transceivers” and “photovoltaic laser power converters” in the same way. The tube can also be manufactured with more than one bore, making it possible to contain different data and power transfer technology that otherwise may not be compatible within the same containment.

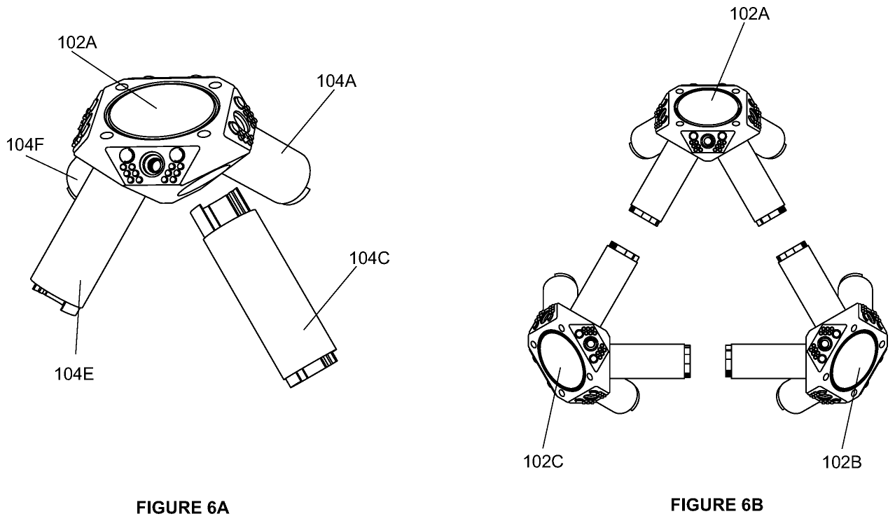

Referring now generally to the Figures, and particularly to FIG. 6A, FIG. 6A is a 3D model presenting a close-up view of one of the struts 104 being coupled with one of the nodes 102 of the octaframe chassis assembly 100. Specifically, for the purpose of a non-limiting example consistent with the octaframe chassis assembly 100 as presented in FIG. 1, the first node 102A is presented here, coupled with the first strut 104A, the fifth strut 104E, and the sixth strut 104F, and being coupled to the third strut 104C. Electrical connection of the power and signal pathways 502 of the struts 104 with the node 104 and all electrical connectors can be done by any means known in the art such as but not limited to soldering, crimping, bonding, clamping, connector attachment, etc.

Referring now generally to the Figures, and particularly to FIG. 6B, FIG. 6B is a 3D model presenting three corners—each corner comprising one of the nodes 102 coupled with a plurality of the struts 104—of one of the plurality of poly-mount interfaces 106 of the octaframe chassis assembly 100, and demonstrating how these line up. A mechanical attachment plate incorporating power and data connectors, such as the mount connectors 202, is positioned at each of these corners. Specifically, for the purpose of a non-limiting example consistent with the octaframe chassis assembly 100 as presented in FIG. 1, the three corners of the first poly-mount interface 106A of FIG. 1—the first node 102A, the second node 102B, and the third node 102C—are presented.

Referring now generally to the Figures, and particularly to FIG. 7, FIG. 7 is a line drawing of the octaframe chassis assembly 100 further coupled with an interface frame component called a delta ring 700; since two instances of the delta ring 700 are presented in this drawing in order to show both sides of the delta ring 700, these two instances are further labeled as a first delta ring 700A and a second delta ring 700B. The delta ring 700 is a component providing a standard-sized interface to facilitate compatibly coupling modules together. In preferred embodiment, chassis assemblies such as but not limited to the octaframe chassis assembly 100 might couple together directly with each other at the poly-mount interfaces 106, without utilizing the delta ring 700, but other modules such as the example function modules of FIGS. 11A through 11D can guarantee compatibility with this standard of modular spacecraft—for instance, the ability to compatibly couple onto or into the octaframe chassis assembly 100—by incorporating the delta ring 700 into the design of the other module being connected, as the delta ring 700 is compatible for coupling with one of the poly-mount interfaces 106. It is further noted that two instances of the delta ring 700 would not necessarily couple together with each other. The delta ring 700 may preferably include a plurality of node connectors 702, specifically a first node connector 702A, a second node connector 702B, and a third node connector 702C, which interface with the nodes 102 as shown here, and connect the delta ring 700 and anything further attached to the delta ring 700 to the network 300 of the octaframe chassis assembly 100. The delta ring 700 may additionally include one or more mechanical mounting features 704, such as apertures for bolting fixtures. The delta ring 700 may further include one or more node-side module connectors 706 and/or non-node-side module connectors 708 which provide access to the power and data network infrastructure of the octaframe chassis assembly 100 for a connected device.

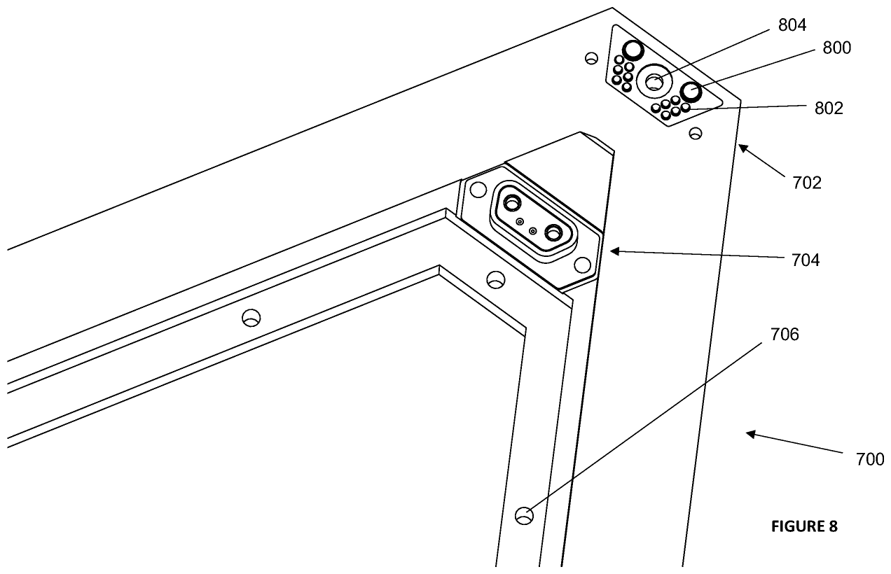

Referring now generally to the Figures, and particularly to FIG. 8, FIG. 8 is a closer view of one corner of the delta ring 700, wherein the node connection points 702, the module connection points 704, and the mechanical mounting features 706 of that corner are presented in higher detail. Correspondingly to one of the mount connectors 202 of the node 102 of FIG. 2, the node connection points 702 may further include one or more delta ring power connectors 800, one or more delta ring data connectors 802, and/or one or more delta ring mechanical fastening features 804. The module connection points 704 may further include ports or connectors for a module device associated with the delta ring 700 to connect to the power and data network infrastructure of the octaframe chassis assembly 100.

Referring now generally to the Figures, and particularly to FIG. 9A, FIG. 9A is a first alternative chassis shape, specifically a tetraframe chassis assembly 900. The tetraframe chassis assembly 900 includes a plurality of three-strut nodes 902, for coupling at the intersection of three struts 104 instead of the four strut corners of the octaframe chassis assembly 100. The plurality of three-strut nodes 902 are each axisymmetric at 120 degrees, so function modules such as those of FIGS. 11A through 11D might be mounted in any of three positions in azimuth at each mount location, adding flexibility in spacecraft configurations. As the sides of the tetraframe chassis assembly 900 are triangles, the tetraframe chassis assembly 900 would be geometrically compatible for coupling onto one of the poly-mount interfaces 106 of the octaframe chassis assembly 100 if similarly scaled.

Referring now generally to the Figures, and particularly to FIG. 9B, FIG. 9B is a second alternative chassis shape, specifically an icosaframe chassis assembly 904. The icosaframe chassis assembly 904 includes a plurality of five-strut nodes 906, for coupling at intersections of five struts 104 each instead of the four strut corners of the octaframe chassis assembly 100. As the sides of the icosaframe chassis assembly 904 are triangles, the icosaframe chassis assembly 904 would be geometrically compatible for coupling onto one of the poly-mount interfaces 106 of the octaframe chassis assembly 100 if similarly scaled.

Referring now generally to the Figures, and particularly to FIG. 9C, FIG. 9C is a third alternative chassis shape, specifically a cube chassis assembly 908. The cube chassis assembly 908 includes a plurality of cube nodes 910, for coupling together struts 104 at the corners of the shape. The cube chassis assembly 908 forms a plurality of square-shaped poly-mount interfaces, as shown by the dotted line of FIG. 9C. Unlike the octaframe chassis assembly 100, the tetraframe chassis assembly 900, and the icosaframe chassis assembly 904, which are all geometrically compatible to fit together with each other, the cube chassis assembly 908 may be considered a representative of a different “series” of polyhedral chassis shape built around the interlocking geometry of squares and cubes instead of triangles and tetrahedrons.

It is noted that other series of polyhedral chassis shape, including those having face shapes other than triangles or squares, are also potentially viable, such as a polyhedron having pentagonal sides, hexagonal sides, rhombic sides, and so on, and further, that a chassis shaped like a polyhedron showing faces of differing shapes, such as but not limited to a rhombicuboctahedron, which includes both square-shaped and triangle-shaped faces, could function as an adapter piece between modules of differing face geometry. It is understood that none of the above discussion of potential geometric variation should be construed as limiting, and should be recognized that starting from this basic concept, one skilled in the art of three-dimensional geometry could come up with an enormous number of potentially useful variations and combinations, of which these are just an exemplary few.

Referring now generally to the Figures, and particularly to FIG. 10A, FIG. 10A is a first combination chassis arrangement 1000 comprised of three instances of the octaframe chassis assembly 100 arranged together, specifically a first octaframe 100A, a second octaframe 100B, and a third octaframe 100C. It is noted how the geometric shape octaframe chassis assembly 100 lends itself to various combinations such as this one, the other exemplary combinations presented in FIGS. 10B through 10D, and many more. It is noted that the first combination chassis arrangement 1000 might be coupled together in this shape, and that adjacent ones of the nodes 102 of each octaframe chassis assembly 100 might be communicatively coupled to share a same power and data network throughout a combined assembly. Spacecraft requiring more complexity can employ more chassis modules, each providing additional interfaces for additional function modules, such as the example function modules of FIGS. 11A through 11D, to couple onto. Once a structural configuration is selected, function modules can be added to provide the spacecraft's required functionality. In preferred embodiments, the function modules also each include a delta ring 700, such that the delta ring 700 of a function module can interface with one of the poly-mount interfaces 106 of a chassis assembly such as but not limited to the octaframe chassis assembly 100 of FIG. 1. The delta ring 700 is preferably a compatible shape for coupling onto one of the poly-mount interfaces 106—such as but not limited to being triangular for attachment and interconnection with the poly-mount interfaces 106 of the octaframe chassis 100. In addition, power and communication interconnection is provided for the function module's instrumentation or machinery.

Referring now generally to the Figures, and particularly to FIG. 10B, FIG. 10B is a second combination chassis arrangement 1002 presenting a different geometric configuration of multiple previously-presented chassis shapes showing how these modular chassis might fit and couple together. This configuration includes a fourth octaframe 100D and a fifth octaframe 100E which are instances of the octaframe chassis assembly 100, and a first tetraframe 900A and a second tetraframe 900B which are instances of the tetraframe chassis assembly 900. It is noted how the geometric shape of the octaframe chassis assembly 100 and the tetraframe chassis assembly 900 lend themselves to various combinations such as this one, the other exemplary combinations presented in FIGS. 10B through 10D, and many more. It is noted that the second combination chassis arrangement 1002 might be coupled together in this shape, and that adjacent ones of the nodes 102 of each octaframe chassis assembly 100 and tetraframe assembly 900 might be communicatively coupled to share a same power and data network throughout a combined assembly.

Referring now generally to the Figures, and particularly to FIG. 10C, FIG. 10C is a third combination chassis assembly 1004 presenting a different geometric configuration of previously-presented chassis shapes showing how these modular chassis might fit and couple together. This configuration includes a sixth octaframe 100F, a seventh octaframe 100G, an eighth octaframe 100H, and a ninth octaframe 100I, which are instances of the octaframe chassis assembly 100. It is noted how the geometric shape of the octaframe chassis assembly 100 lends itself to various combinations such as this one, the other exemplary combinations presented in FIGS. 10B through 10D, and many more. It is noted that the third combination chassis arrangement 1004 might be coupled together in this shape, and that adjacent ones of the nodes 102 of each octaframe chassis assembly 100 might be communicatively coupled to share a same power and data network throughout a combined assembly.

Referring now generally to the Figures, and particularly to FIG. 10D, FIG. 10D is a fourth combination chassis assembly 1006 presenting a different geometric configuration of previously-presented chassis shapes showing how these modular chassis might fit and couple together. This configuration includes a tenth octaframe 100J, an eleventh octaframe 100K, a twelfth octaframe 100L, a thirteenth octaframe 100M, and a fourteenth octaframe 100N, which are instances of the octaframe chassis assembly 100. It is noted how the geometric shape of the octaframe chassis assembly 100 lends itself to various combinations such as this one, the other exemplary combinations presented in FIGS. 10B through 10D, and many more. It is noted that the fourth combination chassis arrangement 1006 might be coupled together in this shape, and that adjacent ones of the nodes 102 of each octaframe chassis assembly 100 might be communicatively coupled to share a same power and data network throughout a combined assembly.

Referring now generally to the Figures, and particularly to FIG. 11A, FIG. 11A is a first example of a function module, specifically a visible imaging camera & infrared spectrometer function module 1100. For the purpose of this disclosure, function modules are defined as devices that mount to a chassis assembly, such as coupling to the poly-mount interfaces 106 of the octaframe chassis assembly 100 using the delta ring 700, and provide functionality to a comprising spacecraft. Function modules can be scientific instruments, communication systems, cameras, telescopes, propulsion devices, robotic manipulators, solar panels, landing gear, drilling devices, wheel assemblies or any other required functional device, powered or unpowered. Each function module may be autonomously controlled by an onboard CPU control system and preferably communicates with other functional modules through the interconnected data networks of the craft, such as those supported by the octaframe chassis assembly 100 or another chassis assembly. Regardless of their purpose, function, configuration or design, all function modules preferably share a common standard such as the delta ring 700. Some non-limiting examples of function modules are presented in FIGS. 11A through 11D. A notable benefit of adoption of certain preferred embodiments of the invented system may include facilitation of independent development of function modules from multiple vendors, while assuring framework compatibility and functional module interchangeability.

Referring now generally to the Figures, and particularly to FIG. 11B, FIG. 11B is a second example of a function module, specifically a communications function module 1102 for spacecraft communication.

Referring now generally to the Figures, and particularly to FIG. 11C, FIG. 11C is a third example of a function module, specifically a telescope function module 1104.

Referring now generally to the Figures, and particularly to FIG. 11D, FIG. 11D is a fourth example of a function module, specifically a PV array function module 1106.

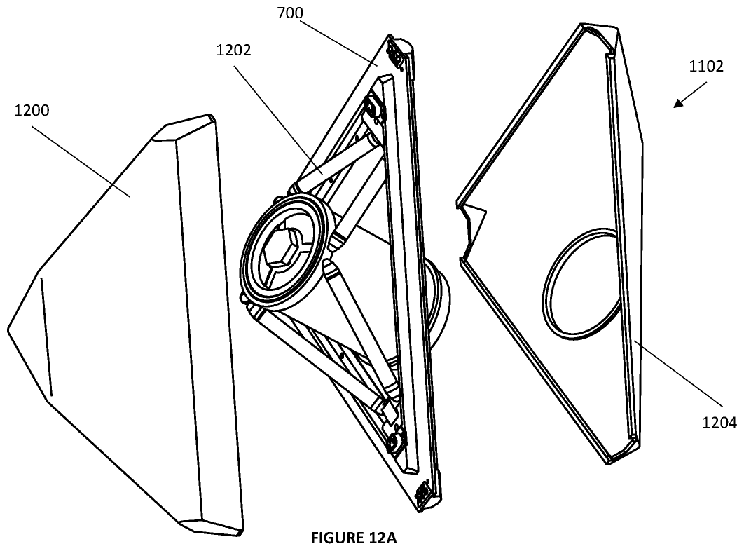

Referring now generally to the Figures, and particularly to FIG. 12A, FIG. 12A presents an exploded view of the telescope function module 1104 of FIG. 11C, showing further detail regarding how a function module can be assembled using a module developer's kit which provides an instance of the delta ring 700. The telescope function module 1104 is presented here with a back casing 1200 presented separately from a delta ring telescope device 1202, presented separately from a front casing 1204. With the back casing 1200 and front casing 1204 set aside, it's easier to see how the delta ring 700 is incorporated into the telescope design, allowing this telescope to be compatibly mounted on the octaframe chassis assembly 100 or another chassis assembly with triangular poly-mount interfaces, utilizing the delta ring 700 on each.

A module developers kit can be provided to aid in producing function modules compatible with embodiments of the invented system and method, such as compatible for coupling onto the octaframe chassis assembly 100 or another chassis assembly and using the provided power and data infrastructure of the chassis assembly. Within this modular framework, a spacecraft is created by joining of one or more function modules such as the function module examples of FIGS. 11A through 11D to one or more instances of the octaframe chassis assembly 100 or other chassis assemblies, by way of their delta ring 700 interfaces, selecting each configuration to meet the needs of a specific mission. Each function module may operate autonomously under its own local programming while coordinating with other function modules through network commands.

Referring now generally to the Figures, and particularly to FIG. 12B, FIG. 12B presents further detail pertaining to developer kit functionality of the delta ring 700, specifically an exploded view of a series of standard circuit board panels fitting together with the delta ring 700, specifically a circuit board 1206, an optical board 1208, and a non-circuit panel 1210.

Referring now generally to the Figures, and particularly to FIG. 12C, FIG. 12C presents a view of the communications function module 1102 with the back casing 1200 detached, showing how the delta ring 700 may be incorporated into a design like this, including use of one or more of the standard circuit board panels of FIG. 12B.

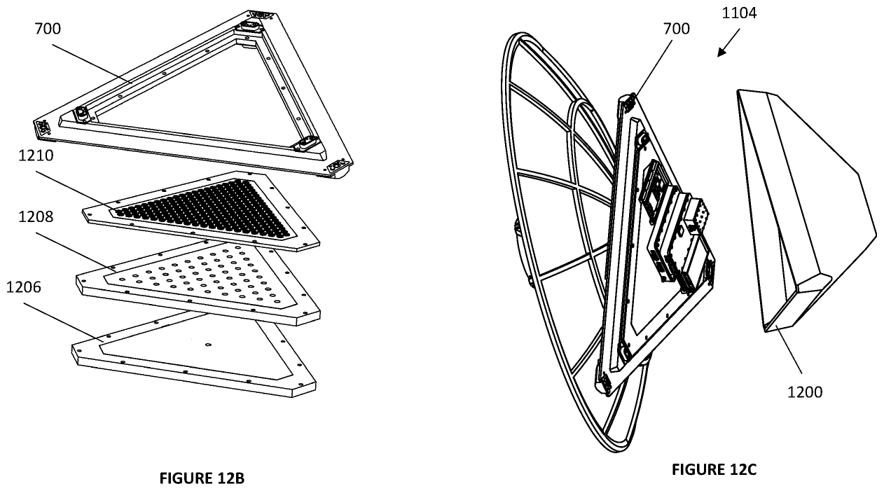

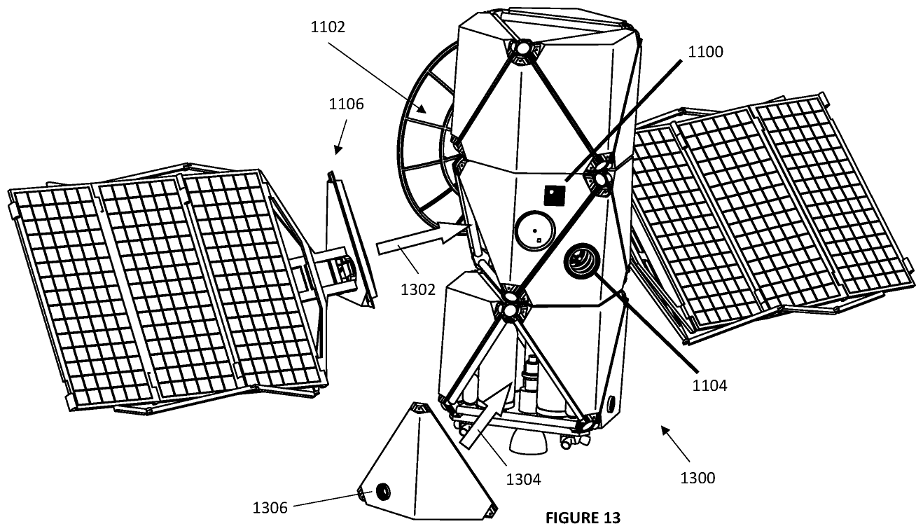

Referring now generally to the Figures, and particularly to FIG. 13, FIG. 13 presents a 3D model of an exemplary modular spacecraft 1300 incorporating elements discussed in previous Figures, such as a composite chassis assembly as presented in FIGS. 10A through 10D and inclusion of each of the function modules of FIGS. 11A through 11D: the visible imaging camera & infrared spectrometer function module 1100, the communications function module 1102, the telescope function module 1104, and the PV array function module 1106. In the drawing, a first arrow 1302 shows where the PV array function module 1106, partially detached from the craft to show the connection, would be recoupled; and a second arrow 1304 indicates that a section of the spacecraft 1306 has been drawn in a detached position to show a portion of the internal structure of the craft and to demonstrate how a spacecraft may assembled simply by joining function modules to the composite chassis.

Referring now generally to the Figures, and particularly to FIG. 14A, FIG. 14A is a first line diagram explicating further detail regarding the corner geometry of the poly-mount interface of FIG. 1. It is noted that the poly-mount interface 106 of the chassis assemblies such as but not limited to the octaframe chassis assembly 100 as described herein are only some possible implementations of this corner geometry, and that other applications implementing this corner geometry may also be embodiments. In a first mount connector diagram 1400, only the mechanical fastening features are shown, such as a mechanical fastening feature 1402. It is noted that, since these line drawings only show select features of the mount connector 202, the diagram is numbered and presented as the first mount connector diagram 1400, even though many of the design principles and considerations explicated herein pertain to preferred implementation and shape of the mount connector 202 as presented at least in FIG. 2 as a component of one of the nodes 102. This diagram further presents a frame opening corner angle 1404, and an angle centerline 1406 which divides the space of the frame opening corner angle 1404 into a frame opening corner angle left side 1408 and a frame opening corner angle right side 1410.

Referring now generally to the Figures, and particularly to FIG. 14B, FIG. 14B is a second line diagram further explicating the geometric principles of FIG. 14A and depicting a three-strut node embodiment such as but not limited to the tetraframe chassis assembly 900. In this example, further instances of the mount connector diagram 1400 are shown placed in context, with each frame opening corner angle 1404 measuring 120 degrees.

Referring now generally to the Figures, and particularly to FIG. 14C, FIG. 14C is a third line diagram further explicating the geometric principles of FIG. 14A and depicting an embodiment forming a square-shaped frame module. It is noted that this diagrammed example repeats the elements of the diagram of FIG. 14A, and all that changes is the measure of the angle; where the frame opening corner angles 1404 of the example of FIG. 14B were 120 degrees each, the frame opening corner angles 1404 in the present FIG. 14C measure 90 degrees each.

Referring now generally to the Figures, and particularly to FIG. 14D, FIG. 14D is a fourth line diagram further explicating the geometric principles of FIG. 14A and depicting an embodiment forming a pentagon-shaped frame module. It is noted that this diagrammed example repeats the elements of the diagram of FIG. 14A, and all that changes is the measure of the angle; where the frame opening corner angles 1404 of the example of FIG. 14B were 120 degrees each, the frame opening corner angles 1404 in the present FIG. 14D measure 72 degrees each.

Referring now generally to the Figures, and particularly to FIG. 14E, FIG. 14E is a fifth line diagram further explicating the geometric principles of FIG. 14A and depicting an embodiment forming a hexagon-shaped frame module. It is noted that this diagrammed example repeats the elements of the diagram of FIG. 14A, and all that changes is the measure of the angle; where the frame opening corner angles 1404 of the example of FIG. 14B were 120 degrees each, the frame opening corner angles 1404 in the present FIG. 14D measure 60 degrees each.

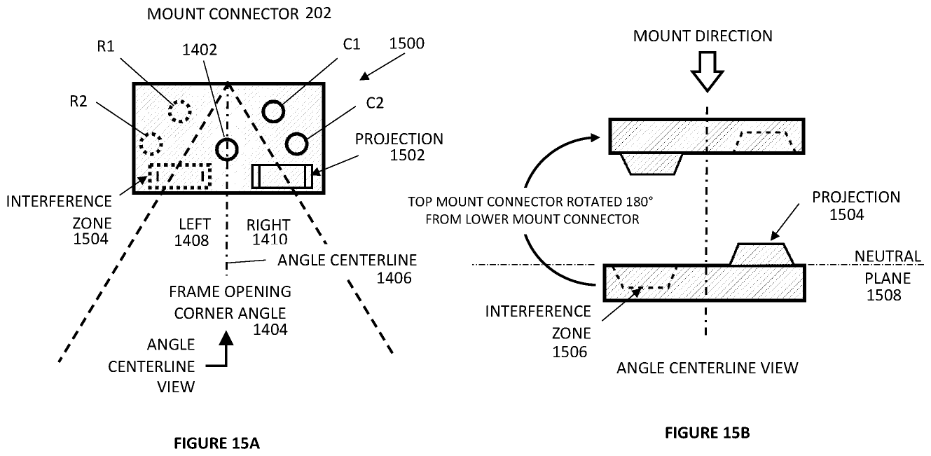

Referring now generally to the Figures, and particularly to FIG. 15A, FIG. 15A is a line diagram further explicating the mount connector 202 design considerations of FIGS. 14A through 14E. A second mount connector diagram 1500 includes the markings from FIG. 14A showing the mechanical fastening feature 1402, the frame opening corner angle 1404, the angle centerline 1406, the frame opening corner angle left side 1408, and the frame opening corner angle right side 1410. The diagram of FIG. 15A further presents four contact positions: a first contact position C1, a second contact position C2, a third contact position R1, and a fourth contact position R2. If a second identical connector having this configuration of contact positions were flipped over to join the mount connector 202 shown here face to face (as presented in FIG. 15B), then the first contact position C1 and the second contact position C2, positioned on the right side of the connector, would end up facing the third contact position R1 and the fourth contact position R2 of the diagram. This implementation would be nonideal for two main reasons. First, contact elements would have to be provided on the left side of the connector at the locations of the third contact position R1 and the fourth contact position R2, so that contacts placed at the first contact position C1 and the second contact position C2 would line up when the connectors are joined. Secondly, even with mating contact elements, the left and right signals would be crossed. One way to mitigate this issue would be to have an intermediate device between two joined poly-mount interfaces that swap the power and data connections with a mirror-image mating pattern so they will match when joined. However, a preferred and more direct solution is to design an androgynous interconnection apparatus, allowing one poly-mount interface to connect directly with an identical poly-mount interface; with these design concerns now understood and explained, subsequent Figures will present several androgynous design options for the mount connector 202.

Referring now generally to the Figures, and particularly to FIG. 15B, FIG. 15B is a line diagram depicting a side view of how two mount connectors 202 of FIG. 15A might be fitted together, illustrating further that, in the mount connector 202 design of FIG. 15A, the projection 1502 of one connector protrudes above a neutral plane 1508 of the mount connector 202 surface, and would fit into the interference zone 1504 of the other connector which indents below the neutral plane 1508. In this embodiment, the first contact position C1, the second contact position C2, the third contact position R1, and the fourth contact position R2 are on the neutral plane. Any projection above the neutral plane on one side of the angle centerline, has a zone of interference of equal dimension on the surface of the opposite side.

It is understood that, to design the mount connector 202 as androgynous, one might think of the device strategy in terms of each of the mount connector 202 connectors having a symmetry centerline aligned with the angle centerline 1406 of each of the mount connector 202 corner angles. When the two mount connectors 202 are mated, the mechanical fastening feature 1402 on the angle centerline 1406 will match in the same position. Positions that are off the angle centerline 1406 will end up mated to a mirror-image position on the other side of the angle centerline 1406 when mated. Therefore, an androgynous connector design successfully accommodates two factors: matching up the connection points on each side of the angle centerline 1406, and matching up the surface features on either side of the angle centerline 1406.

It is further noted that an androgynous mount connector 202 design can be independent of the type of node 102, particularly including nodes 102 which couple with different numbers of struts at different angles, as presented at least in FIG. 14B through 14E. Identical instances of the mount connector 202 might be used in mount connectors 202 of different polygonal arrangements. It is further understood that an androgynous connector in this context is being mated to a reversed duplicate of itself: the same connector, but positioned to be mirroring, such that any protrusions of a first connector are matched by indentations of an opposite identical connector, and vice versa.

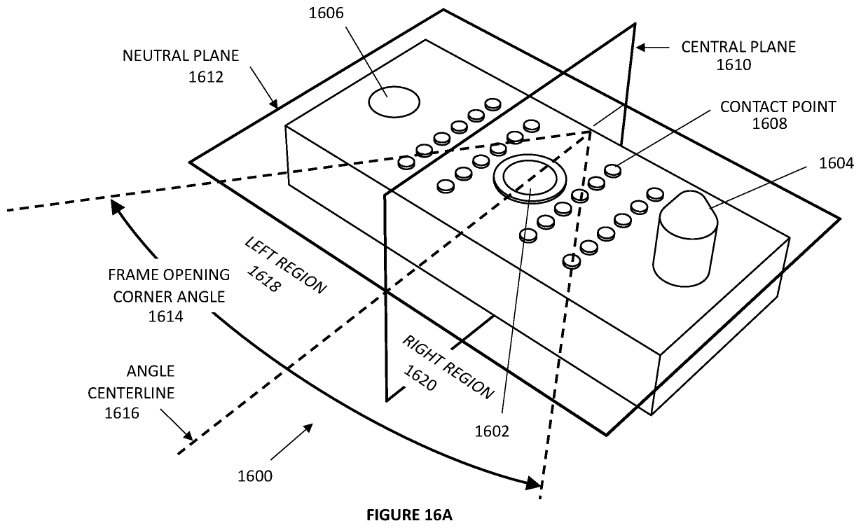

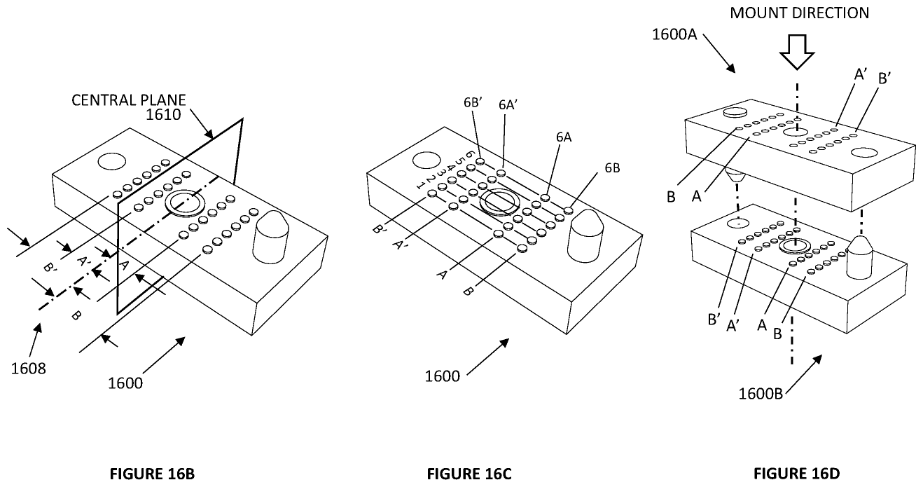

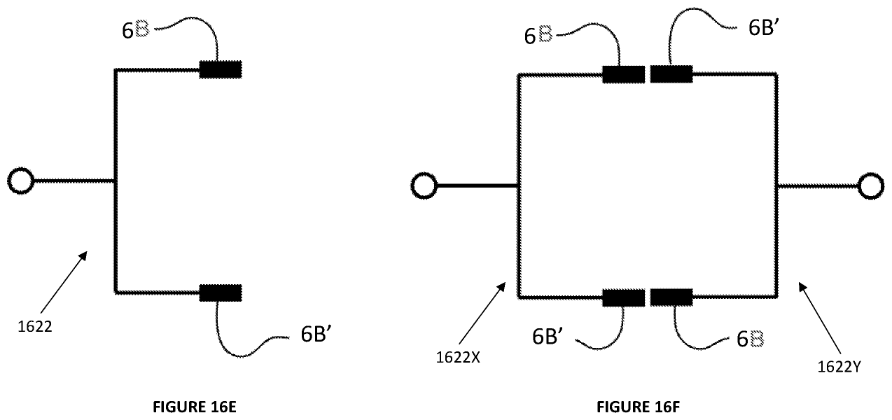

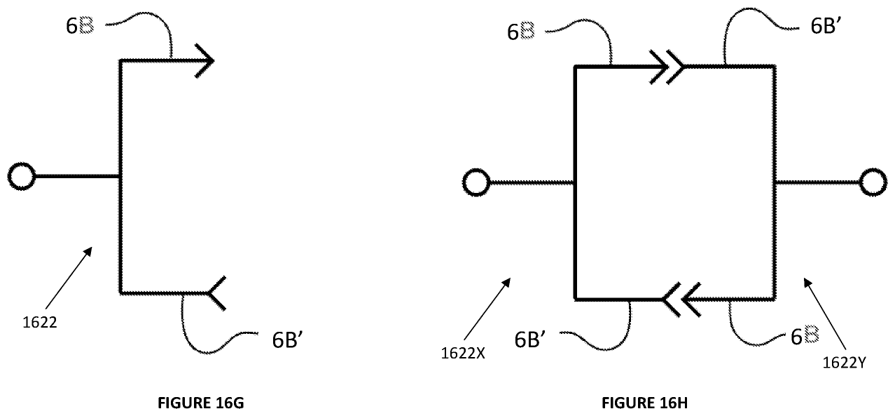

Referring now generally to the Figures, and particularly to FIG. 16A, FIG. 16A is a 3D model presenting a first androgynous mount connector 1600 design as explicated in FIGS. 14A through 15B. The first androgynous mount connector 1600 includes a mechanical fastening feature 1602, an alignment pin 1604, an alignment socket 1606, a plurality of contact points 1608 (further differentiated and explained in FIG. 16B), a central plane 1610, a neutral plane 1612 which is orthogonal to the central plane 1610, a frame opening corner angle 1614, an angle centerline 1616 which is aligned with the central plane 1610, a left region 1618, and a right region 1620. It is noted that the positions of those of the plurality of contact points 1608 which are located in the right region 1620, here presented as two rows of six contacts, are mirrored at the central plane 1610 in the left region 1618. The projection of the alignment pin 1604 is accommodated by the alignment socket 1606 in a mirrored position on the opposite side of the central plane 1610.

Referring now generally to the Figures, and particularly to FIG. 16B, FIG. 16B is a 3D model of the mount connector design of FIG. 16A presenting further information. In this diagram, the plurality of contact points 1608 is subdivided into four rows, as shown: an A row, an A′ row, a B row, and a B′ row. The A row of the plurality of contact points 1608 mirrors the A′ row of the plurality of contact points 1608 across the central plane 1610, and the B row of the plurality of contact points 1608 mirrors the B′ row of the plurality of contact points 1608 across the central plane 1610.

Referring now generally to the Figures, and particularly to FIG. 16C, FIG. 16C is a 3D model of the mount connector design of FIG. 16A presenting further information. In this Figure, the rows of the plurality of contact points 1608 are further subdivided into columns numbered 1 through 6, with the contacts on the end labeled to show a naming convention: a 6 column of the plurality of contact points 1608 contains a contact point 6B′, a contact point 6A′, a contact point 6A, and a contact point 6B. Corresponding ones of the plurality of contact points 1608 having a same column and letter are internally electrically connected together; for example, the contact point 6B is electrically connected to the contact point 6B′, and the contact point 6A′ is electrically connected to the contact point 6A.

Referring now generally to the Figures, and particularly to FIG. 16D, FIG. 16D is a 3D model presenting two instances of the first androgynous mount connector 1600 of FIG. 16A, a top first androgynous mount connector 1600A and a bottom first androgynous mount connector 1600B, being compatibly fitted together. As this Figure presents, the A′ row of the top first androgynous mount connector 1600A interfaces with the A row of the bottom first androgynous mount connector 1600B, the B′ row of the top first androgynous mount connector 1600A interfaces with the B row of the bottom first androgynous mount connector 1600B, the A row of the top first androgynous mount connector 1600A interfaces with the A′ row of the bottom first androgynous mount connector 1600B, and the B row of the top first androgynous mount connector 1600A interfaces with the B′ row of the bottom first androgynous mount connector 1600B. In view of the internal electrical connections explained regarding FIG. 16C, this makes the connections androgynous in the sense of being “non-sided”: connecting to a contact in the A row is the same as connecting to that contact's counterpart in the A′ row. The first androgynous mount connector 1600 employs neutrally-shaped contacts, allowing identical contact pads to join.

Referring now generally to the Figures, and particularly to FIG. 16E, FIG. 16E is a first diagram regarding the internal electrical connections explained regarding FIG. 16C, presenting the contact point 6B and the contact point 6B′ of an androgynous mount connector such as the first androgynous mount connector 1600, connected together by an internal circuit 1622.

Referring now generally to the Figures, and particularly to FIG. 16F, FIG. 16F is a second diagram further regarding the internal electrical connections of the first androgynous mount connector 1600, wherein a first internal circuit 1622X of the top first androgynous mount connector 1600A and a second internal circuit 1622Y of the bottom first androgynous mount connector 1600B are paired together, showing where the contact point 6B of the first internal circuit 1622X lines up with the contact point 6B′ of the second internal circuit 1622Y, and vice versa.

Referring now generally to the Figures, and particularly to FIG. 16G, FIG. 16G is a third diagram further regarding the internal electrical connections of the first androgynous mount connector 1600, further showing direction of current, such as for power or signal connections.

The contact point 6B of this diagram includes an arrowhead indicating a male connection, and the contact point 6B′ includes an inverted arrowhead showing a female connection.

Referring now generally to the Figures, and particularly to FIG. 16H, FIG. 16H is a fourth diagram further regarding the internal electrical connections of the first androgynous mount connector 1600, wherein a first internal circuit 1622X of the top first androgynous mount connector 1600A and a second internal circuit 1622Y of the bottom first androgynous mount connector 1600B are paired together, showing where the contact point 6B of the first internal circuit 1622X lines up with the contact point 6B′ of the second internal circuit 1622Y, and vice versa. This diagram further shows male and female connectors, such as for power or signal connections, by use of the arrowhead and inverted arrowhead convention of FIG. 16G.

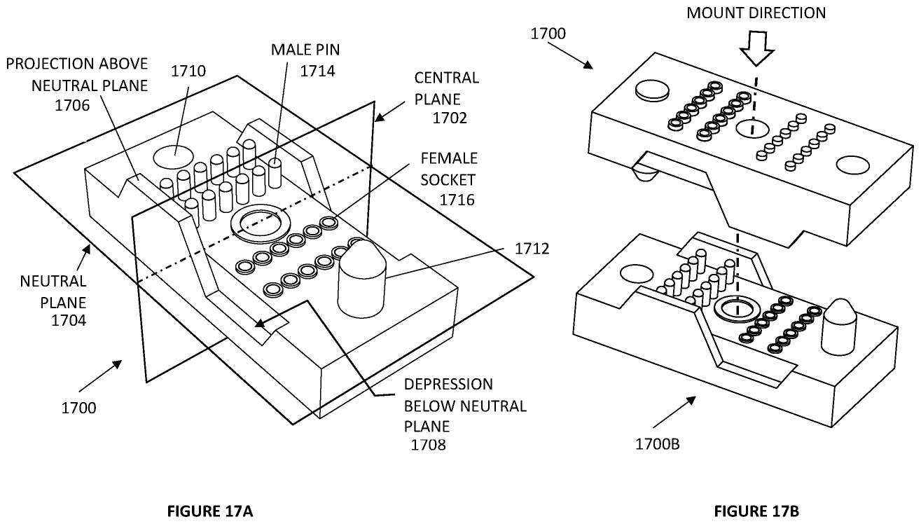

Referring now generally to the Figures, and particularly to FIG. 17A, FIG. 17A is a 3D model presenting a second androgynous mount connector 1700 design. Connector design can be simplified when neutrally-shaped connection points are used, but an androgynous mount connector can also be made with male and female connection points, as presented with this embodiment. The second androgynous mount connector 1700 includes a central plane 1702, a neutral plane 1704, a projection above the neutral plane 1706, a depression below the neutral plane 1708, a second alignment socket 1710, a second alignment pin 1712, a plurality of male pins 1714, and a plurality of female sockets 1716. Each one of the plurality of male pins 1714 has a counterpart one of the plurality of female sockets 1716, in the same mirrored positioning described in FIGS. 16B and 16C. As in FIGS. 16B and 16C, each connection point is internally wired to its counterpart so interconnection does not change the signal.

Referring now generally to the Figures, and particularly to FIG. 17B, FIG. 17B is a 3D model presenting two instances of the second androgynous mount connector 1700, specifically a top second androgynous mount connector 1700A and a bottom second androgynous mount connector 1700B, being compatibly fitted together in the mount direction shown. As in FIG. 16D, the corresponding rows of the plurality of male pins 1714 and the plurality of female sockets 1716 fit together, with the difference that these are pins and sockets instead of neutrally-shaped contacts. It is noted that the projection above the neutral plane 1706 of the top second androgynous mount connector 1700A fits into the depression below the neutral plane 1708 of the bottom second androgynous mount connector 1700B, and vice-versa, and that the alignment pin 1712 of the top second androgynous mount connector 1700A fits into the alignment socket 1710 of the bottom second androgynous mount connector 1700B and vice versa.

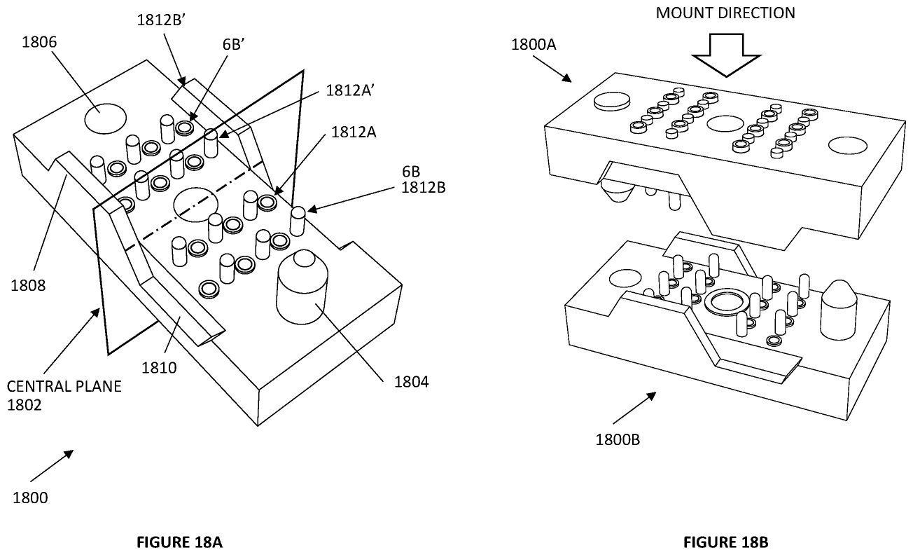

Referring now generally to the Figures, and particularly to FIG. 18A, FIG. 18A is a 3D model presenting a third androgynous mount connector 1800 design. Connector design can be simplified when neutrally-shaped connection points are used, but an androgynous mount connector can also be made with male and female connection points, as further presented with this embodiment. A central plane 1802 is shown here for reference, and other aspects recognizable from earlier embodiments are also included, such as a third alignment pin 1804, a third alignment socket 1806, a projection 1808, and a depression 1810. Further included are an A connector row 1812A, an A′ connector row 1812A′, a B connector row 1812B, and a B′ connector row 1812B′. This embodiment employs a mix of both pins and sockets on both sides of the central plane, with the same wiring configuration as described in FIGS. 16B and 16C.

For example, a counterpart pin 6B as labeled is electrically connected to a counterpart socket 6B′ as labeled.

Referring now generally to the Figures, and particularly to FIG. 18B, FIG. 18B is a 3D model presenting two instances of the third androgynous mount connector 1800, specifically a top third androgynous mount connector 1800A and a bottom third androgynous mount connector 1800B being compatibly fitted together in the mount direction shown. As in FIG. 17B, the corresponding rows of connectors fit together, with the primary difference that the pins and sockets are intermixed rather than grouped on either side of the central plane. It is noted that the projection 1808 of the top third androgynous mount connector 1800A also fits into the depression 1810 of the bottom third androgynous mount connector 1800B, and vice-versa, and that the alignment pin 1804 of the top third androgynous mount connector 1800A fits into the alignment socket 1806 of the bottom third androgynous mount connector 1800B and vice versa.

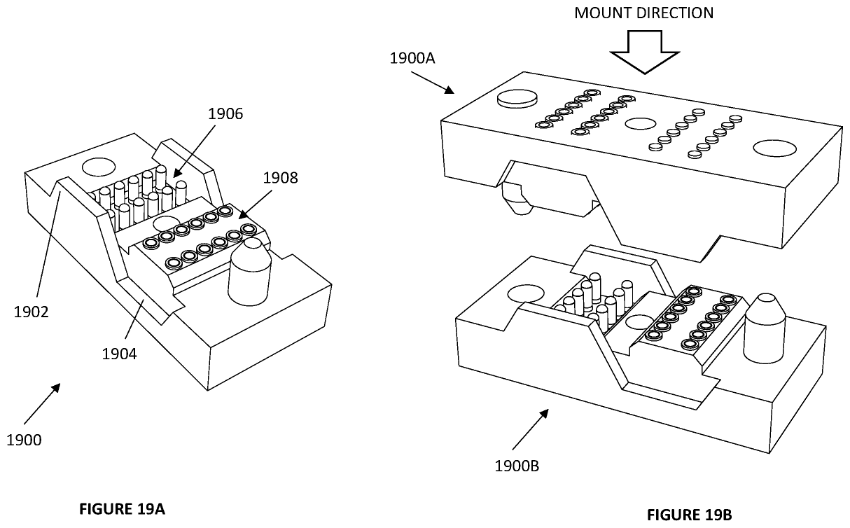

Referring now generally to the Figures, and particularly to FIG. 19A, FIG. 19A is a 3D model presenting a fourth androgynous mount connector 1900 design. Connector design can be simplified when neutrally-shaped connection points are used, but an androgynous mount connector can also be made with male and female connection points, as further presented with this embodiment. Aspects recognizable from earlier embodiments are also included, such as a fourth projection 1902 and a fourth depression 1904; to present further possible variation, the alignment pin and alignment socket features are optionally omitted from this particular embodiment as shown. In this embodiment, the connector points are provided in the shape of a relief pocket with pins 1906 which corresponds to a projection with sockets 1908. In this embodiment, sockets are mounted on a projection above the neutral plane and the counterpart pins are mounted at the bottom of a relief pocket, an equal distance below the neutral plane. This embodiment continues to employ the same wiring configuration as described in FIGS. 16B and 16C, with counterpart connection points electrically coupled together. It is notable that, while the neutral plane is not marked in this Figure, the embodiment of FIGS. 19A and 19B is a version of the androgynous mount connector design series of FIGS. 15A through 20B wherein the connector points are protruded above and correspondingly depressed below the neutral plane, showing that connector points need not always be on the same level as the neutral plane, as long as any projections in shape are reflected with corresponding depressions.

Referring now generally to the Figures, and particularly to FIG. 19B, FIG. 19B is a 3D model presenting two instances of the fourth androgynous mount connector 1900, specifically a top fourth androgynous mount connector 1900A and a bottom fourth androgynous mount connector 1900B being compatibly fitted together in the mount direction shown. As in the embodiments of FIGS. 16A through 18B, the corresponding rows of connectors fit together as shown, illustrating another mode of overall androgynous mount connector design which might incorporate male and female components. It is noted that the fourth projection 1908 of the top fourth androgynous mount connector 1900A also fits into the fourth depression 1910 of the bottom fourth androgynous mount connector 1900B, and vice-versa, and that the fourth alignment pin 1904 of the top fourth androgynous mount connector 1900A fits into the fourth alignment socket 1906 of the bottom fourth androgynous mount connector 1900B and vice versa.

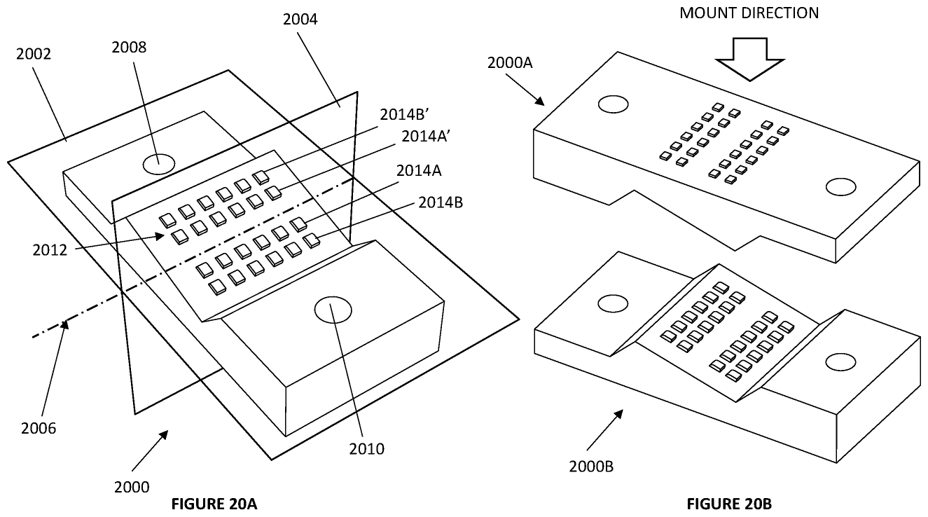

Referring now generally to the Figures, and particularly to FIG. 20A, FIG. 20A is a 3D model presenting a fifth androgynous mount connector 2000 design. Presented here are a neutral plane 2002, a central plane 2004, an angle centerline 2006, a first mechanical fastening aperture 2008, a second mechanical fastening aperture 2010, and a sloped contact 2012 further comprising an A connector row 2014A, an A′ connector row 2014A′, a B connector row 2014B, and a B′ connector row 2014B′, which continue to employ the same wiring configuration as described in FIGS. 16B and 16C, with counterpart connection points electrically coupled together. The contact points are mounted on a plane that slopes at an angle to the neutral plane, intersecting the neutral plane at the angle centerline. If mating pairs of contact points are equally distant in opposite directions from the central plane, the mating pairs of contact points will also be equal distances in opposite directions from the neutral plane, making the mating pairs of contact points match in height when two identical connector mounts are joined. As before, in cases where connection points are off the centerline, the mating connection points on the left and the right are bussed together so that although connection points swap when joined, the power or signal interconnections are unchanged. It is further noted that, in this embodiment, the first mechanical fastening aperture 2008 and the second mechanical fastening aperture 2010 replace the centrally-located mechanical fastening feature 208 of other embodiments such as that of FIG. 16A, with a pair of mechanical fastening features to either side.

Referring now generally to the Figures, and particularly to FIG. 20B, FIG. 20B is a 3D model presenting two instances of the fifth androgynous mount connector 2000, specifically a top fifth androgynous mount connector 2000A and a bottom fifth androgynous mount connector 2000B being compatibly fitted together in the mount direction shown. As in the embodiments of FIGS. 16A through 19B, the corresponding rows of connectors fit together as shown, illustrating another mode of overall androgynous mount connector design.

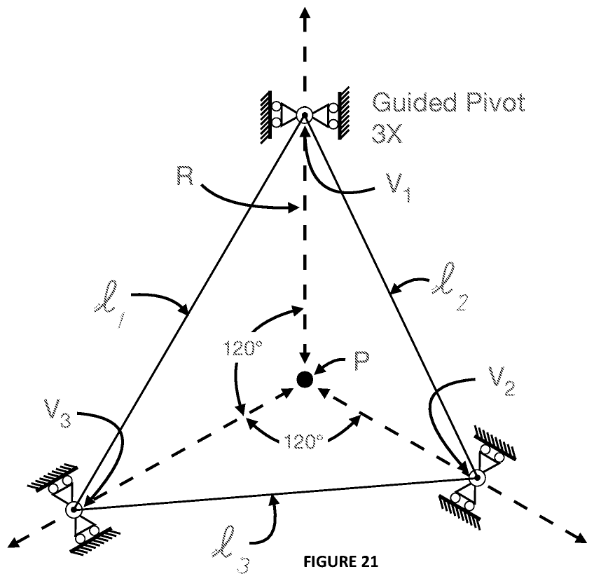

Referring now generally to the Figures, and particularly to FIG. 21, FIG. 21 is a diagram presenting geometry relevant to another important aspect of the modular system, which regards a means of rigidly attaching modules in a way that prevents their positions from shifting during launch stress. Most manufactured components require a means of dealing with dimensional variation in mating parts and assemblies. This is usually done by allowing sufficient clearance between mating hardware to prevent binding. For example, for a particular screw size, a mating hole might be oversized to allow for variations in manufactured hole positions, thus preventing the screw from binding against the side of the hole. Within the oversized mating hole, the element is constrained from moving only by friction produced by the tightness of the screw. Unfortunately, spacecraft undergo high vibrations and acceleration which can cause parts constrained only by friction to “walk” slightly to another position within the oversized holes, possibly disturbing critical proximities between attached elements. To better constrain the modules at the attachment points, an apparatus is used which is compliant to center-to-center variations in mounting point positions, but rigidly constrains movement of an attached module, as explained in the diagram of FIG. 21. Represented here is an apparatus with three fixed guides, restricting the motion of pivot points V1, V2, and V3 along the three radial paths R, originating at point P and radiating outward in a plane 120° from each other. The distances between the pivots, l1, l2, and l3, represent the center-to-center distances between the attachment points of the modular frame nodes and the function modules. The freedom of motion along the radial paths, R, allows compliance with any combination of lengths l1, l2, and l3. Although the guided pivots can freely move when the pivot distances change, when l1, l2, and l3 lengths are fixed, the pivot points become locked in position. It is noted that the three pivot points V1, V2, and V3 are guided only along the rays, R, which are the angle centerlines 1406 of each of the corners represented by the three pivot points V1, V2, and V3. It is understood that the lengths l1, l2, and l3 could be different lengths and a triangular interface such as the delta ring 700 could still be coupled with instances of the nodes 102 positioned at the three pivot points V1, V2, and V3. If l1, l2, and l3 are of fixed length, that would not allow V1, V2 and V3 to be moved in any direction. One might consider the case that the pivot at V1 were pushed in the direction of P (downward in the Figure). If this were to happen, then V2 and V3 would both be pushed to slide in the direction away from point P. But this couldn't happen, because l3 would have to stretch and l1 and l2 would have to compress. These changes in lengths would be rigidly resisted by the material stiffness of an interfacing connector such as such as the delta ring 700. It is noted that there are many other embodiments of this basic concept which are possible. All that is necessary in a design to implement the principles explained above is that three, approximately equally spaced, pivoting attachment points on one element are mechanically guided along the angle centerline of the other element.

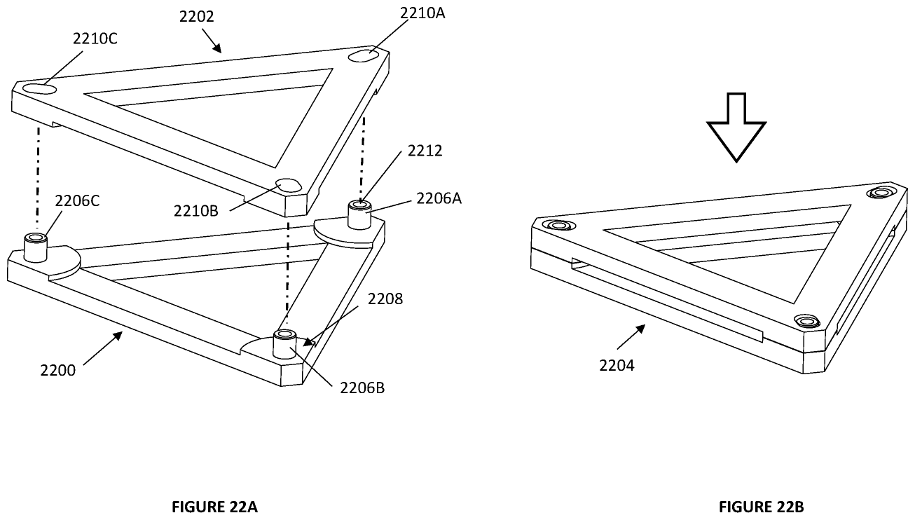

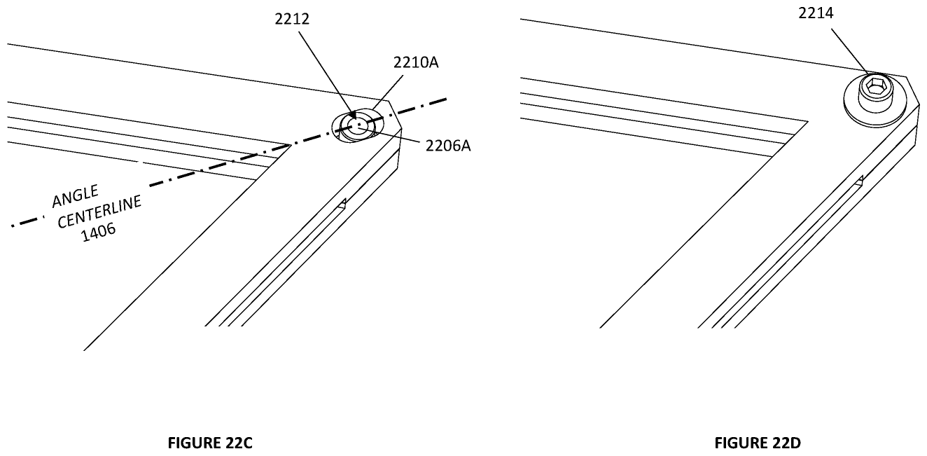

Referring now generally to the Figures, and particularly to FIG. 22A, FIG. 22A is a simplified model presenting aspects of coupling together two frames in accordance with the geometric principles of FIG. 21. A simplified apparatus is shown in FIG. 22A, demonstrating the concept explained regarding FIG. 21. Only mechanical fastening aspects are presented in this simplified example. A first triangular frame element 2200 couples together with a second triangular frame element 2202, to form a connected triangular frame assembly 2204 as presented in FIG. 22B. The first triangular frame element 2200 has three pivot pins, a first pin 2206A, a second pin 2206B, and a third pin 2206B, (hereinafter, “the pins 2206”) on three mount pads, a first mount pad 2208A, a second mount pad 2208B, and a third mount pad 2208C located at the corners, and the second triangular frame element 2202 has three slots, a first slot 2210A, a second slot 2210B, and a third slot 2210C (hereinafter, “the slots 2210”) at corresponding corners aligned with the angle centerline 1406 of each corner. The pins 2206 and the slots 2210 are produced with a locational clearance fit so one of the pins 2206 can slide along the length of a corresponding one of the slots 2210, but there is little or no play across the width of the slot. Therefore, the pivot is guided along the angle centerline 1406. Within the allowance provided by the slot length, the assembly can adapt to dimensional variation in the positions of the pins 2206, but will rigidly lock the frames laterally and in azimuth once the connected triangular frame assembly 2204 is put together. Each of the pins 2206 further includes a threaded center hole 2212.

Referring now generally to the Figures, and particularly to FIG. 22B, FIG. 22B is a second view of the model of FIG. 22A presenting the first triangular frame element 2200 coupled together with the second triangular frame element 2202, to form the connected triangular frame assembly 2204.

Referring now generally to the Figures, and particularly to FIG. 22C, FIG. 22C is a detail of the assembled model of FIG. 22B, showing the fit of the first pin 2206A within the first slot 2210A. The angle centerline 1406 of this corner is further marked here for reference.

Referring now generally to the Figures, and particularly to FIG. 22D, FIG. 22D is the view of FIG. 22C, further including a retaining fastener 2214, which fits into the threaded center hole 2212 and inhibits the frames from separating, more fully restraining the assembly. It is understood that, though the other two corners are not presented with retaining fasteners in these drawings, preferably all three corners would be similarly fastened following the example presented here.

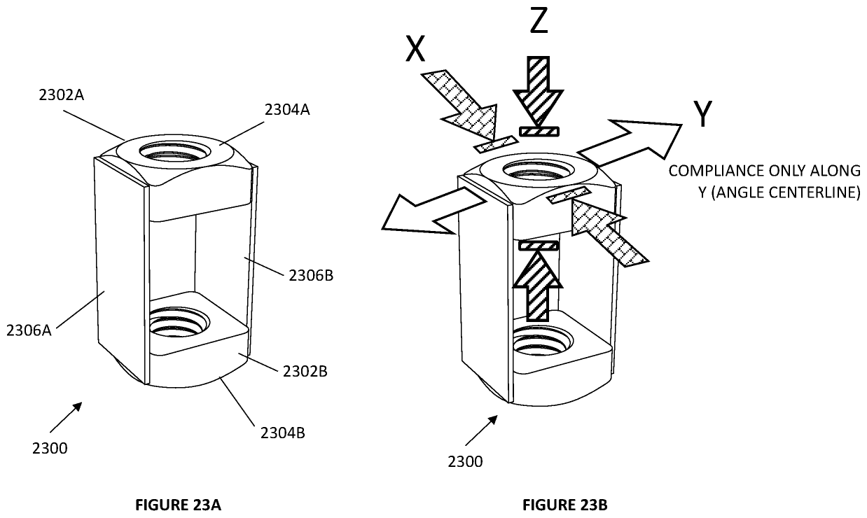

Referring now generally to the Figures, and particularly to FIG. 23A, FIG. 23A is a 3D model of a flex mount 2300, a mechanical fastening fixture which might additionally or alternatively support implementation of the mechanical fastening concepts of FIGS. 21 through 22D. The flex mount 2300 includes a first square nut 2302A and a second square nut 2302B, respectively presenting a first mounting surface 2304A and a second mounting surface 2304B, rigidly attached at both ends of a pair of spring bands, namely a first flat spring band 2306A and a second flat spring band 2306B coupling the first square nut 2302A and the second square nut 2302B as presented.

Referring now generally to the Figures, and particularly to FIG. 23B, FIG. 23B is a second image of the model of FIG. 23A, annotated with arrows to show the freedom of movement of a fastener coupled with the flex mount 2300. The diagram utilizes arrows to present an X axis, a Y axis, and a Z axis, such that the arrows show how movement of an attached fastener is constrained: there is only compliance along the Y axis as shown, allowing for practice of the mechanical fastening concepts of FIGS. 21 through 22D, with the Y axis as presented here lined up with the angle centerline 1406 as presented in FIG. 22C. The flex mount 2300 is a parallel fixture device particularly designed to guide an attachment point along the Y axis (i.e. the angle centerline 1406). If fixed at the second mounting surface 2304B, the first mounting surface 2304A can be displaced a small distance along the Y axis. The X axis and Z axis degrees of freedom are resisted.

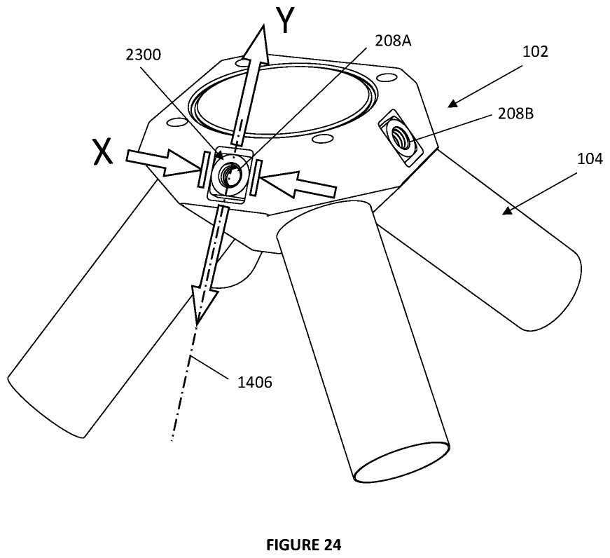

Referring now generally to the Figures, and particularly to FIG. 24, FIG. 24 is a 3D model of the node assembly of FIG. 2 coupled with a plurality of struts, with the flex mount 2300 installed. The X axis and Y axis as presented in FIG. 23B are annotated here, showing how the flex mount 2300 as installed in one of the nodes 102 permits displacement along the angle centerline 1406, but restricts the X axis degree of freedom. The presented embodiment of this design concept utilizes the node 102 incorporating guided mounting points for frame module or function module attachment. As shown in the Figure, each of the two mechanical fastening features 208A & 208B as shown on the node 102 (it is noted that the node 102 may include more mechanical fastening features 208 which are not in view) is allowed to move along the Y-axis (the angle centerline), but is restrained from motion on the X-axis. An attached module is also restrained from pulling away from or pushing into the to the node 102. The mechanical fastening features 208A & 208B as shown may be guided by many methods known in the art, such as the flex mount 2300 or a slide device using grooves that guide the edges of a square nut in a Y-axis-only displacement.

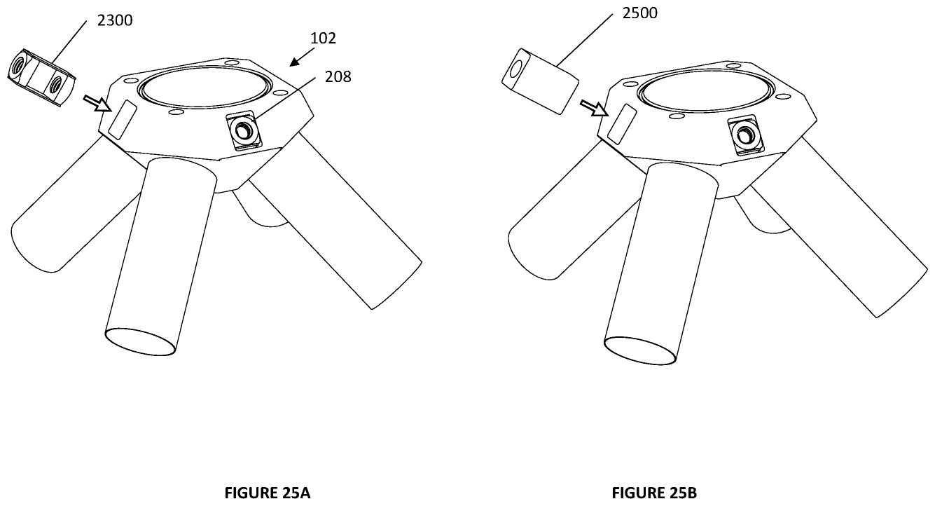

Referring now generally to the Figures, and particularly to FIG. 25A, FIG. 25A is a 3D model of the node assembly of FIG. 23A, showing coupling of the flex mount 2300 to one of the nodes 102. In preferred implementation, an instance of the flex mount 2300 may be installed in all or many of a plurality of mechanical fastening feature 208 positions of the nodes 102 of a chassis such as the octaframe chassis assembly 100 of FIG. 1, the tetraframe chassis assembly 900 of FIG. 9, or others, as presented here.

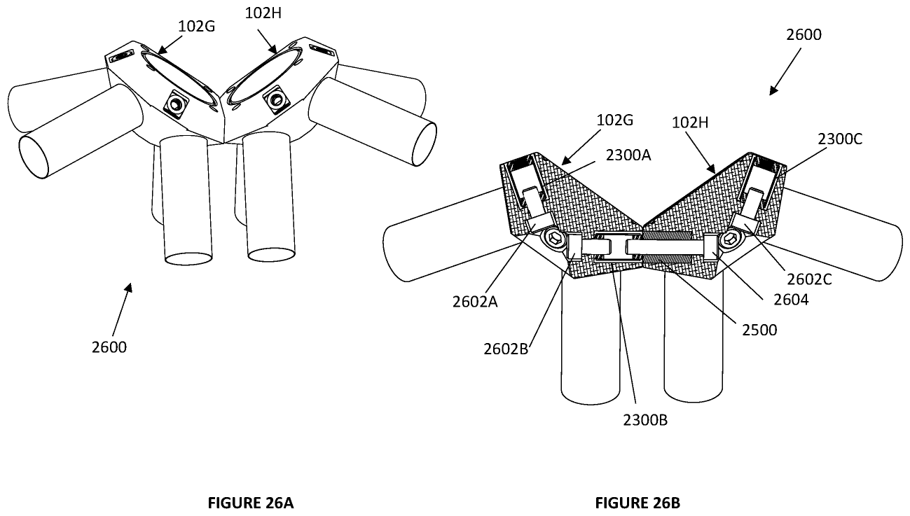

Referring now generally to the Figures, and particularly to FIG. 25B, FIG. 25B is a 3D model of the node assembly of FIG. 23A, showing the coupling of a coupling guide element 2500 to one of the nodes 102. The coupling guide element forms an opposite connection point for coupling with the flex mount 2300, such that one instance of the mechanical fastening feature 208 with the flex mount 2300 installed may couple onto an opposing instance of the mechanical fastening feature 208 with the coupling guide 2500 installed, as presented in FIGS. 26A & 26B.

Referring now generally to the Figures, and particularly to FIG. 26A, FIG. 26A is a 3D model presenting two of the nodes 102 mechanically coupled together into a coupled node assembly 2600, namely a left node 102G and a right node 102H. Portions of the struts 104 attached to these nodes are also presented for context.

Referring now generally to the Figures, and particularly to FIG. 26B, FIG. 26B is a cutaway view of the coupled node assembly 2600. A first flex mount 2300A is coupled with the interior of the left node 102G by a first flex mount screw 2602A, a second flex mount 2300B is also coupled with the interior of the left node 102G by a second flex mount screw 2602B, the second flex mount 2300B is coupled with the coupling guide 2500, the coupling guide 2500 is coupled with the interior of the right node 102H by a coupling guide screw 2604, and a third flex mount 2300C is coupled to the interior of the right node 102H by a third flex mount screw 2602C. When joining two of the nodes 102, the flex mount 2300 is removed from one side of each joint and replaced by the coupling guide 2500. The nodes are then attached through the coupling guide 2500 to the flex mount 2300 on the mating node as shown in the Figure.

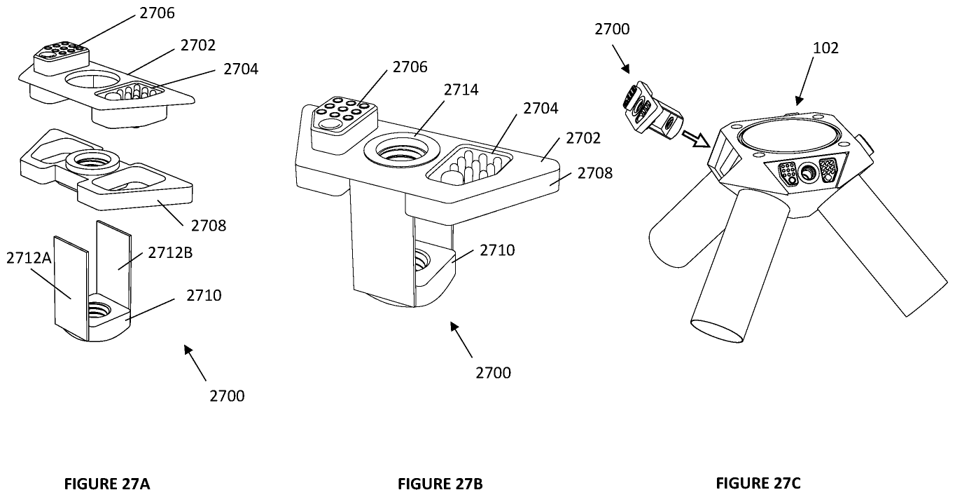

Referring now generally to the Figures, and particularly to FIG. 27A, FIG. 27A is a 3D model presenting an exploded view of a second mount connector 2700, an alternative embodiment of the mount connector 202, incorporating the flex mount 2300 and the androgynous connector design principles of FIGS. 14A through 20B. A connector block 2702 having a plurality of pins 2704 and a corresponding plurality of sockets 2706 is coupled into an upper flex mount support 2708, is coupled onto a lower flex mount 2710. It is noted that coupling the power and data connection features such as the connector block 2702 directly with the mechanical connection features such as the lower flex mount 2710 supports improved reliability of lining up of interface elements which are supposed to couple together, such as pins 2704 into sockets 2706. In the assembly of the second mount connector 2700, the flex mount 2300 as previously described is modified to replace the first square nut 2302A with the upper flex mount support 2708. The upper flex mount support 2708 is rigidly attached to the top of the spring bands 2712A and 2712B of the lower flex mount 2710, as the first square nut 2302A was in the flex mount 2300. On top of the upper flex mount support 2708, the connector block 2702 is bonded or otherwise rigidly attached, making the upper flex mount support 2708 and pins 2704 move together, compliant on the Y-axis as presented in FIGS. 23B and 24. It is understood that the preferred designs of these mechanical structures as presented herein are not an exhaustive presentation of available options for practicing certain preferred embodiments of the invented method, and that although the flex mount 2300 structure and similar are presented to describe the preference and advantage of guiding connectors and mounts as a unit along the Y-axis, other means of providing selective freedom of motion and of guiding corresponding connection points to line up may also alternatively be utilized, such as a slide device or kinematic linkage, and could yield comparable benefits.

Referring now generally to the Figures, and particularly to FIG. 27B, FIG. 27B is a 3D model presenting an assembled view of the second mount connector 2700. Labeled here are the connector block 2702, the pins 2704, the sockets 2706, the upper flex mount support 2708, and the lower flex mount 2710. With the components of the second mount connector 2700 assembled, a mechanical mounting point 2714 is provided.

Referring now generally to the Figures, and particularly to FIG. 27C, FIG. 27C is a 3D model presenting the second mount connector 2700 being coupled onto one of the nodes 102 in the position of the mount connector 202.

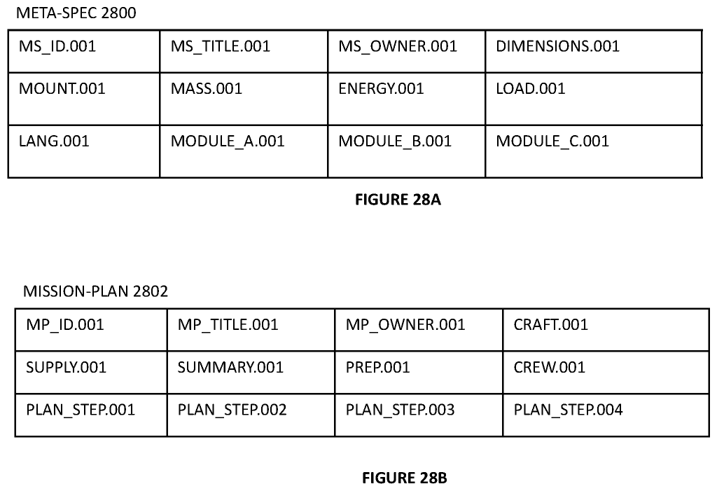

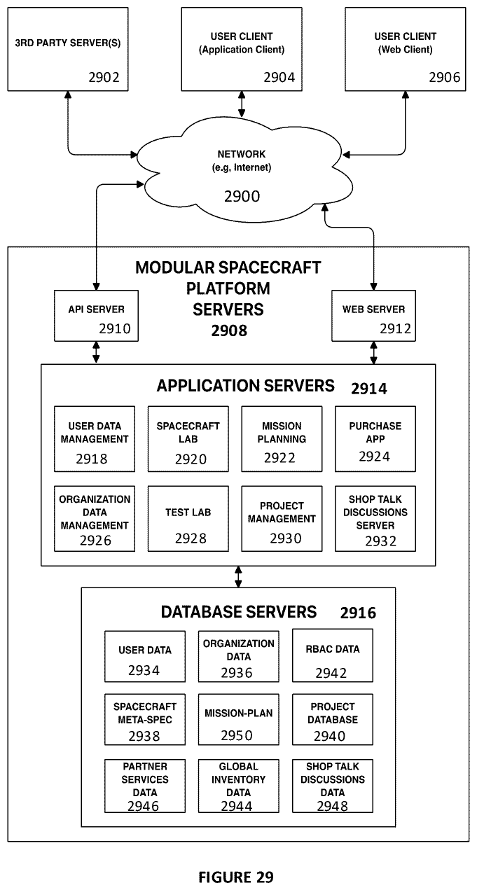

Referring now generally to the Figures, and particularly to FIG. 28A, FIG. 28A is a block diagram representing a Meta-Spec 2800 as discussed further in subsequent Figures. The Meta-Spec 2800 is a data structure for instantiating a spacecraft module within the design platform system further described in FIGS. 29 through 35, such that the module design instantiated by a given instance of the Meta-Spec 2800 can be modified and stored; can be shared, licensed, and/or sold; can be compatibly incorporated with permission into design of other modules and spacecraft; or can even be authorized and ordered to be assembled, manufactured, and launched.

The Meta-Spec 2800 may include or comprise all or some of the following data fields and more: an identifier data field MS_ID.001 (such as a reference number for this item), a craft title data field MS_TITLE.001 (such as a name for the spacecraft design), an ownership data field MS_OWNER.001, a dimensions data field DIMENSIONS.001, a mounting geometry data field MOUNT.001, a mass data field MASS.001, an energy data field ENERGY.001, a launch load data field LOAD.001, a coding language data field LANG.001 to indicate what language(s) any module software might be written in (if relevant), a first included module data field MODULE_A.001, a second included module data field MODULE_B.001, and a third included module data field MODULE_C.001. Any or all of these data fields may be single amounts or more complex and specific information as required; for instance, the mass data field MASS.001 may simply be a number of pounds or kilograms, or may further include other important data regarding the mass of the craft, such as information about the location of the module's center of gravity or the module's mass distribution. The first included module data field MODULE_A.001, the second included module data field MODULE_B.001, the third included module data field MODULE_C.001, and however few or many more of these may be needed for a particular design, each reference or incorporate another instance of the Meta-Spec 2800 which pertains to a module or component included in the craft. For instance, the Meta-Spec 2800 for the exemplary modular spacecraft 1300 might include references to the visible imaging camera & infrared spectrometer function module 1100, the communications function module 1102, the telescope function module 1104, and the PV array function module 1106, and codify how these modules are included and positioned within the exemplary modular spacecraft 1300.

With each added module, the selected module's spec becomes incorporated in the Meta-Spec 2800 associated with this spacecraft. At any point in the spacecraft's configuration, the Meta-Spec 2800 will record the state of the craft as a whole in all parameters of interest. For example, a part of each module specification includes its center of gravity (CG) and its moment of inertia in in three axes at 90°. As the craft is configured in this process, the precise positions of module CGs and their individual moments of inertia profiles are mathematically processed to produce the CG and moment of inertia of the craft as a whole and this is recorded in the spacecraft's Meta-Spec 2800. Power requirements and power production in each module can also be combined in various ways to produce the spacecraft's power profile affecting how the spacecraft power is managed in the mission software. For example, the power profile and mass distribution of the spacecraft will be critical in planning its trajectory. The Meta-Spec 2800, therefore, becomes a data-based proxy for the spacecraft, used in most platform operations from testing the function of the spacecraft as a whole to testing trajectories to automatically filtering the module choices to those recommended by the system.

Referring now generally to the Figures, and particularly to FIG. 28B, FIG. 28B is a block diagram representing a Mission-Plan 2802 as discussed further in subsequent Figures. The Mission-Plan 2802 is a data structure for instantiating a spacegoing mission within the design platform system further described in FIGS. 29 through 35, such that the mission design instantiated by a given instance of the Mission-Plan 2802 can be modified and stored; can be shared, licensed, and/or sold; and be launched and carried out. Further, the Mission-Plan 2802 integrates reference to a specific Meta-Spec 2800, and instantiates exactly how that particular spacecraft of the Meta-Spec 2800 will perform the mission: how much fuel or other supplies will be needed, which mechanisms aboard the craft will be used when, and so on.

The Mission-Plan 2802 may include or comprise all or some of the following data fields and more: an identifier data field MP_ID.001 (such as a reference number for this item), a project title data field MP_TITLE.001 (such as a name or designation to refer to the project by), an ownership data field MP_OWNER.001, a craft data field CRAFT.001 such as a reference to the associated Meta-Spec 2800, a supply data field SUPPLY.001 containing information about what supplies (such as fuel) are required to perform this mission, a summary field SUMMARY.001 such as a text field for describing the mission, a preparation data field PREP.001 containing information about what actions need to be taken to prepare to execute this mission, a personnel data field CREW.001 containing information about what kind and how many personnel may be required to perform the mission. Mission-Plan steps PLAN_STEP.001-004 are representative instances of a series of steps for performing the mission of the Mission-Plan 2802, such as recording which engines should fire when, when pictures will be taken by an onboard camera or modules otherwise utilized, and so on. It is understood that the Mission-Plan 2802 may contain any number of mission steps, and these are only a representative few. It is further understood that the Mission-Plan 2802 may contain further information besides those data fields represented here. Further, it is understood that any of the data fields presented here might also be duplicated; for instance, a same project might incorporate coordinated actions by multiple spacecraft working together, in which case the Meta-Spec 2800 of each craft involved might be included in the Mission-Plan 2802.

Referring now generally to the Figures, and particularly to FIG. 29, FIG. 29 is a diagram representing exemplary platform services for inclusion in a business model associated with preferred embodiments of the invented devices and methods. The modular spacecraft platform as described herein makes possible a unique business method capable of providing a more efficient process for designing, producing, project planning, selling, buying, programming, launching and operating spacecraft. This business method depends on a web-based system of servers and network access, as presented in FIG. 29. This platform system can be structured many ways. In this example embodiment, separate database servers are used to place users, organizations, spacecraft, and projects in an on-line ecosystem where users or organizations can buy or sell spacecraft, or complete mission projects, in an online marketplace with services provided by third-party partners. This architecture provides API servers for access to partner data existing on third-party servers and a web server for user access. Although many examples exist where products are bought, sold, bartered, and financed in online platforms, the most critical part of those sales transactions is the knowledge, by all involved parties, of the product's specification and the ownership and transfer of the ownership of those properties. For a modular spacecraft produced as this disclosure has described, the product's specification has never existed before. This creates difficulties for automated sales transactions of these custom-designed spacecraft. Prior to the transaction, no prior, physical spacecraft has existed to provide size, shipping weight, or characterize the product for the customer's use. Moreover, many more parameters are needed in the completion of a spacecraft project such as the satellite's mounting features, detailed satellite dimensions, or the data needed for trajectory planning such as mass, center of gravity, moment of inertia in three axes or characterization of thrust. These critical module and spacecraft parameters must be accurately known, yet each product can be of unlimited shapes, with a large variation in mass, size, functionality, etc. Before a project is complete, a spacecraft must be shipped, handled, tested, mounted, launched, deployed and put in communication with available ground services, all requiring prior knowledge of an intricate specification of the spacecraft as a whole.

In an example network environment for designing, producing, project planning, selling, buying, programming, launching and operating spacecraft presented in FIG. 29, an electronic communications network 2900 such as the Internet (noted to be distinct from the network 300 implemented locally between nodes 102 of a spacecraft) may connect a plurality of third party servers 2902, an application user client device 2904, a web user client device 2906, and modular spacecraft platform servers 2908 including an API server 2910 and a web server 2912. These may further connect to a plurality of application servers 2914, further connected to a plurality of database servers 2916. The application servers may include a user data management server 2918, a spacecraft lab server 2920, a mission planning server 2922, a purchase app server 2924, an organization data management server 2926, a test lab server 2928, a project management server 2930, and a shop talk discussion server 2932. The database servers 2916 may include a user data server 2934, an organization data server 2936, a spacecraft Meta-Spec server 2938, a Mission-Plan database server 2950, a project database server 2940, a role-based access control data server 2942, a global inventory data server 2944, a partner services data server 2946, and a shop talk discussions data server 2948.

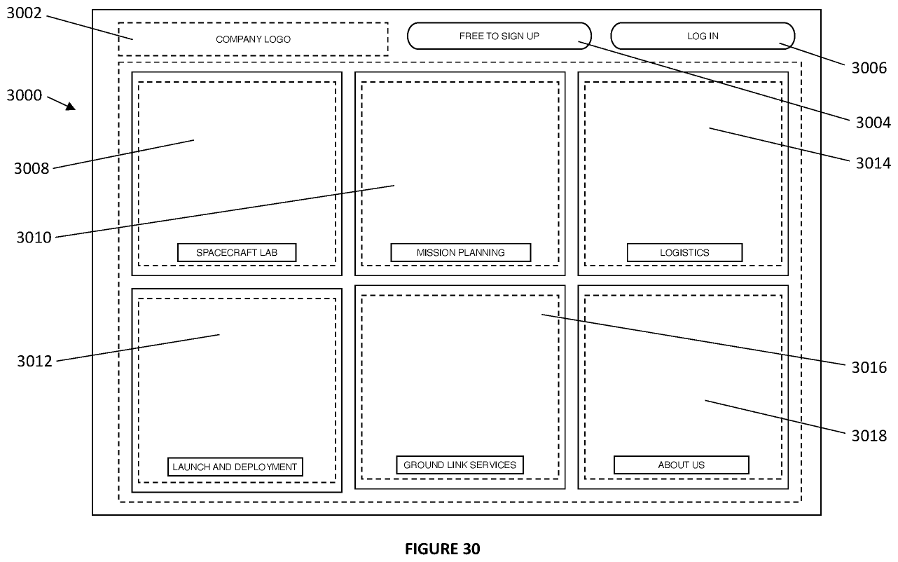

Referring now generally to the Figures, and particularly to FIG. 30, FIG. 30 is an example home page 3000 for an interface for designing, procuring, deploying, and managing modular spacecraft utilizing the network 300. The example home page 3000 may include features such as but not limited to a logo 3002 associated with the providing enterprise, a sign up button 3004, a login button 3006, and a plurality of linked panels for accessing the content of the interface application, such as a spacecraft lab panel 3008, a mission planning panel 3010, a launch and deployment panel 3012, a logistics panel 3014, a ground link services panel 3016, and an about us panel 3018. The example home page 3000 displays various platform functionalities in separate panes (6 in this example). Each pane might have text or graphics to represent its category. Clicking on a pane will take the visitor to demonstrations and tutorials associated with the platforms function in that category. For example, if a visitor were to click the Spacecraft Lab frame, they may be taken to a demo of how a spacecraft can be assembled and tested in a virtual 3D environment.

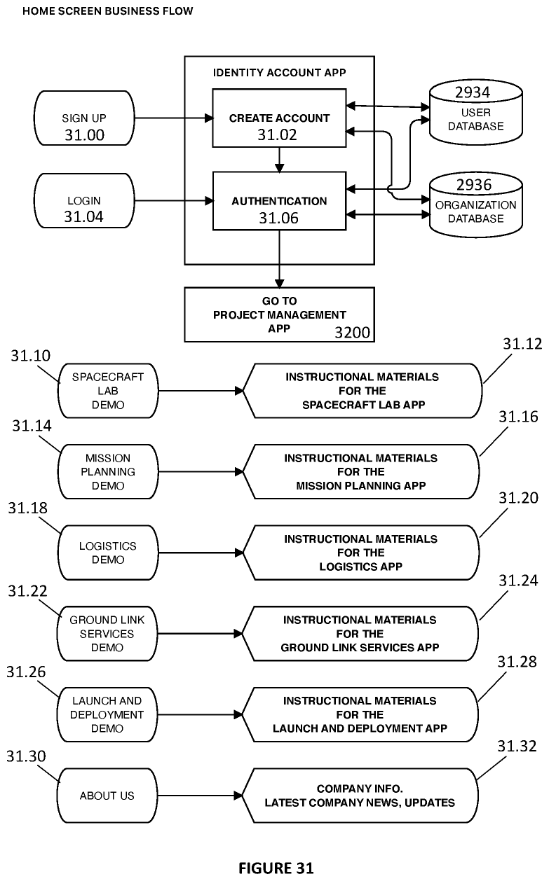

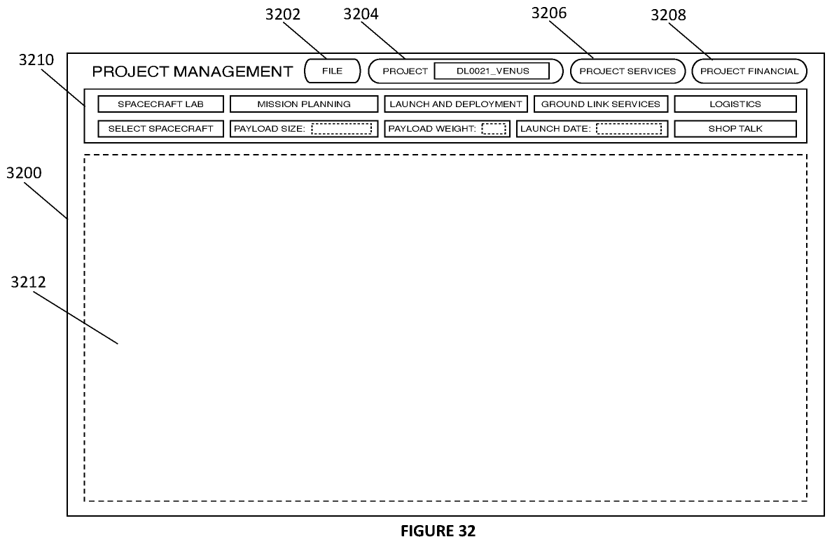

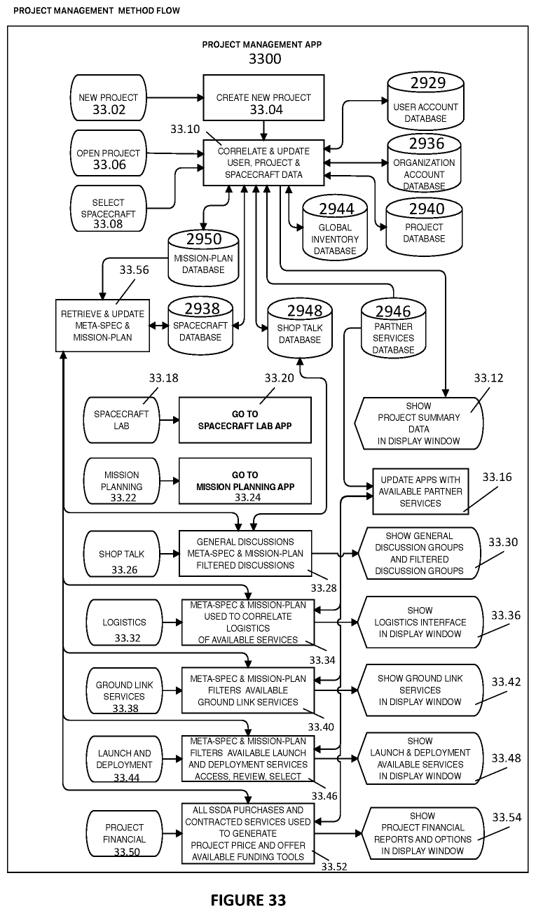

Referring now generally to the Figures, and particularly to FIG. 31, FIG. 31 is a process chart representing a business flow associated with the home page 3000. Here are some ways a user might interact with the home page 3000 interface. The business flow may include a sign up option 31.00 which leads to an account creation process 31.02 in interaction with the user database management server 2918 and the organization database management server 2926. The user data management server 2918 accesses and updates the user data database 2934 and the organization data management server 2926 accesses and updates the organization data database 2936. Once an account has been created, a login option 31.04 is available, wherein an authentication process 31.06 interacts with the user database management server 2918 and the organization database management server 2926 to look up and permit access to a previously created user account if provided with the correct login credentials (such as a username and password). Once a user has logged in successfully, the user may be provided with an interface for managing the account contents, such as providing access to the project management application 3200 of FIG. 32 via the project management page 3300 of FIG. 33. Other options available for interacting with the home page 3000 interface may include the following. A spacecraft lab demo option 31.10 is provided, and a user who accesses this item may view spacecraft lab app instructional materials 31.12. A mission planning demo option 31.14 is provided, and a user who accesses this item may view mission planning app instructional materials 31.16. A logistics demo option 31.18 is provided, and a user who accesses this item may view logistics app instructional materials 31.20. A ground link services demo option 31.22 is provided, and a user who accesses this item may view ground link services app instructional materials 31.24. A launch and deployment demo option 31.26 is provided, and a user who accesses this item may view launch and deployment app instructional materials 31.28. An about us option 31.30 is provided, and a user who accesses this item may view company information 31.32 such as but not limited to latest company news and updates.

Some important purposes of the home page 3000 include providing users with an interface for signing up and logging in, and encouraging and persuading new users to sign up. Registered members can be either individual users or organizations. While the work of an individual is held under that user's ownership and permission, the work of an organization's sponsored members (for example, employees or other members) is held under that organization's ownership and permission.

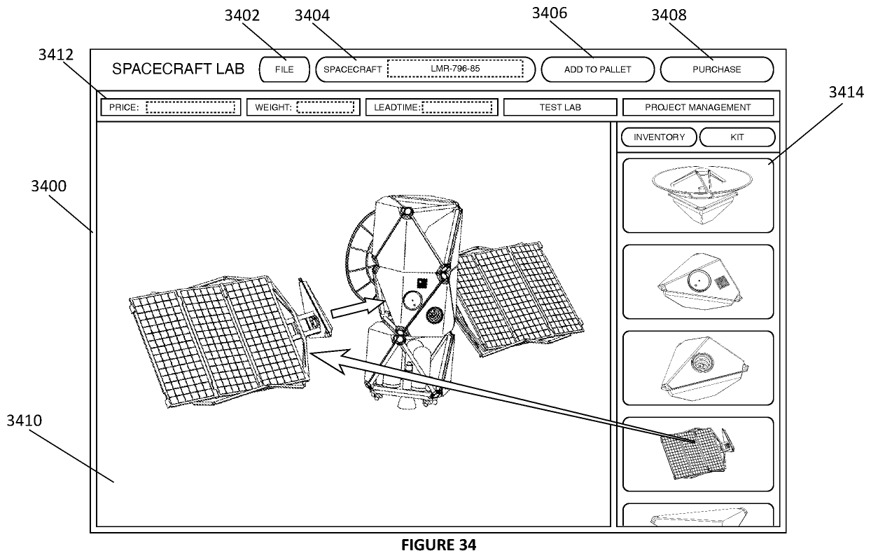

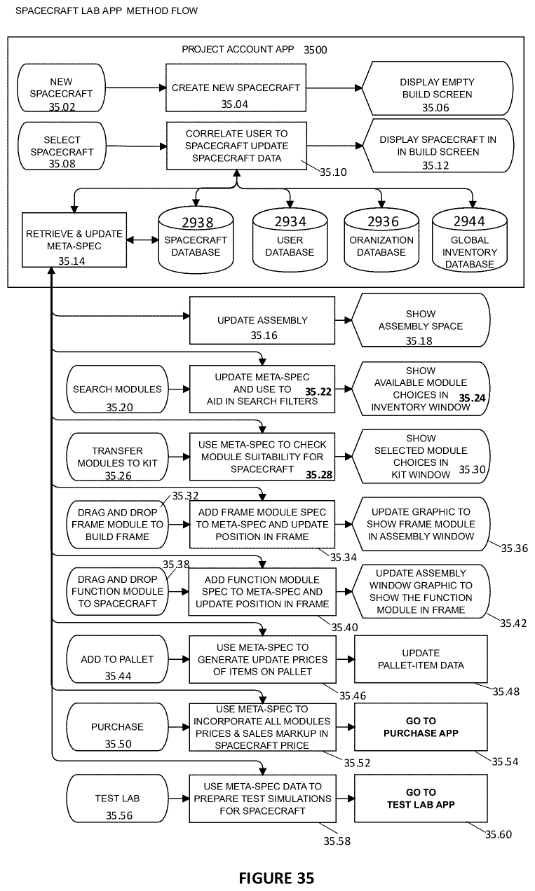

To sponsor its members, an organization may first authorize member access by setting permissions in the member's access table in the organization's account. A secure form of access control may be incorporated, such as role-based access control (RBAC). When an organization sets up access for a member in its account, the process may include setting levels of access for that member. Once a member is registered, they may log on to the organizations account with access granted to all levels allowed. For example, some roles may just review, others can create or change, others allowed to initiate various transactions, etc. Any change made by an authenticated user or organization will be automatically associated with their account and updated with work produced and owned properties transferred in each session. Properties owned and traded can include: spacecraft Meta-Specs 2800, Mission-Plans 2802, modules, spacecraft apps, purchased spacecraft, and financed projects. There are two automatically generated structured data assets for the two primary elements in a mission: The Meta-Spec 2800 and the Mission-Plan 2802. The Meta-Spec 2800 is a data structure codifying all of the spacecraft hardware and how the hardware fits together and works; the Mission-Plan 2802 is a description of how that hardware is to be handled and utilized in a mission. For instance, in an example where a spacecraft is designed to be sent out to orbit the moon and send back pictures, the Meta-Spec 2800 would codify how to build the craft and how the craft will work when built, and the Mission-Plan 2802 would codify the trajectory the craft will take to and around the moon, how many pictures are to be taken and where, and how the craft's available capabilities (as codified by the Meta-Spec 2800) will be applied in order to get there and do the mission. The Mission Planning Tool, shown as a menu choice in the Project Management Tool of FIGS. 32 and 33, creates the Mission-Plan 2802. The Spacecraft Lab Tool of FIGS. 34 and 35 creates the Meta-Spec 2800.

Referring now generally to the Figures, and particularly to FIG. 32, FIG. 32 is an example interface for a project management page 3200. Once a user, such as a member or organization, has logged on, this user is transferred to the project management page 3200. The project management page 3200, in this example, gives access to a cluster of tools used to coordinate all the components of a project, such as but not limited to designing modular spacecraft, mission planning, logistics, craft deployment, managing of ground services, and more. When entering this page, the user selects whether to access an existing project or create a new project. All tools used in project management activities continuously build a new instance of the Mission-Plan 2802. Presented here as exemplary elements of the project management interface 3200 are a file button 3202, a project title display 3204, a project services button 3206, a project financial button 3208, a plurality of tools and settings 3210, and a workspace 3212. The plurality of tools and settings 3210 may further include access to a Spacecraft Lab application, a Mission Planning application, launch and deployment tools, ground link services, logistics, a button for selecting the spacecraft, a display of the payload size, a display of the payload weight, a display of the launch date, and a button for shop talk. It is understood that the buttons, options, displays, and tools presented in this exemplary interface are merely non-limiting and explanatory examples of items which might preferably be included in this interface.

Referring now generally to the Figures, and particularly to FIG. 33, FIG. 33 is a process chart representing a method flow associated with a project management app 3300 displaying an interface such as or similar to the project management page 3200. Here are some ways a user might interact with the project management page 3200 interface or other aspects of the project management app 3300 overall. A new project option 33.02 is provided, and if the user selects this option, a new project creation action 33.04 is initiated. An open project option 33.06 is provided to load data about a project already begun previously, a select spacecraft option 33.08 option such as to select a template, and selecting either of these options may initiate a correlate and update user project and spacecraft data process 33.10 in coordination with the user account database server 2934, the organization account database 2936, the project database 2940, the global inventory database 2944, the spacecraft database 2938, mission-plan database 2950, the shop talk database 2948, some of these in coordination with other aspects of the project management app 3300 as shown, and the partner services database 2946, and perform a project management page 3200 display action 33.12. The partner services database may perform an app update with available partner services process 33.16, in coordination with other aspects of the project management app 3300 as shown. An accessing the spacecraft lab option 33.18 may be selected, resulting in a spacecraft lab displaying process 33.20 for displaying a spacecraft lab interface such as that of FIG. 34. An accessing the mission planning option 33.22 may be selected, resulting in a mission planning displaying process 33.24 for displaying a mission planning interface. An accessing shop talk option 33.26 may be selected, resulting in a shop talk displaying process 33.28 for displaying a shop talk interface 33.30, providing access to general discussion groups and Meta-Spec 2800 filtered discussion groups. An accessing logistics option 33.32 may be selected, which may result in a correlation of the logistics of available services using the Meta-Spec process 33.34, and providing of a logistics interface display 33.36. An accessing ground link services option 33.38 may be selected, which may result in an available ground link services being filtered according to the Meta-Spec process 33.40, and a ground link services display 33.42 may be provided. A launch and deployment option 33.44 may be selected, this may result in a filtering of available launch and deployment services by Meta-Spec process 33.46, and a launch and deployment available services display 33.48 may be provided. A project financial option 33.50 may be selected, this may result in a generation of project price and offering of available funding tools process 33.52, and a project financial reports and options display 33.54. The Meta-Spec 2800 may further be retrieved and updated in a Meta-Spec 2800 retrieve and update interaction 33.56 with other actions and interfaces as shown.

Referring now generally to the Figures, and particularly to FIG. 34, FIG. 34 is an example spacecraft lab page 3400 for an interface for designing modular spacecraft utilizing the network 300 computing environment. The spacecraft lab page 3400, in this example, gives access to a cluster of tools used to design spacecraft in accordance with the invented method. Presented here as exemplary elements of the spacecraft lab page 3400 are a file button 3402, a project title display 3404, an add to pallet button 3406, a purchase button 3408, a workspace 3410, a plurality of displays and tools 3412, and a selection display of module components 3414. It is noted that the example spacecraft lab page 3400 presented here depicts designing of the exemplary modular spacecraft 1300 by incorporation of the example function modules of FIGS. 11A through 11D, as shown in the selection display of module components 3414. The plurality of displays and tools 3412 may further include a display of the aggregated price of the craft as currently designed, the aggregated weight of the craft as currently designed, how much lead-time would be needed to build the craft as currently designed, a button for accessing the testing lab, and a button for accessing project management. It is understood that the buttons, options, displays, and tools presented in this exemplary interface are merely non-limiting and explanatory examples of items which might preferably be included in this interface. The selection display of module components 3414 may be further subdivided into a global inventory which might show all available modules, and a local inventory called a “kit”. In this embodiment, a 3D graphic of the spacecraft shows its current state in the build. The spacecraft assembly can be rotated to reveal any attachment point of interest on the craft. The operator may select and drag a selected module from the kit window into the assembly area, bringing it up to the desired attachment position. The page software detects the module proximity to the compatible attachment point and the module snaps into place. Since the modules can be mounted in more than one position in azimuth, the operator can initiate rotate the module to gain the proper angular orientation. It is understood that this workspace might be presented visually on a screen such as a computer screen, as depicted here, but could also be presented and implemented in other display environments such as Augmented Reality or Virtual Reality.

Referring now generally to the Figures, and particularly to FIG. 35, FIG. 35 is a process chart representing a method flow associated with a spacecraft account app 3500. A new spacecraft option 35.02 is provided, and if the user selects this option, a new spacecraft creation action 35.04 is initiated. A select spacecraft option 35.06 option is provided such as to load a work in progress or select a template, and selecting either of these options may initiate a correlate user to spacecraft update data process 35.10 in coordination with the user account database server 2934, the organization account database 2936, the global inventory database 2944, the spacecraft database 2938, and some of these in coordination with other aspects of the project account app 3500, and perform a display spacecraft in build screen action 35.12, such as but not limited to displaying the screen display of FIG. 34. The Meta-Spec 2800 may further be retrieved and updated in a Meta-Spec 2800 retrieve and update interaction 35.14 with other actions and interfaces as shown. Further, an update assembly action 35.16 may be performed, resulting in an assembly space displaying process 35.18. A search modules option 35.20 may be selected, resulting in an update Meta-Spec 2800 and use to aid in search filters process 35.22, to generate a display of available choices of module 35.24. A transfer modules to kit option 35.26 may be selected, whereupon a using the Meta-Spec 2800 to check module suitability for spacecraft process 35.28 may be implemented, resulting in a selected module choices in the kit window display 35.30. A drag-and-drop frame module to build frame option 35.32 may be selected, whereupon an add frame module spec to Meta-Spec 2800 and update position in frame process 35.34 may be implemented, resulting in updating of the graphic to show the frame module in the assembly window 35.36. A drag-and-drop function module to spacecraft option 35.38 may be selected, whereupon an add function module spec to Meta-Spec 2800 and update position in frame process 35.40 may be implemented, resulting in updating of the graphic to show the function module in the assembly window 35.42. An add to pallet option 35.44 may be selected, whereupon a use Meta-Spec 2800 to generate update prices of items on pallet process 35.46 may be implemented, resulting in updating of pallet-item data 35.48. A purchase option 35.50 may be selected, whereupon a use Meta-Spec 2800 to incorporate all modules' prices and sales markup in spacecraft price process 35.52 may be implemented, resulting in a purchase app displaying process 35.54. A test lab 35.56 option may be selected, whereupon a use Meta-Spec 2800 data to test simulations for spacecraft process 35.58 may be implemented, and a test lab app displaying process 35.60 is initiated.

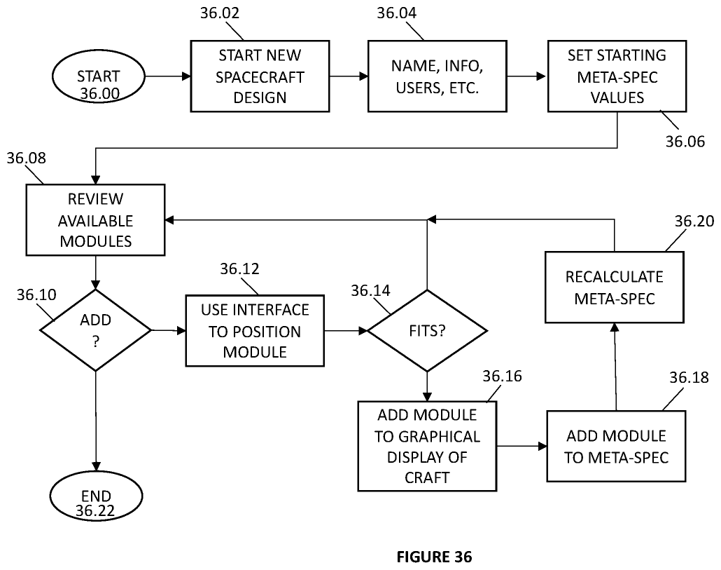

Referring now generally to the Figures and particularly to FIG. 36, FIG. 36 is a process chart presenting a method for designing modular spacecraft utilizing the interface of FIGS. 34 and 35. At step 36.00, the process starts. At step 36.02, a new spacecraft design is started. At step 36.04, logistics of beginning a new spacecraft project are managed, such as but not limited to allotting identifying information such as a login for reliably accessing the project, naming the project, designating who is authorized to edit the project, and so on. At step, 36.06, starting values for the Meta-Spec are initialized; for instance, a new project would probably begin with a mass of 0 kg, a power usage of 0 watts, and a price of $0, among other values. At step 36.08, a selection of modules available for inclusion in a designed spacecraft is browsed and reviewed; it is noted that a catalog of modules—such as chassis assemblies as presented in FIGS. 1, 9A-9C, and so on, or function modules such as those presented in FIGS. 11A through 11D—might be presented for a user to select from, and further that options for shortlisting favorites, filtering the selection, and so on may be included. At step 36.10, a user selects a module to add (or doesn't). If a new module is added, at step 36.12 the user uses the interface to position the module as preferred. At step 36.14, the user's selection is verified; if the module has been incompatibly placed or is otherwise invalid, the user may be asked to try a different spot, or the module may be rejected as incompatible; otherwise, the spacecraft design is revised to include the newly added module. At step 36.16, a graphical display is rendered to present the spacecraft including all modules added so far. At step 36.18, the selected module is incorporated into the Meta-Spec; the identifier for that module is added to the list of modules comprising the craft, along with a recording of the module's positioning on the craft such that the craft as designed could be re-created from the Meta-Spec information. At step 36.20, the value totals of the Meta-Spec are recalculated; for instance, the mass of the new module is added to the total mass of the craft; the price of manufacturing, obtaining, and/or installing the new module is added to the price of building the craft; and the power usage of the new module is added to the total power usage of the craft. The loop of the chart repeats, with a user selecting more modules to incorporate, until the user declines to select another module to add, at which point the process ends at step 36.22.

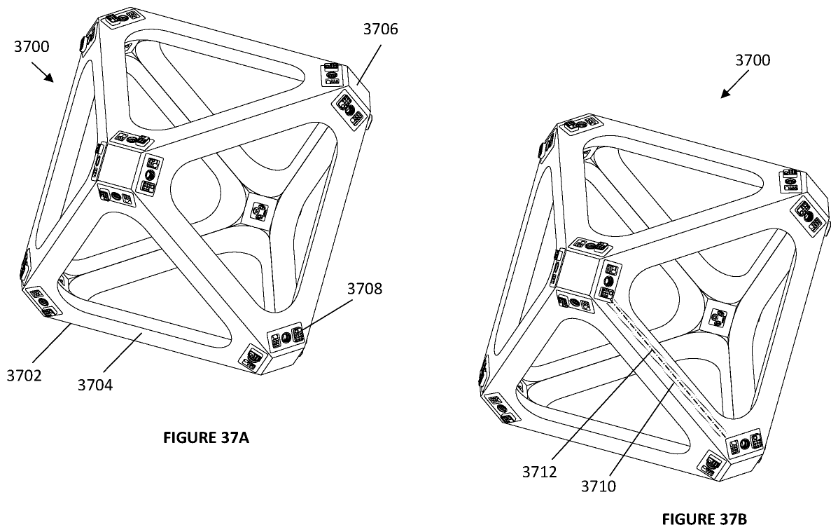

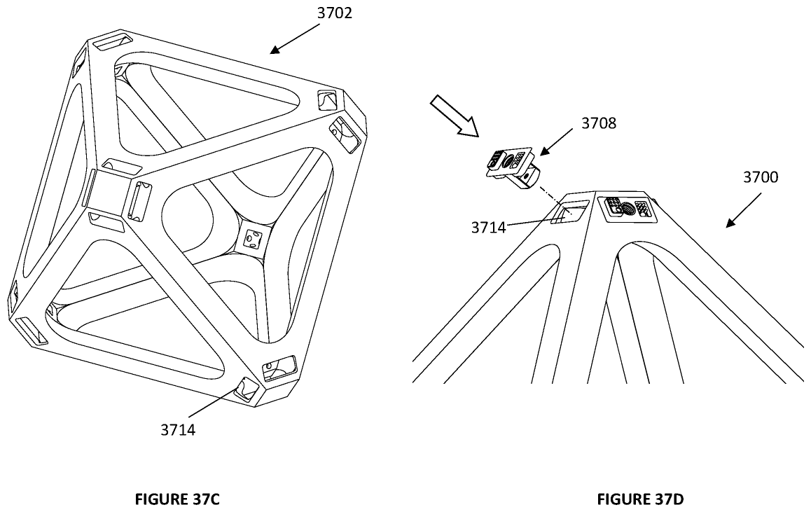

Referring now generally to the Figures and particularly to FIG. 37A, FIG. 37A is a single-piece chassis 3700, which is an embodiment of chassis assembly which is extruded, molded, or otherwise manufactured as a single unified piece. A single-piece chassis frame 3702 of the single-piece chassis 3700 is preferably shaped as a polygon having a plurality of single-piece chassis edges 3704 and a plurality of single-piece chassis vertices 3706, with each of the single-piece chassis vertices 3706 further comprising one or more single-piece chassis connectors 3708. It is noted that the single-piece chassis mount connectors 3708 are similar in function to the mount connector 202, but compatible with the single-piece chassis frame 3702 instead of the node controller 200. It is further noted that other aspects discussed herein regarding the mount connector 202 may also apply to the single-piece chassis mount connectors 3708, such as use of the connection point design elements of FIGS. 14A through 27C.

Referring now generally to the Figures and particularly to FIG. 37B, FIG. 37B is a second diagram of the single-piece chassis 3700 further depicting an internal structure of the plurality of single-piece chassis edges 3704, namely a conduit channel 3710 shaped as a feature of the interior of the plurality of single-piece chassis edges 3704 for holding a power and signal conduit 3712 for transmitting electrical power and/or transmitting data signals between each of the single-piece chassis vertices 3706 and performing an analogous function to that of the struts 104 as illustrated particularly in FIG. 5.

Referring now generally to the Figures and particularly to FIG. 37C, FIG. 37C is a third diagram regarding the single-piece chassis 3700, presenting only the single-piece chassis frame 3702. The single-piece chassis connectors 3708 fit into a plurality of connector mount pockets 3714 shaped into the single-piece chassis frame 3702, as presented further in FIG. 37D.

Referring now generally to the Figures and particularly to FIG. 37D, FIG. 37D is a fourth diagram regarding the single-piece chassis 3700, presenting one of the single-piece chassis connectors 3708 being inserted and fastened into one of the connector mount pockets 3714.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

We claim:

1. A chassis system comprising a plurality of interconnected nodes and struts, wherein:
each strut is coupled to two nodes and each node is coupled to at least two struts, the nodes and struts coupled to form a polygon shaped chassis frame;
each strut further comprises power and data wiring for transmitting data and electricity between nodes;
each node further comprises power and data wiring for transmitting data and electricity between struts and at least one connection point for coupling a device to the power and data wiring of the node and thus connecting a power system and a data system of the device to the power and data wiring of the chassis system via the connection point of the node.

2. The chassis system of claim 1, wherein the chassis system forms a polyhedron shape.

3. The chassis system of claim 2, wherein the polyhedron shape is a regular polyhedron.

4. The chassis system of claim 1, wherein at least one of the nodes further comprises an embedded microprocessor coupled with a control system.

5. The chassis system of claim 4, wherein all of the nodes further comprise an embedded microprocessor coupled with a control system.

6. The chassis system of claim 1, as an infrastructural framework module for inclusion in a modular vehicle.

7. The chassis system of claim 1, wherein the chassis frame is manufactured as a unified piece.

8. A mechanical fastening apparatus comprising a first fastening pair, a second fastening pair, and a third fastening pair, wherein:
The first fastening pair comprises a first extension and a first aperture, wherein the first aperture is shaped to fit around the first extension allowing motion tolerance only in a direction toward a midpoint between the second fastening pair and the third fastening pair;
The second fastening pair comprises a second extension and a second aperture, wherein the second aperture is shaped to fit around the second extension allowing motion tolerance only in a direction toward a midpoint between the first fastening pair and the third fastening pair; and
The third fastening pair comprises a third extension and a third aperture, wherein the third aperture is shaped to fit around the third extension allowing motion tolerance only in a direction toward a midpoint between the first fastening pair and the second fastening pair;
Wherein when the first extension traverses the first aperture, the second extension traverses the second aperture, and the third extension traverses the third aperture, the mechanical fastening apparatus is held in position by opposing force tension or compression between the first fastening pair, the second fastening pair, and the third fastening pair.

9. The mechanical fastening apparatus of claim 8, wherein the first fastening pair, second fastening pair, and third fastening pair are positioned at vertices of a triangle.

10. The mechanical fastening apparatus of claim 8, wherein each individual fastening pair of the first fastening pair, the second fastening pair, and/or the third fastening pair individually includes freedom of motion, but the combination of all three fastening pairs being fastened restricts the motion of all three fastening pairs.

11. A connection system comprising a mount interface and a frame,
wherein the mount interface and the frame have a same polygonal shape;
wherein the frame is shaped suitably for mechanically coupling onto the mount interface and vice versa;
wherein the frame includes a mount connection point for connecting to a power and signal connector of the mount interface;
wherein the frame includes a device connection point for connecting to a device power and signal network of an attached device; and
wherein the frame includes power and signal wiring connecting the device connection point to the mount connection point;
wherein the mount connection points comprise a mechanical fastening apparatus comprising a first fastening pair, a second fastening pair, and a third fastening pair, wherein:
the first fastening pair comprises a first extension and a first aperture, wherein the first aperture is shaped to fit around the first extension allowing motion tolerance only in a direction toward a midpoint between the second fastening pair and the third fastening pair;
the second fastening pair comprises a second extension and a second aperture, wherein the second aperture is shaped to fit around the second extension allowing motion tolerance only in a direction toward a midpoint between the first fastening pair and the third fastening pair; and
the third fastening pair comprises a third extension and a third aperture, wherein the third aperture is shaped to fit around the third extension allowing motion tolerance only in a direction toward a midpoint between the first fastening pair and the second fastening pair;
wherein when the first extension traverses the first aperture, the second extension traverses the second aperture, and the third extension traverses the third aperture, the mechanical fastening apparatus is held in position by opposing force tension or compression between the first fastening pair, the second fastening pair, and the third fastening pair; and
wherein each individual fastening pair of the first fastening pair, the second fastening pair, and the third fastening pair and/or individually includes freedom of motion, but the combination of all three fastening pairs being fastened restricts the motion of all three fastening pairs.

12. A device for coupling to the mount interface of claim 11, the device incorporating the frame into an exterior surface of the device.

13. A manufacturing design system for design and deployment of a vehicle, the system comprising:
building a database of hardware and software specifications for modules conforming to a same compatibility standard;
providing a software interface for assembling a modular vehicle design comprised of a plurality of component modules selected from the database; and
storing a first digital data object representing the modular vehicle design (“the Meta-Spec”), the Meta-Spec comprising an automatically generated specification for the modular vehicle design based upon combination of the specifications of the component modules of the modular vehicle design.

14. The manufacturing design system of claim 13, further comprising:
storing a second digital data object representing a mission (“the Mission-Plan”) to be executed utilizing a vehicle built in accordance with the Meta-Spec, the Mission-Plan comprising automatically generated mission supply requirements and details of mission execution based on properties of the vehicle as encoded in the Meta-Spec; and
executing a mission by assembling the vehicle in accordance with the Meta-Spec and equipping, launching, and directing the vehicle in accordance with the Mission-Plan.

15. The manufacturing design system of claim 13, wherein the vehicle of the Meta-Spec is a spacecraft, and the mission of the Mission-Plan is a spacegoing mission.

16. The manufacturing design system of claim 13, wherein the Meta-Spec is owned and licensed as intellectual property.

17. The manufacturing design system of claim 13, wherein the Mission-Plan is owned and licensed as intellectual property.
